(19) United States
(12) Patent Application Publication
(10) Pub. No.: US 2026/0188349 A1
(43) Pub. Date: Jul. 2, 2026

(54) FLUORINE-CONTAINING ETHER COMPOUND, LUBRICANT FOR MAGNETIC RECORDING MEDIUM, AND MAGNETIC RECORDING MEDIUM

(71) Applicant: Resonac Corporation, Tokyo (JP)

(72) Inventors: Takuya UNO, Tokyo (JP); Daisuke YAGYU, Tokyo (JP); Yutaka TANJI, Tokyo (JP); Tatsushi SAITO, Tokyo (JP)

(73) Assignee: Resonac Corporation, Tokyo (JP)

(21) Appl. No.: 18/861,252

(22) PCT Filed: Mar. 29, 2024
(86) PCT No.: PCT/JP2024/013222

§ 371 Date: Oct. 29, 2024

(30) Foreign Application Priority Data
Apr. 25, 2023 (JP) 2023-071338

(51) Int. Cl. G11B 5/725; C08G 65/00; C10M 107/38; C10N 40/18

(52) U.S. Cl. CPC G11B 5/7257; C08G 65/007; C10M 107/38; C10M 2213/0606; C10N 2040/18

(57) ABSTRACT

This fluorine-containing ether compound is a fluorine-containing ether compound represented by the following formula: R¹—CH₂—R²—(CH₂—R³—CH₂—R²)ₕ—CH₂—R⁴ (z represents 1 or 2. R² is a perfluoropolyether chain. R¹ is Formula (2). R⁴ is an organic group having 3 to 35 carbon atoms and having 1 to 3 polar groups. R³ is Formula (4).)

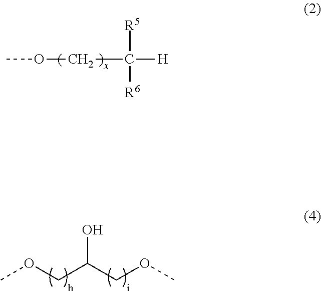

### TECHNICAL FIELD

The present invention relates to a fluorine-containing ether compound, a lubricant for a magnetic recording medium, and a magnetic recording medium.

Priority is claimed on Japanese Patent Application No. 2023-071338, filed Apr. 25, 2023, the content of which is incorporated herein by reference.

### BACKGROUND ART

In order to increase the recording density in magnetic recording and reproducing devices, development of a magnetic recording medium suitable for a high recording density has been in progress.

In the related art, as a magnetic recording medium, there is a magnetic recording medium in which a recording layer is formed on a substrate and a protective layer made of carbon or the like is formed on the recording layer. The protective layer protects information recorded in the recording layer and improves the sliding property of a magnetic head. In addition, the protective layer coats the recording layer and prevents a metal contained in the recording layer from being corroded by an environmental substance.

However, the durability of the magnetic recording medium is not sufficiently obtained only by providing the protective layer on the recording layer. Therefore, a lubricant is applied to the surface of the protective layer to form a lubricating layer. The lubricating layer disposed on the outermost surface of the magnetic recording medium is required to improve the floating stability and wear resistance of the magnetic head, in addition to improving the durability and protective power of the protective layer.

As a lubricant used in a case of forming the lubricating layer of the magnetic recording medium, a lubricant containing a compound having a polar group such as a hydroxy group at a terminal of a fluorine-based polymer having a repeating structure including —CF₂— has been proposed (for example, refer to Patent Documents 1 to 6).

Patent Document 1 to Patent Document 4 disclose fluorine-containing ether compounds having a skeleton in which a plurality of perfluoropolyether chains are bonded through linking groups having a secondary hydroxy group in the molecule, in which terminal groups having a polar group are each bonded to either side thereof through methylene groups (—CH₂—).

Patent Document 5 discloses a method for producing a polyol perfluoropolyether compound useful as a lubricant for a magnetic medium. Patent Document 5 describes that a triol is reacted with an activator to synthesize an activated protective triol, and the activated protective triol is subjected to a nucleophilic substitution reaction with hydroxy groups disposed at both terminals of a functional (per)fluoropolyether, thereby producing a polyol (per)fluoropolyether derivative.

Patent Document 6 discloses a fluorine-containing ether compound including one perfluoropolyether chain in the molecule, in which terminal groups including two primary hydroxy groups are each bonded to both sides of the perfluoropolyether chain.

### CITATION LIST

### Patent Documents

Patent Document 1: PCT International Publication No. WO2021/251335
Patent Document 2: PCT International Publication No. WO 2016/084781
Patent Document 3: United States Patent Application, Publication No. 2016/0260452
Patent Document 4: PCT International Publication No. WO 2018/116742
Patent Document 5: Japanese Patent No. 5334064
Patent Document 6: PCT International Publication No. WO 2022/131202

### SUMMARY OF INVENTION

### Technical Problem

In order to increase the capacity of a magnetic recording and reproducing device, development of a magnetic recording medium suitable for a high recording density has been in progress. In recent years, there has been a demand for further reduction of the distance between a magnetic head and a magnetic layer of the magnetic recording medium and the reduction of the magnetic spacing (floating height) in order to improve the recording density of the magnetic recording medium. Therefore, it is required to further reduce the thickness of the protective layer and/or the lubricating layer in the magnetic recording medium.

However, generally, in a case where the thickness of the lubricating layer is reduced, there is a tendency that the coatability of the lubricating layer is reduced, and the wear resistance and smoothness of the magnetic recording medium deteriorate.

The present invention has been made in view of the above circumstances, and an object of the present invention is to provide a fluorine-containing ether compound which has excellent wear resistance, can form a lubricating layer having good smoothness, and can be suitably used as a material for a lubricant for a magnetic recording medium.

In addition, another object of the present invention is to provide a lubricant for a magnetic recording medium, which contains the fluorine-containing ether compound of the present invention, has excellent wear resistance, and can form a lubricating layer having good smoothness.

In addition, another object of the present invention is to provide a magnetic recording medium, which contains the fluorine-containing ether compound of the present invention, has excellent wear resistance, and has a lubricating layer having good smoothness.

### Solution to Problem

The present inventors have conducted intensive studies to achieve the above objects.

As a result, the present inventors found that the above objects can be achieved by a fluorine-containing ether compound having a skeleton in which two or three perfluoropolyether chains are provided, and a divalent linking group having only one secondary hydroxy group is bonded between adjacent perfluoropolyether chains through methylene groups (—CH₂—), in which a specific branched terminal group in which two groups which are each composed of an organic group having 3 to 35 carbon atoms, do not contain a secondary hydroxy group and a tertiary hydroxy group, but contains one primary hydroxy group are bonded to a trisubstituted carbon atom is disposed in at least one terminal of the skeleton through a methylene group, and in a case where only one terminal is the branched terminal group, an organic group having 3 to 35 carbon atoms and having 1 to 3 polar groups is disposed at the other terminal through a methylene group, and conceived the present invention.

That is, the present invention relates to the following matters.

[1]A fluorine-containing ether compound represented by Formula (1),

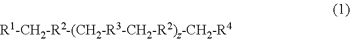

(In Formula (1), z is 1 or 2. R² is a perfluoropolyether chain. (z+1) R²'s may be the same in part or in whole, or may be different from each other. R¹ is a branched terminal group having 3 to 35 carbon atoms, which is represented by Formula (2). R⁴ is an organic group having 3 to 35 carbon atoms and having 1 to 3 polar groups, and may be the same as or different from R¹. R³ is a divalent linking group represented by Formula (4). In a case where z is 2, two R³'s may be the same as or different from each other.)

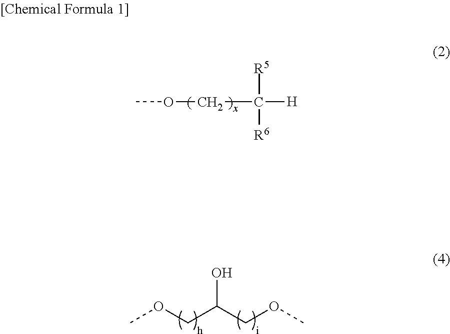

(In Formula (2), R⁵ and R⁶ are organic groups which do not include a secondary hydroxy group and a tertiary hydroxy group and include one primary hydroxy group, and may be the same as or different from each other. x is an integer of 0 to 3.)

(In Formula (4), h is an integer of 1 to 3, and i is an integer of 1 to 3.)

[2] The fluorine-containing ether compound according to [1], in which Formula (2) is any group represented by Formula (2-1) or (2-2).

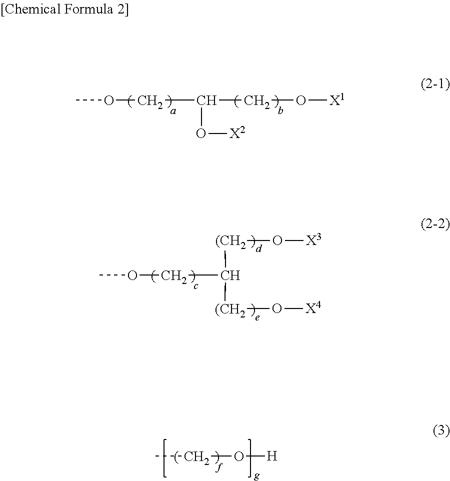

(In Formula (2-1), a is an integer of 1 to 3, and b is an integer of 1 to 4. X¹ is a hydrogen atom or a group represented by Formula (3). X² is a group represented by Formula (3). X¹ and X² may be the same as or different from each other.)

(In Formula (2-2), c is an integer of 0 to 3, and d and e are each independently an integer of 1 to 5. X³ and X⁴ are each independently a hydrogen atom or a group represented by Formula (3). X³ and X⁴ may be the same as or different from each other.)

(In Formula (3), f is an integer of 2 to 5, and g is 1 or 2.)

[3] The fluorine-containing ether compound according to [1] or [2], in which R⁴ in Formula (1) is the group represented by Formula (2).

[4] The fluorine-containing ether compound according to [2], in which both R¹ and R⁴ in Formula (1) are each independently represented by Formula (2-1) or (2-2).

[5] The fluorine-containing ether compound according to any one of [1] to [4], in which R¹ and R⁴ in Formula (1) are the same as each other.

[6] The fluorine-containing ether compound according to [1] or [2], in which R⁴ in Formula (1) is any group represented by Formula (6-1) to (6-3).

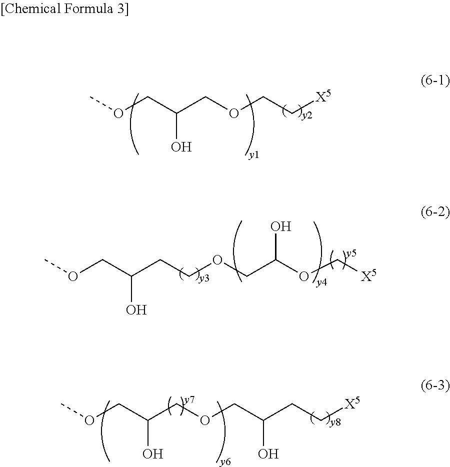

(In Formula (6-1), y1 is 1 or 2, and y2 is an integer of 0 to 3. X⁵ is an aromatic hydrocarbon group, an unsaturated heterocyclic group, an alkenyl group, an alkynyl group, or a polar group. In a case where y1 is 1, X⁵ is a polar group. In a case where X⁵ is the aromatic hydrocarbon group or the unsaturated heterocyclic group, an atom constituting a ring structure in X⁵ is bonded to a methylene group adjacent to X⁵. In a case where X⁵ is the alkenyl group or the alkynyl group, a carbon atom constituting an unsaturated bond in X⁵ is bonded to a methylene group adjacent to X⁵.)

(In Formula (6-2), y3 is an integer of 1 to 3, y4 is 0 or 1, and y5 is an integer of 0 to 3. X⁵ is an aromatic hydrocarbon group, an unsaturated heterocyclic group, an alkenyl group, an alkynyl group, or a polar group. In a case where y4 is 0, X⁵ is a polar group. In a case where X⁵ is the aromatic hydrocarbon group or the unsaturated heterocyclic group, an atom constituting a ring structure in X⁵ is bonded to a methylene group adjacent to X⁵. In a case where X⁵ is the alkenyl group or the alkynyl group, a carbon atom constituting an unsaturated bond in X⁵ is bonded to a methylene group adjacent to X⁵.)

(In Formula (6-3), y6 is 0 or 1, y7 is an integer of 1 to 3, and y8 is an integer of 1 to 3. X⁵ is an aromatic hydrocarbon group, an unsaturated heterocyclic group, an alkenyl group, an alkynyl group, or a polar group. In a case where y6 is 0, X⁵ is a polar group. In a case where X⁵ is the aromatic hydrocarbon group or the unsaturated heterocyclic group, an atom constituting a ring structure in X⁵ is bonded to a methylene group adjacent to X⁵. In a case where X⁵ is the alkenyl group or the alkynyl group, a carbon atom constituting an unsaturated bond in X⁵ is bonded to a methylene group adjacent to X⁵.)

[7] The fluorine-containing ether compound according to any one of [1] to [6], in which (z+1) R²'s in Formula (1) are each independently a perfluoropolyether chain represented by Formula (5).

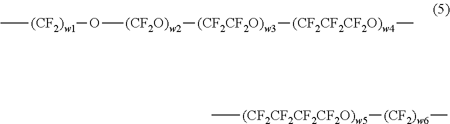

(In Formula (5), w2, w3, w4, and w5 represent average degrees of polymerization and each independently represent 0 to 20. Here, there are no cases where all of w2, w3, w4, and w5 become 0 at the same time. w1 and w6 are average values representing the number of CF₂'s and each independently represent 1 to 3. An order of arrangement of (CF₂O), (CF₂CF₂O), (CF₂CF₂CF₂O), and (CF₂CF₂CF₂CF₂O), which are repeating units in Formula (5), is not particularly limited.)

[8] The fluorine-containing ether compound according to any one of [1] to [7], in which (z+1) R²'s in Formula (1) are each independently any one selected from perfluoropolyether chains represented by Formulae (5-1) to (5-4).

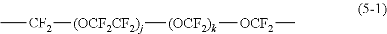

(In Formula (5-1), j and k represent average degrees of polymerization, j represents 1 to 20, and k represents 0 to 20.)

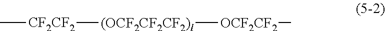

(In Formula (5-2), 1 represents an average degree of polymerization, and represents 1 to 15.)

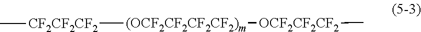

(In Formula (5-3), m represents an average degree of polymerization, and represents 1 to 10.)

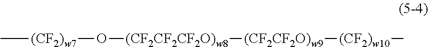

(In Formula (54), w8 and w9 represent average degrees of polymerization and each independently represent 1 to 20. w7 and w10 are average values representing the number of CF₂'s and each independently representing 1 to 2.)

[9] The fluorine-containing ether compound according to any one of [1] to [8], in which (z+1) R²'s in Formula (1) are all the same as each other.

[10] The fluorine-containing ether compound according to any one of [1] to [9], in which a number-average molecular weight is within a range of 500 to 10000.

[11]A lubricant for a magnetic recording medium, comprising the fluorine-containing ether compound according to any one of [1] to [10].

[12] A magnetic recording medium including at least in order, on a substrate, a magnetic layer, a protective layer, and a lubricating layer, in which the lubricating layer includes the fluorine-containing ether compound according to any one of [1] to [10].

[13] The magnetic recording medium according to [12], in which an average film thickness of the lubricating layer is 0.5 nm to 2.0 nm.

### Advantageous Effects of Invention

The fluorine-containing ether compound of the present invention is a compound represented by Formula (1) and is suitable as a material for a lubricant for a magnetic recording medium.

The lubricant for a magnetic recording medium of the present invention contains the fluorine-containing ether compound of the present invention, and thus can form a lubricating layer having excellent wear resistance and smoothness even in a case where the thickness is reduced.

The magnetic recording medium of the present invention includes a lubricating layer which contains the fluorine-containing ether compound of the present invention and has excellent wear resistance and smoothness. Therefore, the magnetic recording medium of the present invention has excellent reliability and durability.

### BRIEF DESCRIPTION OF DRAWINGS

FIG. 1 is a schematic cross-sectional view showing one embodiment of a magnetic recording medium of the present invention.

### DESCRIPTION OF EMBODIMENTS

In order to achieve the above objects, the present inventors focused on a relationship between the molecular structure of a fluorine-containing ether compound contained in a lubricant and a protective layer, and conducted intensive studies as described below.

In the related art, as a material for a lubricant for a magnetic recording medium (hereinafter, may be abbreviated as “lubricant”) to be applied to a surface of a protective layer, a fluorine-containing ether compound having a polar group such as a hydroxy group is used.

The fluorine-containing ether compound having a polar group may have a terminal group having a plurality of polar groups at a terminal of a chain-like structure. In addition, as the fluorine-containing ether compound, there is a compound having a plurality of perfluoropolyether chains, in which a linking group having a polar group between adjacent perfluoropolyether chains is disposed. In a lubricating layer containing the fluorine-containing ether compound, the polar group contained in the fluorine-containing ether compound is bonded to an active point on the protective layer to improve the adhesion of the lubricating layer to the protective layer.

However, in a lubricating layer including a fluorine-containing ether compound in the related art, even in a case where the lubricating layer is formed of a fluorine-containing ether compound having a plurality of polar groups in the molecule, the adhesion to the protective layer may not be sufficiently obtained. As a method of improving the adhesion of the lubricating layer to the protective layer, it is considered to use a fluorine-containing ether compound having a larger number of polar groups. However, with a lubricating layer formed of such a fluorine-containing ether compound, the smoothness and wear resistance of a magnetic recording medium may not be sufficiently obtained.

Therefore, the present inventors focused on the bonding between the polar group contained in the fluorine-containing ether compound and the active site on the protective layer, and conducted intensive studies.

As a result, the present inventors found that the adhesion of the lubricating layer to the protective layer can be improved by a fluorine-containing ether compound, as shown in Formula (1), having a skeleton in which two or three perfluoropolyether chains are provided, and a divalent linking group represented by Formula (4) having only one secondary hydroxy group is bonded between adjacent perfluoropolyether chains through methylene groups (—CH₂—), in which a specific branched terminal group represented by Formula (2) in which two groups which are each composed of an organic group having 3 to 35 carbon atoms, do not contain a secondary hydroxy group and a tertiary hydroxy group, but contains one primary hydroxy group are bonded to a trisubstituted carbon atom is disposed in at least one terminal of the skeleton through a methylene group, and in a case where only one terminal is the branched terminal group represented by Formula (2), an organic group having 3 to 35 carbon atoms and having 1 to 3 polar groups is disposed at the other terminal through a methylene group.

It is presumed that a lubricating layer containing the fluorine-containing ether compound represented by Formula (1) has good smoothness and excellent wear resistance due to a synergistic effect of the following actions and functions.

The secondary hydroxy group contained in the linking group represented by Formula (4) and the primary hydroxy group contained in the branched terminal group represented by Formula (2), which are contained in the fluorine-containing ether compound represented by Formula (1), are likely to participate in bonding with an active site present on the protective layer, due to the following reasons <1> to <3>.

<1> In the fluorine-containing ether compound represented by Formula (1), the divalent linking group represented by Formula (4) having only one secondary hydroxy group is bonded between two or three perfluoropolyether chains. Therefore, for example, in a case where there are two divalent linking groups represented by Formula (4), the perfluoropolyether chain is disposed between the divalent linking groups. Therefore, even in a case where there are two divalent linking groups represented by Formula (4), the distance between two secondary hydroxy groups is not too close. Therefore, even in a case where there are two divalent linking groups represented by Formula (4), both of two secondary hydroxy groups are not inhibited from bonding with the active site on the protective layer by the adjacent secondary hydroxy group.

In addition, in the fluorine-containing ether compound represented by Formula (1), the perfluoropolyether chain is disposed between the divalent linking group represented by Formula (4) and each of both terminal groups. Therefore, the distance between the secondary hydroxy group included in the divalent linking group represented by Formula (4) and the polar group included in each of both terminal groups is not too close. As a result, the secondary hydroxy group included in the divalent linking group represented by Formula (4) is not inhibited from bonding with the active site on the protective layer by the polar groups included in both terminal groups. Therefore, the secondary hydroxy group included in the divalent linking group represented by Formula (4) is likely to participate in the bonding with the active site on the protective layer.

<2> In the fluorine-containing ether compound represented by Formula (1), the perfluoropolyether chain is disposed between the divalent linking group represented by Formula (4) and each of both terminal groups. Therefore, the secondary hydroxy group included in the divalent linking group represented by Formula (4) does not inhibit the bonding of the polar groups included in both terminal groups with the active site on the protective layer, and the secondary hydroxy group included in the divalent linking group represented by Formula (4) and the polar group included in each terminal group are less likely to aggregate. Therefore, in the fluorine-containing ether compound represented by Formula (1), not only the secondary hydroxy group included in the above-described divalent linking group but also the polar group included in each terminal group are likely to be bonded to the active point on the protective layer.

<3> At least one terminal group is a branched terminal group represented by Formula (2) in which two organic groups each including one primary hydroxy group are bonded to a trisubstituted carbon atom, and the distance between two primary hydroxy groups included in Formula (2) is appropriate. Therefore, in the fluorine-containing ether compound represented by Formula (1), aggregation due to the too close distance between two primary hydroxy groups included in the branched terminal group represented by Formula (2) is less likely to occur, and two primary hydroxy groups do not inhibit the bonding with the active points on the protective layer each other.

In addition, since the branched terminal group represented by Formula (2) is an organic group having 3 to 35 carbon atoms, the distance between two primary hydroxy groups included in the branched terminal group is not too long. Therefore, in a case where one of the primary hydroxy groups included in the branched terminal group represented by Formula (2) is bonded to the protective layer, the distance of the other primary hydroxy group to the protective layer also becomes short. As a result, the other primary hydroxy group can have an orientation that is likely to induce adsorption to the protective layer. Therefore, two primary hydroxy groups included in the branched terminal group represented by Formula (2) are likely to be bonded to the active points on the protective layer at the same time.

Moreover, the branched terminal group represented by Formula (2) is a group in which two organic groups each not containing a secondary hydroxy group and a tertiary hydroxy group, but containing one primary hydroxy group are bonded to a trisubstituted carbon atom. Therefore, for example, the periphery of two primary hydroxy groups included in the branched terminal group represented by Formula (2) is sterically open as compared with the periphery of a secondary hydroxy group bonded to a carbon atom forming a chain-like structure of the fluorine-containing ether compound. In addition, since two organic groups each having one primary hydroxy group are bonded to the trisubstituted carbon atom, the distances between two primary hydroxy groups and the adjacent perfluoropolyether chain are appropriate. Therefore, both of two primary hydroxy groups are less likely to be inhibited from the bonding with the active site on the protective layer due to the adjacent perfluoropolyether chains, which are bulky portions in the fluorine-containing ether compound represented by Formula (1), and the trisubstituted carbon atom in the branched terminal group represented by Formula (2).

Furthermore, the primary hydroxy group generally has a high degree of freedom and can move more freely than the secondary hydroxy group and the tertiary hydroxy group. Therefore, two primary hydroxy groups included in the branched terminal group represented by Formula (2) can move to the active points on the protective layer at the same time. Therefore, both of two primary hydroxy groups included in the branched terminal group can easily form a bond with the active site on the protective layer.

Due to the above reasons <1> to <3>, the secondary hydroxy group contained in the linking group represented by Formula (4) and the primary hydroxy group contained in the branched terminal group represented by Formula (2), which are contained in the fluorine-containing ether compound represented by Formula (1), are likely to participate in the bonding with the active site present on the protective layer. Therefore, the lubricating layer containing the fluorine-containing ether compound represented by Formula (1) is caused to closely adhere to the protective layer by the secondary hydroxy group contained in the linking group represented by Formula (4), which is disposed between the adjacent perfluoropolyether chains, and two primary hydroxy groups contained in the branched terminal group represented by Formula (2), which is disposed in at least one terminal, and has good adhesion to the protective layer.

Moreover, in the lubricating layer including the fluorine-containing ether compound represented by Formula (1), the end portion bonded to the adjacent methylene group in the branched terminal group represented by Formula (2) is an oxygen atom, and thus the lubricating layer has appropriate flexibility due to the bonding with the adjacent methylene group through an ether bond. Furthermore, the lubricating layer containing the fluorine-containing ether compound represented by Formula (1) has sufficient fluidity and flexibility due to the high mobility of two primary hydroxy groups included in the branched terminal group represented by Formula (2). From these facts, the lubricating layer containing the fluorine-containing ether compound represented by Formula (1) has extremely good adhesion to the protective layer.

As described above, the fluorine-containing ether compound represented by Formula (1) can form a lubricating layer having good adhesion to the protective layer, and the perfluoropolyether chain in the fluorine-containing ether compound contained in the lubricating layer can have a structure in which the perfluoropolyether chain closely adheres to the protective layer without being separated too far from the protective layer. Therefore, a lubricating layer in which the state on the protective layer is less likely to be bulky, and unevenness on the surface is suppressed can be obtained, and it is also possible to form a lubricating layer having good coatability which easily wets and spreads on the protective layer and has a uniform coating state. As a result, it is presumed that the fluorine-containing ether compound represented by Formula (1) can form a lubricating layer having excellent wear resistance and good smoothness.

Furthermore, since the lubricating layer containing the fluorine-containing ether compound represented by Formula (1) has sufficient fluidity and flexibility, even in a case where a part of the lubricating layer is deformed due to abrasion and the fluorine-containing ether compound in the lubricating layer moves to another location, the lubricating layer has high restoration power to return to the original position again. From this, it is presumed that the lubricating layer containing the fluorine-containing ether compound represented by Formula (1) has better smoothness and excellent wear resistance.

On the other hand, for example, in a case where a polar group that does not participate in the bonding with the active site on the protective layer is present in the fluorine-containing ether compound, the adhesion between the lubricating layer and the protective layer is insufficient. As a result, the fluorine-containing ether compounds contained in the lubricating layer locally aggregate, or a part of the molecules of the fluorine-containing ether compound floats from the surface of the protective layer, and thus unevenness is formed on the surface of the lubricating layer. Therefore, the state of the lubricant in the lubricating layer becomes bulky, the coating state of the lubricating layer with respect to the protective layer becomes non-uniform, and it is difficult to obtain a lubricating layer having good coatability and smoothness. In addition, in a case where the adhesion between the lubricating layer and the protective layer is insufficient, the high-speed rotation of the magnetic recording medium causes a change in the state of the lubricating layer present on the surface of the magnetic recording medium, degrades the wear resistance of the lubricating layer, and degrades the durability and reliability of the magnetic recording medium.

Specifically, for example, in a case where a divalent linking group having two or more secondary hydroxy groups is disposed instead of the divalent linking group represented by Formula (4) having only one secondary hydroxy group, two or more secondary hydroxy groups contained in the divalent linking group are likely to inhibit the bonding with the active point on the protective layer to each other. From this, in the fluorine-containing ether compound, there are cases where at least a part of two or more secondary hydroxy groups is likely to be a polar group that does not participate in the bonding with the active site on the protective layer, and the polar group that does not participate in the bonding with the active site on the protective layer is likely to aggregate by attracting a polar group between the molecules and/or in the molecule. Therefore, in a case where the divalent linking group having two or more secondary hydroxy groups is disposed instead of the divalent linking group represented by Formula (4), it is difficult to form a lubricating layer having good wear resistance and smoothness.

Furthermore, the present inventors confirmed that a lubricating layer having excellent wear resistance and good smoothness can be formed by forming a lubricating layer on the protective layer of the magnetic recording medium using the lubricant containing the fluorine-containing ether compound, and conceived the present invention.

Hereinafter, a fluorine-containing ether compound, a lubricant for a magnetic recording medium, and a magnetic recording medium of the present invention will be described in detail. The present invention is not limited only to embodiments shown below. In the present invention, the number, the amount, the ratio, the composition, the kind, the position, the material, the configuration, and the like can be added, omitted, substituted, or changed without departing from the gist of the present invention.

### [Fluorine-Containing Ether Compound]

A fluorine-containing ether compound of the present embodiment is represented by Formula (1).

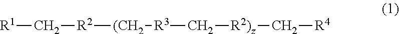

(In Formula (1), z is 1 or 2. R² is a perfluoropolyether chain. (z+1) R²'s may be the same in part or in whole, or may be different from each other. R¹ is a branched terminal group having 3 to 35 carbon atoms, which is represented by Formula (2). R⁴ is an organic group having 3 to 35 carbon atoms and having 1 to 3 polar groups, and may be the same as or different from R¹. R³ is a divalent linking group represented by Formula (4). In a case where z is 2, two R³'s may be the same as or different from each other.)

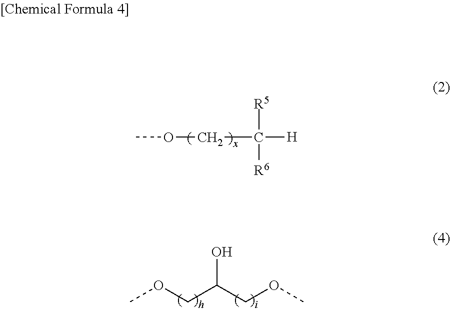

(In Formula (2), R⁵ and R⁶ are organic groups which do not include a secondary hydroxy group and a tertiary hydroxy group and include one primary hydroxy group, and may be the same as or different from each other. x is an integer of 0 to 3.)

(In Formula (4), h is an integer of 1 to 3, and i is an integer of 1 to 3.)

In the fluorine-containing ether compound represented by Formula (1), z is 1 or 2. Since z is 2 or less, in the fluorine-containing ether compound represented by Formula (1), the molecule does not become too large. Therefore, a fluorine-containing ether compound, which can freely move on the protective layer, easily wets and spreads on the protective layer, and makes it easy for a lubricating layer having a uniform film thickness to be obtained, is obtained. In addition, since z is 1 or more, the divalent linking group represented by Formula (4) having a secondary hydroxy group can be disposed between adjacent perfluoropolyether chains. Therefore, the central portion of the chain-like structure of the fluorine-containing ether compound is caused to closely adhere to the protective layer, and the fluorine-containing ether compound becomes capable of forming a lubricating layer having good adhesion to the protective layer, as compared with a case where z is 0 (a case where there is only one perfluoropolyether chain).

### (Perfluoropolyether Chain Represented by R²)

In the fluorine-containing ether compound represented by Formula (1), (z+1) R²'s are each independently a perfluoropolyether chain (hereinafter, may be referred to as a “PFPE chain”). In a case where a lubricant containing the fluorine-containing ether compound of the present embodiment is applied onto the protective layer to form a lubricating layer, the PFPE chain represented by R² coats the surface of the protective layer and imparts lubricity to the lubricating layer to reduce the frictional force between the magnetic head and the protective layer. The PFPE chain represented by R² is appropriately selected depending on the performance or the like required for the lubricant including the fluorine-containing ether compound.

In the fluorine-containing ether compound represented by Formula (1), (z+1) R²'s may be the same as each other in part or in whole, or may be different from each other. It is preferable that all of (z+1) R²'s are the same as each other. This is because the coating state of the fluorine-containing ether compound with respect to the protective layer becomes uniform, and the lubricating layer has better adhesion. Two or more R²'s among (z+1) R²'s being the same means that two or more R²'s having the same structure of the repeating unit of the PFPE chain are included among (z+1) R²'s. The same R²'s also includes R²'s having the same structure of the repeating unit but different average degrees of polymerization.

Examples of the PFPE chain represented by R² include chains composed of a polymer or copolymer of a perfluoroalkylene oxide. Examples of the perfluoroalkylene oxide include perfluoromethylene oxide, perfluoroethylene oxide, perfluoro-n-propylene oxide, perfluoroisopropylene oxide, and perfluorobutylene oxide.

It is preferable that (z+1) R²'s in Formula (1) are each independently, for example, a PFPE chain represented by Formula (5) derived from a polymer or copolymer of a perfluoroalkylene oxide.

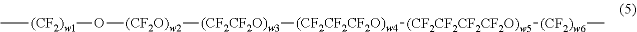

(In Formula (5), w2, w3, w4, and w5 represent average degrees of polymerization and each independently represent 0 to 20. Here, there are no cases where all of w2, w3, w4, and w5 become 0 at the same time. w1 and w6 are average values representing the number of CF₂'s and each independently represent 1 to 3. An order of arrangement of (CF₂O), (CF₂CF₂O), (CF₂CF₂CF₂O), and (CF₂CF₂CF₂CF₂O), which are repeating units in Formula (5), is not particularly limited.)

In Formula (5), w2, w3, w4, and w5 represent the average degrees of polymerization, each independently represent 0 to 20, and are preferably 0 to 15 and more preferably 0 to 10.

In Formula (5), w1 and w6 are the average values indicating the number of CF₂'s, and each independently represent 1 to 3. w1 and w6 are determined depending on the structure of the repeating unit disposed at the end part of the chain-like structure in the PFPE chain represented by Formula (5), and the like.

(CF₂O), (CF₂CF₂O), (CF₂CF₂CF₂O), and (CF₂CF₂CF₂CF₂O) in Formula (5) are repeating units. The order of arrangement of the repeating units in Formula (5) is not particularly limited. In addition, the number of the kinds of repeating units in Formula (5) is not particularly limited.

It is preferable that (z+1) R²'s in Formula (1) are each independently any one selected from PFPE chains represented by Formulae (5-1) to (5-4).

In a case where (z+1) R²'s are each independently any one selected from the PFPE chains represented by Formulae (5-1) to (5-4), a fluorine-containing ether compound from which a lubricating layer having good lubricity can be obtained is obtained. In addition, in a case where (z+1) R²'s are each independently any one selected from the PFPE chains represented by Formulae (5-1) to (5-4), the proportion of the number of oxygen atoms (the number of ether bonds (—O—)) in the number of carbon atoms in the PFPE chain is appropriate. Therefore, the fluorine-containing ether compound has appropriate hardness. Therefore, the fluorine-containing ether compound applied onto the protective layer is less likely to aggregate on the protective layer, and a lubricating layer having a thinner thickness can be formed with a sufficient coating rate.

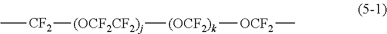

(In Formula (5-1), j and k represent average degrees of polymerization, j represents 1 to 20, and k represents 0 to 20.)

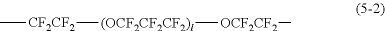

(In Formula (5-2), 1 represents an average degree of polymerization, and represents 1 to 15.)

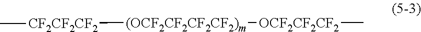

(In Formula (5-3), m represents an average degree of polymerization, and represents 1 to 10.)

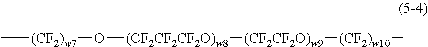

(In Formula (5-4), w8 and w9 represent average degrees of polymerization and each independently represent 1 to 20. w7 and w10 are average values representing the number of CF₂'s and each independently representing 1 to 2.)

In Formula (5-1), the order of arrangement of (OCF₂CF₂) and (OCF₂), which are repeating units, is not particularly limited. In Formula (5-1), the number j of (OCF₂CF₂)'s and the number k of (OCF₂)'s may be the same as or different from each other. The PFPE chain represented by Formula (5-1) may be a polymer of (OCF₂CF₂). In addition, the PFPE chain represented by Formula (5-1) may be any one of a random copolymer, block copolymer, or alternating copolymer composed of (OCF₂CF₂) and (OCF₂).

In Formulae (5-1) to (5-3), since j indicating the average degree of polymerization is 1 to 20, k is 0 to 20, 1 is 1 to 15, and m is 1 to 10, a fluorine-containing ether compound from which a lubricating layer having good lubricity can be obtained is obtained. In addition, in Formulae (5-1) to (5-3), since j and k indicating the average degrees of polymerization are 20 or less, l is 15 or less, and m is 10 or less, the viscosity of the fluorine-containing ether compound does not become excessively high, and it is easy to apply a lubricant including this fluorine-containing ether compound, which is preferable. Since a fluorine-containing ether compound, which easily wets and spreads on the protective layer and makes it easy for a lubricating layer having a uniform film thickness to be obtained, is obtained, j, k, 1, and m representing the average degrees of polymerization are preferably 1 to 10, more preferably 1.5 to 8, and still more preferably 2to 7.

In Formula (5-4), the order of arrangement of (CF₂CF₂CF₂O) and (CF₂CF₂O), which are repeating units, is not particularly limited. In Formula (5-4), the number w8 of (CF₂CF₂CF₂O)'s and the number w9 of (CF₂CF₂O)'s may be the same as or different from each other. Formula (5-4) may a PFPE chain containing any one of a random copolymer, block copolymer, or alternating copolymer composed of monomer units (CF₂CF₂CF₂O) and (CF₂CF₂O).

In Formula (5-4), w8 and w9 representing the average degrees of polymerization are each independently 1 to 20, preferably 1 to 15, and more preferably 1 to 10.

w7 and w10 in Formula (5-4) are the average values indicating the number of CF₂'s, and each independently represent 1 to 2. w7 and w10 are determined depending on the structure of the repeating unit disposed at the end part of the chain-like structure in the perfluoropolyether chain represented by Formula (5-4).

### (Divalent Linking Group Represented by R³)

In the fluorine-containing ether compound represented by Formula (1), R³ is a divalent linking group represented by Formula (4). z R³'s are each disposed between (z+1) R²'s representing the PFPE chains. Therefore, R³'s cause the fluorine-containing ether compound and the protective layer to closely adhere to each other to form a thin lubricating layer with a sufficient coating rate.

In addition, the divalent linking group represented by R³ has only one secondary hydroxy group and is disposed between adjacent PFPE chains. Therefore, the secondary hydroxy group in R³ is less likely to be inhibited from bonding with the active site on the protective layer, and is bonded to the active site on the protective layer to improve the adhesion to the protective layer. As a result, in the lubricating layer including the fluorine-containing ether compound represented by Formula (1), the PFPE chains disposed at both terminals of R³ are suppressed from being separated too far from the protective layer, the unevenness of the surface is reduced, and the lubricating layer has excellent smoothness.

In Formula (4), h and i are integers of 1 to 3, and it is preferable that at least one of h or i is 1. In a case where at least one of h or i is 1, the production of the fluorine-containing ether compound becomes easy, which is preferable. In order to maintain the flexibility of the entire linking group, it is more preferable that h is 1 and i is 1.

In a case where z in Formula (1) is 2, two R³'s may be the same as or different from each other. In a case where R³'s are the same as each other, the coating state of the fluorine-containing ether compound with respect to the protective layer is more uniform, and a lubricating layer having better adhesion can be formed. In a case where z in Formula (1) is 2, two R³'s being the same as each other means that atoms included in two R³'s are symmetrically disposed with respect to R² in the center of the molecule.

### (Terminal Group Represented by R¹)

In Formula (1), the terminal group represented by R¹ is a branched terminal group having 3 to 35 carbon atoms, which is represented by Formula (2). In the branched terminal group represented by Formula (2), two organic groups (R⁵ and R⁶) which do not include a secondary hydroxy group and a tertiary hydroxy group and include one primary hydroxy group are bonded to a trisubstituted carbon atom which is a branching point.

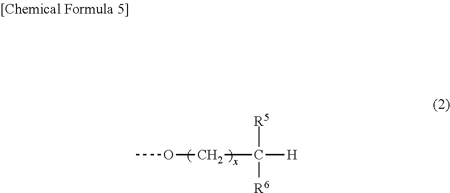

(In Formula (2), R⁵ and R⁶ are organic groups which do not include a secondary hydroxy group and a tertiary hydroxy group and include one primary hydroxy group, and may be the same as or different from each other. x is an integer of 0 to 3.)

The number of the carbon atoms of the branched terminal group represented by Formula (2) is 3 to 35, preferably 3 to 20, and more preferably 3 to 12. The number of the carbon atoms in the branched terminal group may be 3 to 5, 5 to 10, or 10 to 15.

Since the branched terminal group represented by Formula (2) has 35 or less carbon atoms, the distance between two primary hydroxy groups included in the branched terminal group is not too long. Therefore, both of two primary hydroxy groups included in the branched terminal group represented by Formula (2) can easily have an orientation in which both are easily adsorbed to the protective layer, and are easily bonded to the active points on the protective layer. In addition, since the number of the carbon atoms of the branched terminal group represented by Formula (2) is 3 to 35, the proportion of the number of carbon atoms to the number of hydroxy groups becomes appropriate, and the polarity of the molecule becomes appropriate in the fluorine-containing ether compound. In addition, in a case where the number of the carbon atoms of the branched terminal group represented by Formula (2) is 3 to 12, the proportion of fluorine atoms in the fluorine-containing ether compound molecule is reduced, and thus it is possible to suppress an increase in the surface free energy of the entire molecule.

x in Formula (2) represents an integer of 0 to 3. x is preferably 1 to 3. In this case, the interatomic distance between the perfluoropolyether chain represented by R² and the trisubstituted carbon atom contained in Formula (2) becomes more appropriate. Therefore, the interatomic distance between the perfluoropolyether chain represented by R² and two primary hydroxy groups contained in Formula (2) is also likely to become more appropriate. Therefore, both of two primary hydroxy groups included in Formula (2) are less likely to be affected by the bulkiness due to the adjacent perfluoropolyether chain, and are likely to be adsorbed to the protective layer. As a result, a lubricating layer having more excellent adhesion to the protective layer and more excellent wear resistance can be obtained.

In Formula (2), R⁵ and R⁶ are each independently an organic group which does not contain a secondary hydroxy group and a tertiary hydroxy group, contains one primary hydroxy group, and is bonded to the trisubstituted carbon atom. Therefore, the numbers of the carbon atoms of R⁵ and R⁶ are each 1 or more. The organic groups represented by R⁵ and R⁶ may be each independently linear or branched, and are preferably linear. In a case where the organic group represented by R⁵ (or R⁶) is linear, the primary hydroxy group contained in R⁵ (or R⁶) can move freely, as compared with a case where the organic group represented by R⁵ (or R⁶) is branched. Therefore, the primary hydroxy group contained in R⁵ (or R⁶) can more easily form a bond with the active site on the protective layer.

It is preferable that two primary hydroxy groups included in R⁵ and R⁶ in Formula (2) are separated from each other by five or more atoms. In other words, it is preferable that an oxygen atom of one primary hydroxy group of two primary hydroxy groups included in R⁵ and R⁶ is bonded to an oxygen atom of the other primary hydroxy group through a linking group to which five or more atoms including the trisubstituted carbon atom are linked. In this case, the distance between two primary hydroxy groups in Formula (2) is sufficiently separated, the interaction between the primary hydroxy groups is less likely to be dominant, and it is possible to more effectively suppress the bonding with the protective layer being inhibited by the adjacent primary hydroxy group. Therefore, in a case where two primary hydroxy groups included in R⁵ and R⁶ are separated from each other by five or more atoms, both of two primary hydroxy groups included in R⁵ and R⁶ can more easily form a bond with the active point on the protective layer, and a lubricating layer having more excellent smoothness can be formed.

The organic group represented by R⁵ and/or R⁶ in Formula (2) preferably includes one or more ether bonds (—O—). In this case, since the branched terminal group represented by Formula (2) becomes appropriately flexible, the lubricating layer containing the fluorine-containing ether compound represented by Formula (1) has more excellent adhesion to the protective layer.

In a case where the organic group represented by R⁵ (or R⁶) in Formula (2) has a plurality of ether bonds, it is preferable that adjacent ether bonds are bonded to each other through a linking group in which two or more carbon atoms are linked. In this case, the distance between the adjacent ether bonds is appropriate, and thus the fluorine-containing ether compound is less likely to aggregate.

Formula (2) is preferably a branched terminal group of any of Formula (2-1) or (2-2). In a case where Formula (2) is the branched terminal group of any of Formula (2-1) or (2-2), carbon atoms to which two primary hydroxy groups included in Formula (2-1) or (2-2) are bonded are bonded to each other through any linking group selected from a linking group composed of a methine group, a linking group including a methine group and a methylene group, and a linking group including a methine group, a methylene group, and an ether bond. Therefore, in the branched terminal group in Formula (2-1) or (2-2), the distance between two primary hydroxy groups in the branched terminal group is appropriate, and two primary hydroxy groups do not inhibit the bonding with the active site on the protective layer each other. Therefore, two primary hydroxy groups in Formula (2-1) or (2-2) can each independently interact with the protective layer.

Moreover, in a case where Formula (2) is the branched terminal group of any of Formula (2-1) or (2-2), the number of carbon atoms in the branched terminal group is not too large, and the molecular weight of Formula (2-1) or (2-2) does not become too large. Therefore, the proportion of fluorine atoms in the fluorine-containing ether compound molecule is less likely to decrease, and an increase in the surface free energy of the entire molecule can be suppressed.

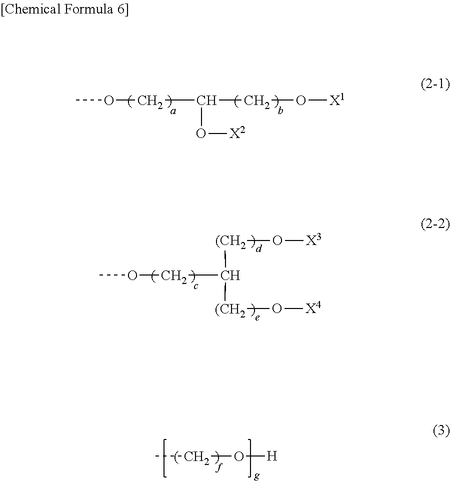

(In Formula (2-1), a is an integer of 1 to 3, and b is an integer of 1 to 4. X¹ is a hydrogen atom or a group represented by Formula (3). X² is a group represented by Formula (3). X¹ and X² may be the same as or different from each other.)

(In Formula (2-2), c is an integer of 0 to 3, and d and e are each independently an integer of 1 to 5. X³ and X⁴ are each independently a hydrogen atom or a group represented by Formula (3). X³ and X⁴ may be the same as or different from each other.)

(In Formula (3), f is an integer of 2 to 5, and g is 1 or 2.)

a in Formula (2-1) represents an integer of 1 to 3. Since a in Formula (2-1) is an integer of 1 to 3, the interatomic distance between the perfluoropolyether chain represented by R² and the trisubstituted carbon atom contained in Formula (2) is appropriate. Therefore, both of two primary hydroxy groups included in Formula (2-1) are less likely to be affected by the bulkiness due to the adjacent perfluoropolyether chain, and are more likely to be adsorbed to the protective layer. As a result, a lubricating layer having more excellent wear resistance can be formed. a is preferably an integer of 1 or 2 and most preferably 1 since it becomes easy to secure the proportion of fluorine atoms in the fluorine-containing ether compound molecule.

b in Formula (2-1) represents an integer of 1 to 4. In a case where X¹ is Formula (3), b is preferably an integer of 1 or 2 since it becomes easy to secure the proportion of fluorine atoms in the fluorine-containing ether compound molecule. In addition, in a case where X¹ is a hydrogen atom and f in X² (In Formula (3)) is 2 or 3, b in Formula (2-1) is preferably 2 to 4 and more preferably 3 or 4. In a case where X¹ is a hydrogen atom and f in X² (=in Formula (3)) is 2 or 3, when b in Formula (2-1) is 2 or more, and the atomic distance between two primary hydroxy groups included in Formula (2-1) becomes more appropriate. Therefore, it is possible to effectively suppress two primary hydroxy groups included in Formula (2-1) inhibiting the bonding with the active points on the protective layer each other. As a result, both of two primary hydroxy groups included in Formula (2-1) are likely to be adsorbed by the protective layer, and a lubricating layer having more excellent wear resistance and better smoothness can be formed.

X¹ in Formula (2-1) is a hydrogen atom or a group represented by Formula (3). X² is a group represented by Formula (3). X¹ and X² may be the same as or different from each other. In a case where both X¹ and X² are the group represented by Formula (3) and the same as each other, the production of the fluorine-containing ether compound may become easy, which is preferable. In a case where X¹ and X² are different from each other, X¹ is preferably a hydrogen atom since it becomes easy to secure the proportion of fluorine atoms in the fluorine-containing ether compound molecule.

c in Formula (2-2) represents an integer of 0 to 3. c is preferably an integer of 0 to 2 since it becomes easy to secure the proportion of fluorine atoms in the fluorine-containing ether compound molecule. In addition, since the interatomic distance between the perfluoropolyether chain represented by R² and the trisubstituted carbon atom included in Formula (2-2) is more appropriate, and the interatomic distance between the perfluoropolyether chain represented by R² and two primary hydroxy groups included in Formula (2-2) is likely to be more appropriate, c is more preferably 1 or 2. In particular, in a case where X³ and X⁴ are hydrogen atoms, the interatomic distance between the perfluoropolyether chain represented by R² and two primary hydroxy groups included in Formula (2-2) is more appropriate, and a lubricating layer having more excellent wear resistance can be formed, and thus c is more preferably 1 or 2.

d and e in Formula (2-2) each independently represent an integer of 1 to 5. d and e are each independently preferably an integer of 1 to 3 and more preferably 1 or 2 since it becomes easy to secure the proportion of fluorine atoms in the fluorine-containing ether compound molecule. d and e may be the same as or different from each other. d and e are preferably the same as each other since the production of the fluorine-containing ether compound is easy. In addition, since the interatomic distance between two primary hydroxy groups included in Formula (2-2) becomes appropriate, it is preferable that the total of d and e is 4 or more. In addition, since the interatomic distance between the perfluoropolyether chain represented by R² and the primary hydroxy group included in Formula (2-2) is likely to become more appropriate, the total of c and d and the total of c and e are each preferably 3 or more.

X³ and X⁴ in Formula (2-2) are hydrogen atoms or groups represented by Formula (3). X³ and X⁴ may be the same as or different from each other. In a case where X³ and X⁴ are the same as each other, the production of the fluorine-containing ether compound is easy, which is preferable. Since it becomes easy to secure the proportion of fluorine atoms in the fluorine-containing ether compound molecule, X³ and/or X⁴ is preferably a hydrogen atom, and both X³ and X⁴ are more preferably hydrogen atoms.

f in Formula (3) represents an integer of 2 to 5. f is preferably an integer of 2 to 4 and more preferably 2 or 3. f in Formula (3) is appropriately determined depending on the numerical values of a and b in Formula (2-1), the kind of X¹, the numerical values of c, d, and e in Formula (2-2), and the like.

In a case where X¹ in Formula (2-1) is a hydrogen atom and X² is Formula (3), f in Formula (3) is preferably 2 or 3. This is because the interatomic distance between two primary hydroxy groups included in Formula (2-1) is likely to become more appropriate.

In a case where X³ and/or X⁴ in Formula (2-2) is Formula (3), f in Formula (3) is preferably 2 or 3 since it becomes easy to secure the proportion of fluorine atoms in the fluorine-containing ether compound molecule.

g in Formula (3) represents 1 or 2. In a case where g is 2, f's in the individual [—(CH₂)ᵣ—O—]'s may be the same as or different from each other. g in Formula (3) is preferably 1 since it becomes easy to secure the proportion of fluorine atoms in the fluorine-containing ether compound molecule.

### (Terminal Group Represented by R⁴)

In the fluorine-containing ether compound represented by Formula (1), the terminal group represented by R⁴ is an organic group having 3 to 35 carbon atoms and having 1 to 3 polar groups. The terminal group represented by R⁴ is preferably an organic group having 3 to 20 carbon atoms, and more preferably an organic group having 3 to 12 carbon atoms. In a case where the number of the carbon atoms in the terminal group represented by R⁴ is 3 to 35, the proportion of the number of carbon atoms to the number of polar groups becomes appropriate, and the fluorine-containing ether compound has an appropriate molecular polarity.

In the terminal group represented by R⁴, it is preferable that an end portion bonded to an adjacent methylene group is an oxygen atom. In this case, R⁴ is bonded to a methylene group adjacent to the ether bond, whereby the fluorine-containing ether compound has appropriate hardness. Therefore, the fluorine-containing ether compound applied onto the protective layer is less likely to aggregate on the protective layer, and a lubricating layer having more excellent coatability and smoothness can be formed even in a case where the thickness is reduced.

Examples of the polar group contained in the terminal group represented by R⁴ include a hydroxy group (—OH), an amino group (—NR⁷R⁸; R⁷ and R⁸ are each independently a hydrogen atom or an organic group), a carboxy group (—COOH), a formyl group (—(C═O)H), a carbonyl group (—(C═O)R⁹; R⁹ is an organic group), a sulfo group (—SO₃H), a cyano group (—CN), and a group having an amide bond (—NR¹⁰COR¹¹ or —CONR¹²R¹³; R¹⁰, R¹¹, R¹², and R¹³ are each independently a hydrogen atom or an organic group). The “group having an amide bond” includes both a group bonding to a carbon atom constituting the amide bond (for example, a carboxamide group (—C(═O)NH₂)) and a group bonding to a nitrogen atom constituting the amide bond (for example, an acetanide group (—NHC(═O)CH₃)), as shown in the above formulae. In the group having an amide bond, R¹⁰ and R¹¹ may be bonded to each other to form a ring, or R¹² and R¹³ may be bonded to each other to form a ring. It is preferable that R¹⁰, R¹¹, R¹², and R¹³ in the group having an amide bond are each independently selected from the group consisting of a hydrogen atom, a methyl group, an ethyl group, a propyl group, and a butyl group.

In a case where the terminal group represented by R⁴ has a polar group containing a carbon atom (for example, a carboxy group, a formyl group, a carbonyl group, a cyano group, or a group having an amide bond), the carbon atom contained in the polar group is included in the number of the carbon atoms in the terminal group represented by R⁴.

Since the fluorine-containing ether compound can form a lubricating layer having further improved adhesion to the protective layer, the numbers of polar groups contained in the terminal groups represented by R⁴ are 1 to 3 and preferably 2 or 3. In a case where the number of the polar groups is 3 or less, in the magnetic recording medium having the lubricating layer containing the fluorine-containing ether compound, the occurrence of aggregation of the fluorine-containing ether compound due to the excessively large number of the polar groups contained in the fluorine-containing ether compound and the deterioration of smoothness can be prevented.

In a case where R⁴ includes two or more polar groups, it is preferable that two or more polar groups are each bonded to different carbon atoms and one or more carbon atoms are included between carbon atoms to which the adjacent polar groups are bonded. In this case, the adjacent polar groups are bonded to each other at an appropriate interatomic distance, as compared with a case where the carbon atoms to which the adjacent polar groups are bonded are directly bonded to each other. Therefore, the plurality of polar groups contained in R⁴ are oriented such that all of the polar groups can closely adhere to the protective layer. As a result, the plurality of polar groups contained in R⁴ are less likely to aggregate and can easily form a bond with the active point on the protective layer.

The terminal group represented by R⁴ may be an organic group having 1 to 3 polar groups and further having a carbon-carbon unsaturated bond site. In a case where the terminal group represented by R⁴ has the carbon-carbon unsaturated bond site, the terminal group is preferably an organic group having at least one selected from the group consisting of an aromatic hydrocarbon group, an unsaturated heterocyclic group, an alkenyl group, and an alkynyl group.

Examples of the aromatic hydrocarbon group include a phenyl group, a methoxyphenyl group, a fluorophenyl group, a naphthyl group, and a methoxynaphthyl group. As described above, the aromatic hydrocarbon group also includes a group in which a substituent such as a methoxy group or a fluoro group is bonded to an aromatic hydrocarbon.

Examples of the unsaturated heterocyclic group include a pyrrolyl group, a pyrazolyl group, a methylpyrazolyl group, an imidazolyl group, a furyl group, a furfuryl group, an oxazolyl group, an isoxazolyl group, a thienyl group, a thiazolyl group, an isothiazolyl group, a pyridyl group, a pyrimidinyl group, a pyridazinyl group, a pyrazinyl group, an indolinyl group, a benzofuranyl group, a benzothienyl group, a benzimidazolyl group, a benzoxazolyl group, a benzothiazolyl group, a benzopyrazolyl group, a benzisoxazolyl group, a benzisothiazolyl group, a quinolyl group, an isoquinolyl group, a quinazolinyl group, a quinoxalinyl group, a phthalazinyl group, and a cinnolinyl group. The unsaturated heterocyclic group also includes a group in which a substituent such as a methyl group is bonded to an unsaturated heterocyclic ring, as described above.

Examples of the alkenyl group include a vinyl group, an allyl group, a butenyl group, a pentenyl group, and a hexenyl group.

Examples of the alkynyl group include a 1-propynyl group, a propargyl group, a butynyl group, a pentynyl group, and a hexynyl group.

In a case where the terminal group represented by R⁴ has the carbon-carbon unsaturated bond site, the lubricating layer containing the fluorine-containing ether compound is preferable since it has excellent adhesion to the protective layer and can be made thinner. The reason will be described below.

A large number of active points present on the protective layer include a locally charged portion and a portion where the charge distribution is spread. The hydroxy group contained in R¹ and R³ in Formula (1) (and the hydroxy group in a case where R⁴ has a hydroxy group) and the carbon-carbon unsaturated bond site contained in the terminal group represented by R⁴ are adsorbed to mutually different sites on the protective layer.

Specifically, the hydroxy groups contained in R¹ and R; in Formula (1) (and the hydroxy group in a case where R⁴ has a hydroxy group) exhibit an adsorption ability by a hydrogen atom interacting with the locally charged portion on the protective layer through a hydrogen bond. On the other hand, since the carbon-carbon unsaturated bond site included in the terminal group represented by R⁴ has a non-local charge, the carbon-carbon unsaturated bond site exhibits an adsorption ability by an interaction with the portion where the charge distribution is spread on the protective layer.

Therefore, the hydroxy groups contained in R¹ and R³ in Formula (1) (and the hydroxy group in a case where R⁴ has a hydroxy group) and the carbon-carbon unsaturated bond site contained in the terminal group represented by R⁴ can each independently interact with the active points on the protective layer. As a result, the lubricating layer containing the fluorine-containing ether compound in which the terminal group represented by R⁴ has the carbon-carbon unsaturated bond site has more excellent adhesion to the protective layer, good smoothness, and high wear resistance.

The terminal group represented by R⁴ may include two primary hydroxy groups. In this case, it is preferable that R⁴ does not contain any polar group other than two primary hydroxy groups. In a case where R⁴ does not include any polar group other than two primary hydroxy groups having high motility and adsorptivity, it is possible to prevent the generation of polar groups that cannot be adsorbed to the protective layer and are liberated due to excessive polar groups that cannot participate in the adsorption to the protective layer. Therefore, it is possible to prevent the polar groups between the molecules and/or in the molecule from aggregating.

R⁴ may be the branched terminal group represented by Formula (2), similar to R¹. In this case, two primary hydroxy groups included in R⁴ in Formula (2) are likely to participate in the bonding with the active site present on the protective layer, similarly to two primary hydroxy groups included in R¹ in Formula (2). In addition, in a case where R⁴ is the branched terminal group represented by Formula (2), similar to R¹, the fluorine-containing ether compound has appropriate flexibility due to the bonding with an adjacent methylene group through an ether bond, and has sufficient fluidity and flexibility due to high mobility of two primary hydroxy groups included in the branched terminal group represented by Formula (2). Therefore, it is presumed that the lubricating layer containing the fluorine-containing ether compound represented by Formula (1) has good adhesion to the protective layer, good smoothness, and excellent wear resistance.

In a case where R⁴ is the branched terminal group represented by Formula (2), R⁴ is preferably the branched terminal group of any of Formula (2-1) or (2-2). In this case, the preferred values of a and b in Formula (2-1), c to e in Formula (2-2), and f and g in Formula (3) are the same as those in a case where R¹ is the branched terminal group of any one of Formula (2-1) or (2-2).

In Formula (1), in a case where R⁴ is the branched terminal group represented by Formula (2), it is still more preferable that both R¹ and R⁴ are the branched terminal groups of any one of Formula (2-1) or (2-2).

In Formula (1), in a case where R⁴ is the branched terminal group represented by Formula (2), R¹ and R⁴ are preferably the same as each other, and both R¹ and R⁴ are more preferably Formula (2-1) or Formula (2-2). In a case where R¹ and R⁴ are the same as each other, the coating state of the fluorine-containing ether compound with respect to the protective layer is more uniform, and a lubricating layer having better adhesion can be formed.

In the fluorine-containing ether compound represented by Formula (1), it is preferable that z is 1, R¹ and R⁴ are the same as each other, and two R²'s are the same as each other. This is because the fluorine-containing ether compound becomes easy to synthesize. In addition, this is because the fluorine-containing ether compound having a symmetric structure is more likely to wet and spread on the protective layer, and thus a lubricating layer having good coatability can be formed.

In the fluorine-containing ether compound represented by Formula (1), it is preferable that z is 2, R¹ and R⁴ are the same as each other, and three R²'s are the same as each other. This is because the fluorine-containing ether compound becomes easy to synthesize. Furthermore, in a case where z is 2, it is preferable that two R³'s are the same as each other. This is because the fluorine-containing ether compound becomes easier to synthesize. In addition, this is because the fluorine-containing ether compound having a symmetric structure is more likely to wet and spread on the protective layer, and thus a lubricating layer having good coatability can be formed.

In a case where R⁴ is not the terminal group represented by Formula (2), the terminal group represented by R⁴ is preferably a terminal group containing two or three polar groups, in which at least one of the polar groups is a secondary hydroxy group. In a case where R⁴ is not the terminal group represented by Formula (2), the terminal group represented by R⁴ is specifically preferably a terminal group represented by any of Formulae (6-1) to (6-3).

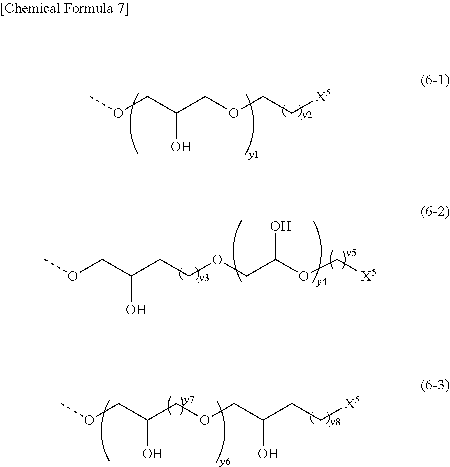

(In Formula (6-1), y1 is 1 or 2, and y2 is an integer of 0 to 3. X⁵ is an aromatic hydrocarbon group, an unsaturated heterocyclic group, an alkenyl group, an alkynyl group, or a polar group. In a case where y1 is 1, X⁵ is a polar group. In a case where X⁵ is the aromatic hydrocarbon group or the unsaturated heterocyclic group, an atom constituting a ring structure in X⁵ is bonded to a methylene group adjacent to X⁵. In a case where X⁵ is the alkenyl group or the alkynyl group, a carbon atom constituting an unsaturated bond in X⁵ is bonded to a methylene group adjacent to X⁵.)

(In Formula (6-2), y3 is an integer of 1 to 3, y4 is 0 or 1, and y5 is an integer of 0 to 3. X⁵ is an aromatic hydrocarbon group, an unsaturated heterocyclic group, an alkenyl group, an alkynyl group, or a polar group. In a case where y4 is 0, X⁵ is a polar group. In a case where X⁵ is the aromatic hydrocarbon group or the unsaturated heterocyclic group, an atom constituting a ring structure in X⁵ is bonded to a methylene group adjacent to X⁵. In a case where X⁵ is the alkenyl group or the alkynyl group, a carbon atom constituting an unsaturated bond in X⁵ is bonded to a methylene group adjacent to X⁵.)

(In Formula (6-3), y6 is 0 or 1, y7 is an integer of 1 to 3, and y8 is an integer of 1 to 3. X⁵ is an aromatic hydrocarbon group, an unsaturated heterocyclic group, an alkenyl group, an alkynyl group, or a polar group. In a case where y6 is 0, X⁵ is a polar group. In a case where X⁵ is the aromatic hydrocarbon group or the unsaturated heterocyclic group, an atom constituting a ring structure in X⁵ is bonded to a methylene group adjacent to X⁵. In a case where X⁵ is the alkenyl group or the alkynyl group, a carbon atom constituting an unsaturated bond in X⁵ is bonded to a methylene group adjacent to X⁵.)

In Formulae (6-1) to (6-3), in a case where X⁵ is an aromatic hydrocarbon group, an atom constituting a ring structure in X⁵ is bonded to a methylene group adjacent to X⁵. In a case where X⁵ is an aromatic hydrocarbon group, the aromatic hydrocarbon group exemplified above can be used as X⁵.

In Formulae (6-1) to (6-3), in a case where X⁵ is an unsaturated heterocyclic group, an atom constituting a ring structure in X⁵ is bonded to a methylene group adjacent to X⁵. In a case where X⁵ is an unsaturated heterocyclic group, the unsaturated heterocyclic group exemplified above can be used as X⁵.

In Formulae (6-1) to (6-3), in a case where X⁵ is an alkenyl group, a carbon atom constituting an unsaturated bond in X⁵ is bonded to a methylene group adjacent to X⁵. In a case where X⁵ is an alkenyl group, examples of X⁵ include —CH═CH₂, —CH═CHR¹⁴ (R¹⁴ is an organic group), —CR¹⁵═CHR¹⁶ (R¹⁵ and R¹⁶ are organic groups), and —CR⁴═CR¹⁸R¹⁹ (R¹⁷, R¹⁸, and R¹⁹ are organic groups). The organic groups represented by R¹⁴ to R¹⁹ are each preferably a hydrocarbon group having 1 to 3 carbon atoms. In a case where X⁵ in Formulae (6-1) to (6-3) is an alkenyl group, X⁵ is preferably —CH═CH₂. —CH═CH₂ has an appropriate bulkiness. Therefore, the lubricating layer containing the fluorine-containing ether compound having a terminal group in which X⁵ is —CH═CH₂ is likely to be in a state where the bulkiness of the fluorine-containing ether compound on the protective layer is low and has good smoothness.

In Formulae (6-1) to (6-3), in a case where X⁵ is an alkynyl group, a carbon atom constituting an unsaturated bond in X⁵ is bonded to a methylene group adjacent to X⁵. In a case where X⁵ is an alkynyl group, examples of X⁵ include —C≡CH and —C≡CR²⁰ (R⁰ is an organic group). The organic group represented by R⁰ is preferably a hydrocarbon group having 1 to 3 carbon atoms. In a case where X⁵ in Formulae (6-1) to (6-3) is an alkynyl group, X⁵ is preferably —C≡CH since X⁵ becomes a terminal group having an appropriate bulkiness.

In Formulae (6-1) to (6-3), in a case where X⁵ is a polar group, the polar group exemplified above can be used as X⁵. Among these polar groups, X⁵ is preferably a hydroxy group, a group having an amide bond, or a cyano group. In a case where X⁵ is a hydroxy group, a group having an amide bond, or a cyano group, a more suitable interaction occurs between the lubricating layer and the protective layer in a case where the lubricating layer is formed on the protective layer using a lubricant containing X⁵. In a case where X⁵ in Formulae (6-1) to (6-3) is a polar group, the lubricating layer containing the fluorine-containing ether compound is more excellent in adhesion to the protective layer and can be made thinner, which is preferable. The reason will be described below.

In Formulae (6-1) to (6-3), the secondary hydroxy group in Formulae (6-1) to (6-3) and X⁵ are bonded to each other through a divalent organic group which may include an ether bond. Therefore, even in a case where X⁵ is a polar group, the distance between the secondary hydroxy group in Formulae (6-1) to (6-3) and the polar group represented by X⁵ becomes appropriate. As a result, the secondary hydroxy group in Formulae (6-1) to (6-3) and the polar group represented by X⁵ are less likely to be inhibited from bonding to the active point on the protective layer by another polar group. In addition, the secondary hydroxy group in Formulae (6-1) to (6-3) and the polar group represented by X⁵ are less likely to aggregate.

Therefore, the secondary hydroxy group in each of Formulae (6-1) to (6-3) and the polar group represented by X⁵ can be each independently adsorbed to the active point on the protective layer. As a result, the lubricating layer containing the fluorine-containing ether compound having a terminal group in which X⁵ in Formulae (6-1) to (6-3) is a polar group has more excellent adhesion to the protective layer, good smoothness, and excellent wear resistance even in a case where the thickness is small.

Among the above, X⁵ in Formulae (6-1) to (6-3) is preferably any one of a hydroxy group, a group having an amide bond, a cyano group, or —CH═CH₂. This is because a fluorine-containing ether compound capable of forming a lubricating layer having a higher coating rate and more excellent smoothness and wear resistance can be obtained.

In the terminal group represented by Formula (6-1), y1 is 1 or 2, and y2 is an integer of 0 to 3. In a case where y1 is 1, X⁵ is a polar group, and Formula (6-1) has two polar groups. In this case, since Formula (6-1) has two polar groups, a lubricating layer having good adhesion to the protective layer can be formed. In a case where y1 is 2, X⁵ may be any of an aromatic hydrocarbon group, an unsaturated heterocyclic group, an alkenyl group, an alkynyl group, or a polar group. Even in a case where y1 is 2 and X⁵ is any one of an aromatic hydrocarbon group, an unsaturated heterocyclic group, an alkenyl group, or an alkynyl group, Formula (6-1) has two polar groups. Therefore, a lubricating layer having good adhesion to the protective layer can be formed. In addition, since X⁵ is an aromatic hydrocarbon group, an unsaturated heterocyclic group, an alkenyl group, or an alkynyl group, a lubricating layer having excellent smoothness and wear resistance can be formed by the a-n interaction between the carbon-carbon unsaturated bond site of X⁵ and the protective layer without impairing the adhesion of two hydroxy groups contained in Formula (6-1) to the protective layer. In addition, in a case where y1 is 2 and X⁵ is a polar group, Formula (6-1) has three polar groups. Therefore, it is possible to form a lubricating layer that exhibits more excellent adhesion to the protective layer.

In the terminal group represented by Formula (6-1), y2 is an integer of 0 to 3. In the terminal group represented by Formula (6-1), even in a case where X⁵ in Formula (6-1) is a polar group, the distance between X⁵ and the secondary hydroxy group in Formula (6-1) is not too close, and thus the polar group in Formula (6-1) is less likely to aggregate. In a case where X⁵ in Formula (6-1) is a polar group, the distance between X⁵ and the secondary hydroxy group in Formula (6-1) becomes more appropriate, and thus y2 is preferably 1 or more. In the terminal group represented by Formula (6-1), since y2 is 3 or less, the mobility of X⁵ in Formula (6-1) does not become excessively high, and each polar group contained in the terminal group can sufficiently closely adhere to the protective layer. y2 is more preferably 2 or less.

In the terminal group represented by Formula (6-2), y3 is an integer of 1 to 3. In a case where y4 is 0, X⁵ is a polar group. Since y3 is an integer of 1 or more, in a case where y4 is 0, the distance between X⁵ and the secondary hydroxy group in Formula (6-2) becomes appropriate, and even in a case where X⁵ is a polar group, the polar group in Formula (6-2) is less likely to aggregate. In addition, since y3 is an integer of 1 or more, in a case where y4 is 1, the distance between the secondary hydroxy groups in Formula (6-2) does not become too close, and the secondary hydroxy groups in Formula (6-2) are less likely to aggregate. In the terminal group represented by Formula (6-2), since y3 is 3 or less, the mobility of the terminal group represented by Formula (6-2) does not become excessively high, and each polar group contained in the terminal group can sufficiently closely adhere to the protective layer. y3 is preferably 2 or less.

In the terminal group represented by Formula (6-2), y4 is 0 or 1. In a case where y4 is 0, X⁵ is a polar group, and Formula (6-2) has two polar groups. In this case, since Formula (6-2) has two polar groups, a lubricating layer having good adhesion to the protective layer can be formed. In a case where y4 is 1. X⁵ may be any of an aromatic hydrocarbon group, an unsaturated heterocyclic group, an alkenyl group, an alkynyl group, or a polar group. Even in a case where y4 is 1 and X⁵ is any one of an aromatic hydrocarbon group, an unsaturated heterocyclic group, an alkenyl group, or an alkynyl group, Formula (6-2) has two polar groups. Therefore, a lubricating layer having good adhesion to the protective layer can be formed. In addition, since X⁵ is an aromatic hydrocarbon group, an unsaturated heterocyclic group, an alkenyl group, or an alkynyl group, a lubricating layer having excellent smoothness and wear resistance can be formed by the n-n interaction between the carbon-carbon unsaturated bond site of X⁵ and the protective layer without impairing the adhesion of two hydroxy groups contained in Formula (6-2) to the protective layer. In addition, in a case where y4 is 1 and X⁵ is a polar group, Formula (6-2) has three polar groups. Therefore, it is possible to form a lubricating layer that exhibits excellent adhesion to the protective layer.

In the terminal group represented by Formula (6-2), y5 is an integer of 0 to 3. In the terminal group represented by Formula (6-2), even in a case where X⁵ in Formula (6-2) is a polar group, the distance between X⁵ and the secondary hydroxy group in Formula (6-2) is not too close, and thus the polar group in Formula (6-2) is less likely to aggregate. In a case where X⁵ in Formula (6-2) is a polar group, the distance between X⁵ and the secondary hydroxy group in Formula (6-2) becomes more appropriate, and thus y5 is preferably 1 or more. In addition, in a case where y4 is 0, the distance between X⁵, which is a polar group, and the secondary hydroxy group in Formula (6-2) becomes appropriate due to y3 methylene groups even in a case where y5 is 0. In a case where y4 is 0, the distance between X⁵, which is a polar group, and the secondary hydroxy group in Formula (6-2) becomes more appropriate due to y3+y5 methylene groups even in a case where y5 is 1. In the terminal group represented by Formula (6-2), since y5 is 3 or less, the mobility of X⁵ in Formula (6-2) does not become excessively high, and each polar group contained in the terminal group can sufficiently closely adhere to the protective layer. y5 is preferably 2 or less.

In the terminal group represented by Formula (6-3), y6 is 0 or 1. In a case where y6 is 0, X⁵ is a polar group, and Formula (6-3) has two polar groups. In this case, since Formula (6-3) has two polar groups, a lubricating layer having good adhesion to the protective layer can be formed. In a case where y6 is 1, X⁵ may be any of an aromatic hydrocarbon group, an unsaturated heterocyclic group, an alkenyl group, an alkynyl group, or a polar group. Even in a case where y6 is 1 and X⁵ is an aromatic hydrocarbon group, an unsaturated heterocyclic group, an alkenyl group, or an alkynyl group, Formula (6-3) has two polar groups. Therefore, a lubricating layer having good adhesion to the protective layer can be formed. In addition, since X⁵ is an aromatic hydrocarbon group, an unsaturated heterocyclic group, an alkenyl group, or an alkynyl group, a lubricating layer having excellent smoothness and wear resistance can be formed by the n-n interaction between the carbon-carbon unsaturated bond site of X⁵ and the protective layer without impairing the adhesion of two hydroxy groups contained in Formula (6-3) to the protective layer. In addition, in a case where y6 is 1 and X⁵ is a polar group, Formula (6-3) has three polar groups. Therefore, it is possible to form a lubricating layer that exhibits excellent adhesion to the protective layer.

In the terminal group represented by Formula (6-3), y7 is an integer of 1 to 3. Since y7 is 1 or more, in a case where y6 is 1, the distance between the secondary hydroxy groups in Formula (6-3) does not become too close. Therefore, the secondary hydroxy groups in Formula (6-3) are less likely to aggregate. In the terminal group represented by Formula (6-3), since y7 is 3 or less, the mobility of the terminal group represented by Formula (6-3) does not become excessively high, and each polar group contained in the terminal group can sufficiently closely adhere to the protective layer. y7 is preferably 2 or less.

In the terminal group represented by Formula (6-3), y8 is an integer of 1 to 3. In the terminal group represented by Formula (6-3), since y8 is 1 or more, even in a case where X⁵ in Formula (6-3) is a polar group, the distance between X⁵ and the secondary hydroxy group in Formula (6-3) does not become too close. Therefore, the polar group in Formula (6-3) is less likely to aggregate. In a case where X⁵ in Formula (6-3) is a polar group, the distance between X⁵ and the secondary hydroxy group in Formula (6-3) becomes more appropriate, and thus y8 is preferably 2 or more. In the terminal group represented by Formula (6-3), since y8 is 3 or less, the mobility of X⁵ in Formula (6-3) does not become excessively high, and each polar group contained in the terminal group can sufficiently closely adhere to the protective layer.

In the fluorine-containing ether compound represented by Formula (1), the kinds of the terminal groups represented by R¹ and R⁴ can be appropriately selected depending on the performance required for the lubricant containing the fluorine-containing ether compound and the like.

Specifically, the fluorine-containing ether compound represented by (1) is preferably any of compounds represented by Formulae (1A) to (1O) and (2A) to (2O) below. In a case where the compound represented by Formula (1) is a compound represented by any of Formulae (1A) to (1O) and (2A) to (2O) below, a raw material is easily procured, and moreover, a lubricating layer having excellent adhesion, more excellent smoothness, and more excellent wear resistance can be formed even in a case where the thickness is small.

The compounds represented by Formulae (1A) to (1O) and (2A) to (2O) are all the groups represented by Formula (2-1) or (2-2), in which R¹ and R⁴ in Formula (1) are the same as each other, and h and i in Formula (4) as R³ are 1.

In all of the compounds represented by Formulae (1A) to (1O) and (2A) to (2O), (z+1) the PFPE chains represented by R² in Formula (1) are all the same as each other. In the compounds represented by Formulae (1A) to (1O) and (2A) to (2O), Rf₁ and Rf₂ representing the PFPE chain are each the following structure. That is, in the compounds represented by Formulae (1A) to (1F), (1J), (1K), (1N), (2A) to (2F), (2J), (2K), and (2N), Rf₂ is the PFPE chain represented by Formula (7-2). In the compounds represented by Formulae (1G) to (1I), (1L), (1M), (1O), (2G) to (2I), (2L), (2M), and (2O), Rf₁ is the PFPE chain represented by Formula (7-1). p and q in Rf₁ and r in Rf₂, which represent the PFPE chain, in Formulae (1A) to (1O) and (2A) to (2O) are values indicating the average degrees of polymerization and are thus not necessarily limited to integers.

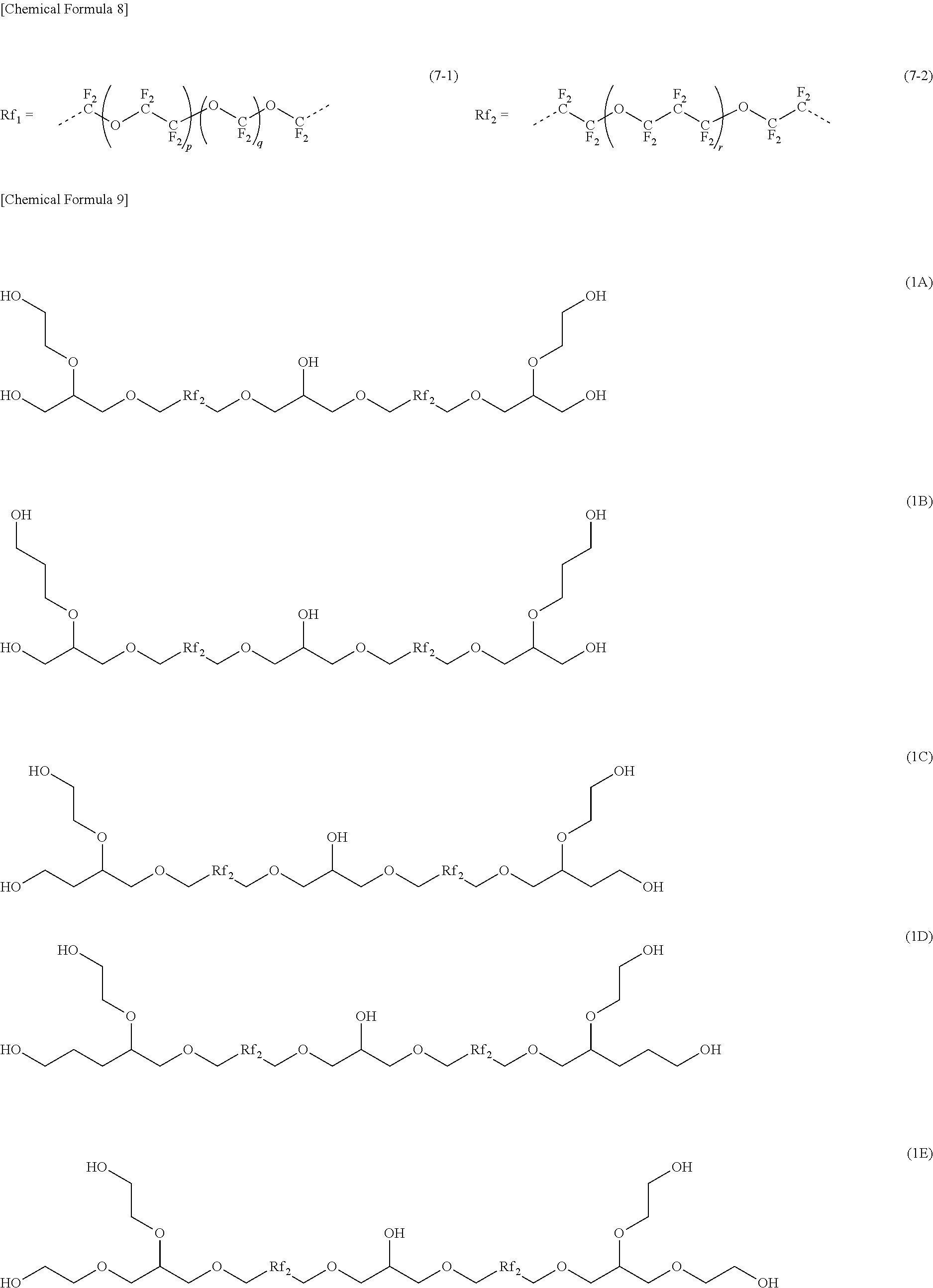

(In two Rf₂'s in Formula (1A), r represents the average degree of polymerization and represents 1 to 15. r's in two Rf₁'s may be the same as or different from each other.)

(In two Rf₂'s in Formula (1B), r represents the average degree of polymerization and represents 1 to 15. r's in two Rf₂'s may be the same as or different from each other.)

(In two Rf₂'s in Formula (1C), r represents the average degree of polymerization and represents 1 to 15. r's in two Rf₁'s may be the same as or different from each other.)

(In two Rf₂'s in Formula (D), r represents the average degree of polymerization and represents 1 to 15. r's in two Rf₂'s may be the same as or different from each other.)

(In two Rf₂'s in Formula (1E), r represents the average degree of polymerization and represents 1 to 15. r's in two Rf₂'s may be the same as or different from each other.)

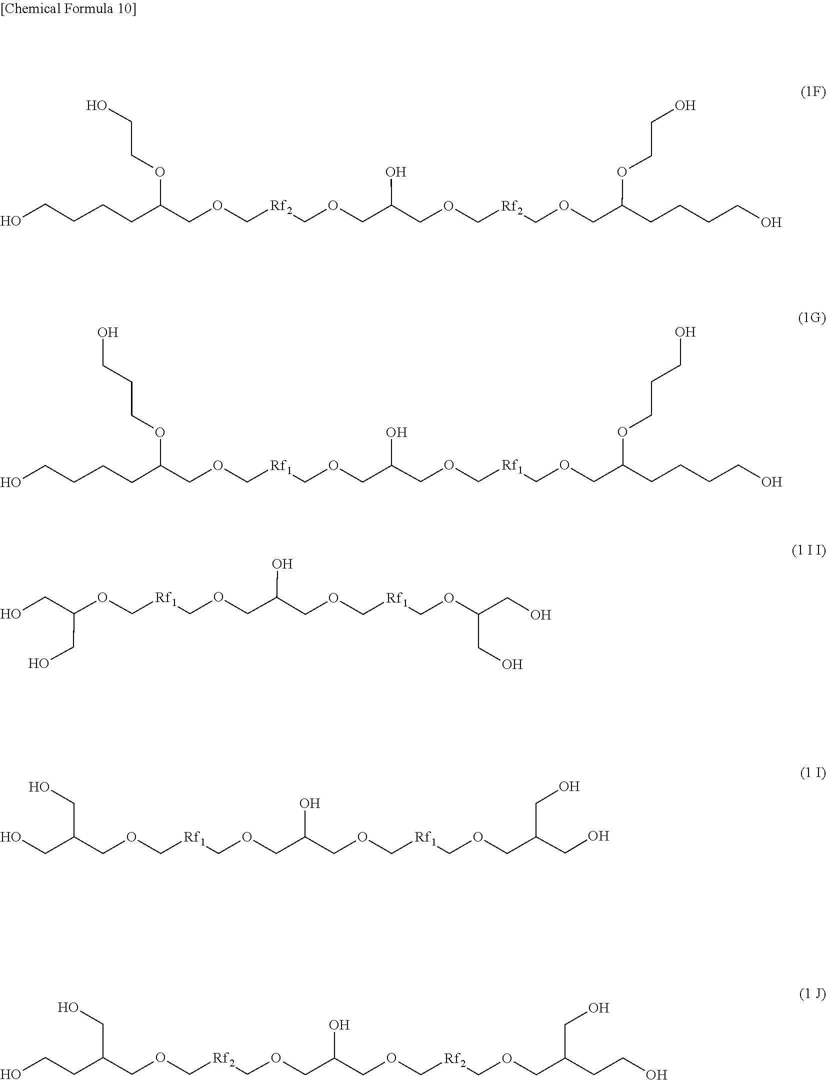

(In two Rf₂'s in Formula (F), r represents the average degree of polymerization and represents 1 to 15. r's in two Rf₂'s may be the same as or different from each other.)

(In two Rf₁'s in Formula (1G), p and q represent the average degrees of polymerization, p represents 1 to 20, and q represents 0 to 20. p and q in two Rf₁'s may be the same as or different from each other.)

(In two Rf₁'s in Formula (1H), p and q represent the average degrees of polymerization, p represents 1 to 20, and q represents 0 to 20. p and q in two Rf₁'s may be the same as or different from each other.)

(In two Rf₁'s in Formula (1I), p and q represent the average degrees of polymerization, p represents 1 to 20, and q represents 0 to 20. p and q in two Rf₁'s may be the same as or different from each other.)

(In two Rf₂'s in Formula (J), r represents the average degree of polymerization and represents 1 to 15. r's in two Rf₂'s may be the same as or different from each other.)

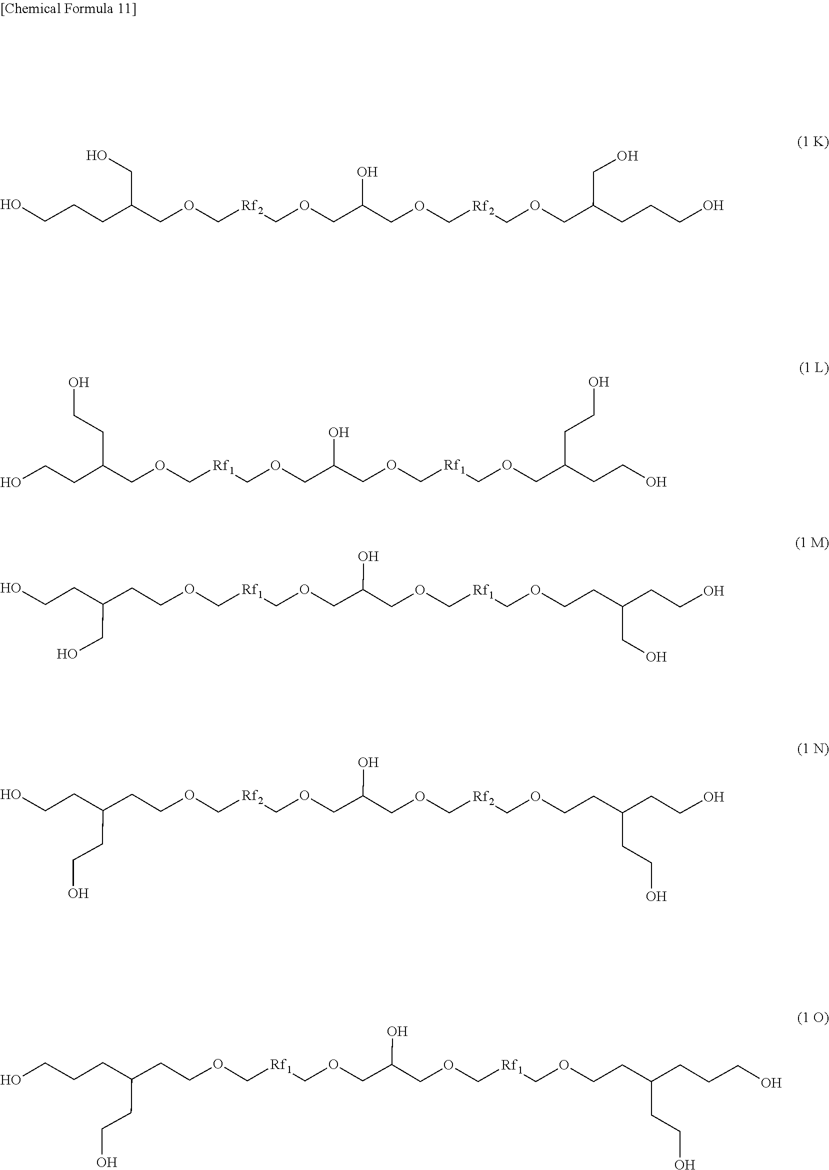

(In two Rf₁'s in Formula (1K), r represents the average degree of polymerization and represents 1 to 15. r's in two Rf₁'s may be the same as or different from each other.)

(In two Rf₁'s in Formula (1L), p and q represent the average degrees of polymerization, p represents 1 to 20, and q represents 0 to 20. p and q in two Rf₁'s may be the same as or different from each other.)

(In two Rf₁'s in Formula (1M), p and q represent the average degrees of polymerization, p represents 1 to 20, and q represents 0 to 20. p and q in two Rf₁'s may be the same as or different from each other.)

(In two Rf₂'s in Formula (1N), r represents the average degree of polymerization and represents 1 to 15. r's in two Rf₂'s may be the same as or different from each other.)

(In two Rf₁'s in Formula (1O), p and q represent the average degrees of polymerization, p represents 1 to 20, and q represents 0 to 20. p and q in two Rf₁'s may be the same as or different from each other.)

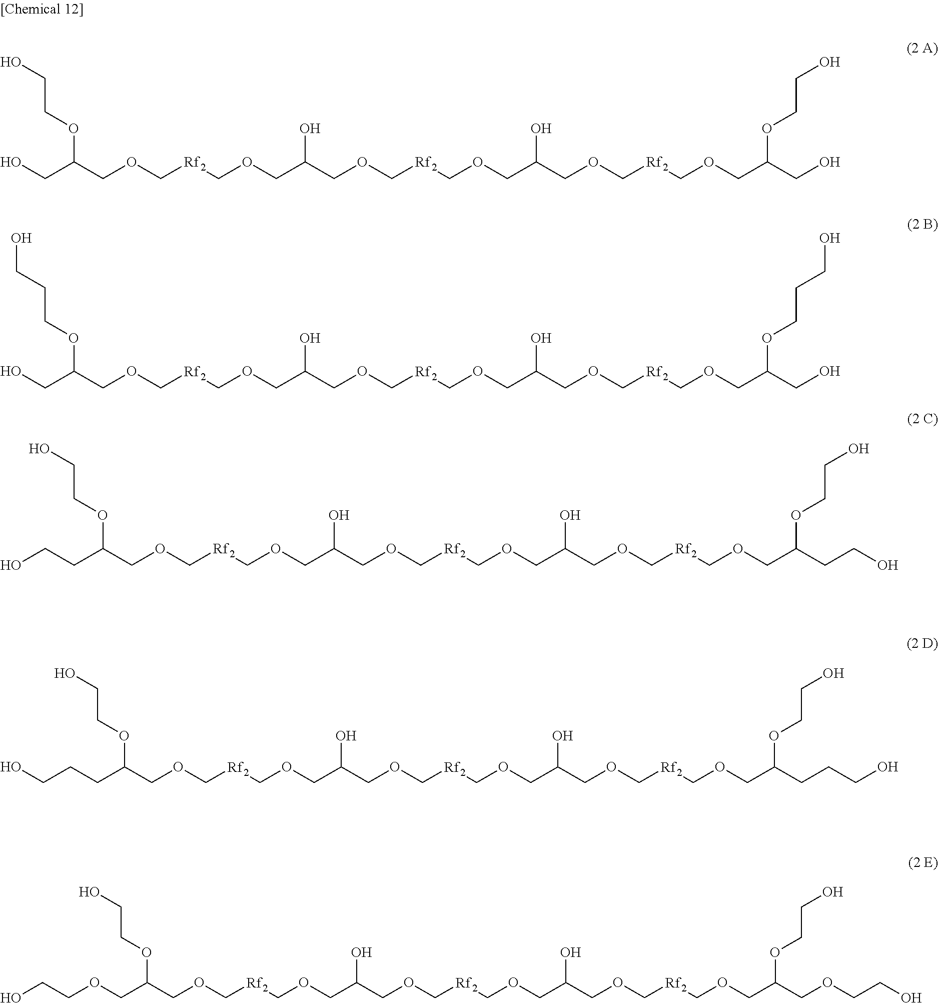

(In three Rf₂'s in Formula (2A), r represents the average degree of polymerization and represents 1 to 15. r's in three Rf₂'s may be different from each other, or may be the same in part or in whole.)

(In three Rf₂'s in Formula (2B), r represents the average degree of polymerization and represents 1 to 15. r's in three Rf₂'s may be different from each other, or may be the same in part or in whole.)

(In three Rf₂'s in Formula (2A), r represents the average degree of polymerization and represents 1 to 15. r's in three Rf₂'s may be different from each other, or may be the same in part or in whole.)

(In three Rf₂'s in Formula (2D), r represents the average degree of polymerization and represents 1 to 15. r's in three Rf₂'s may be different from each other, or may be the same in part or in whole.)

(In three Rf₂'s in Formula (2E), r represents the average degree of polymerization and represents 1 to 15. r's in three Rf₂'s may be different from each other, or may be the same in part or in whole.)

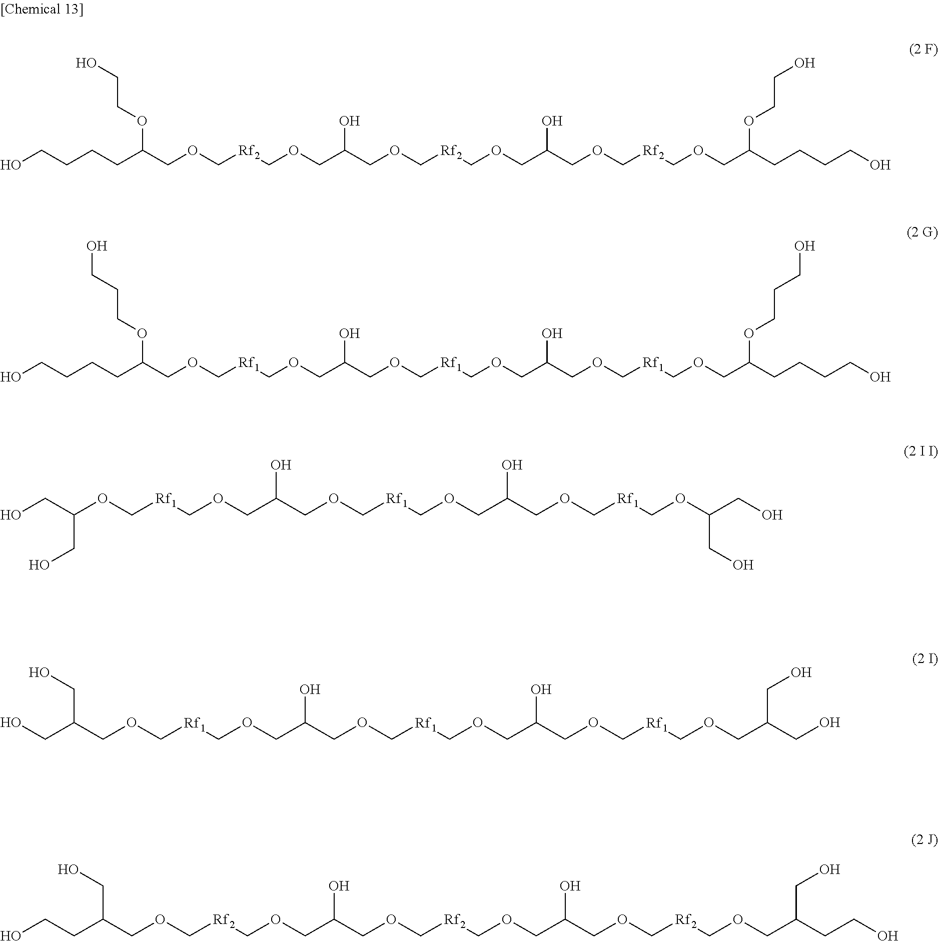

(In three Rf₁'s in Formula (2G), p and q represent the average degrees of polymerization, p represents 1 to 20, and q represents 0 to 20. p's and q's in three Rf₁'s may be different from each other, or may be the same in part or in whole.)

In three Rf₁'s in Formula (2H), p and q represent the average degrees of polymerization, p represents 1 to 20, and q represents 0 to 20. p's and q's in three Rf₁'s may be different from each other, or may be the same in part or in whole.)

In three Rf₁'s in Formula (2I), p and q represent the average degrees of polymerization, p represents 1 to 20, and q represents 0 to 20. p's and q's in three Rf₁'s may be different from each other, or may be the same in part or in whole.)

(In three Rf₂'s in Formula (2J), r represents the average degree of polymerization and represents 1 to 15. r's in three Rf₂'s may be different from each other, or may be the same in part or in whole.)

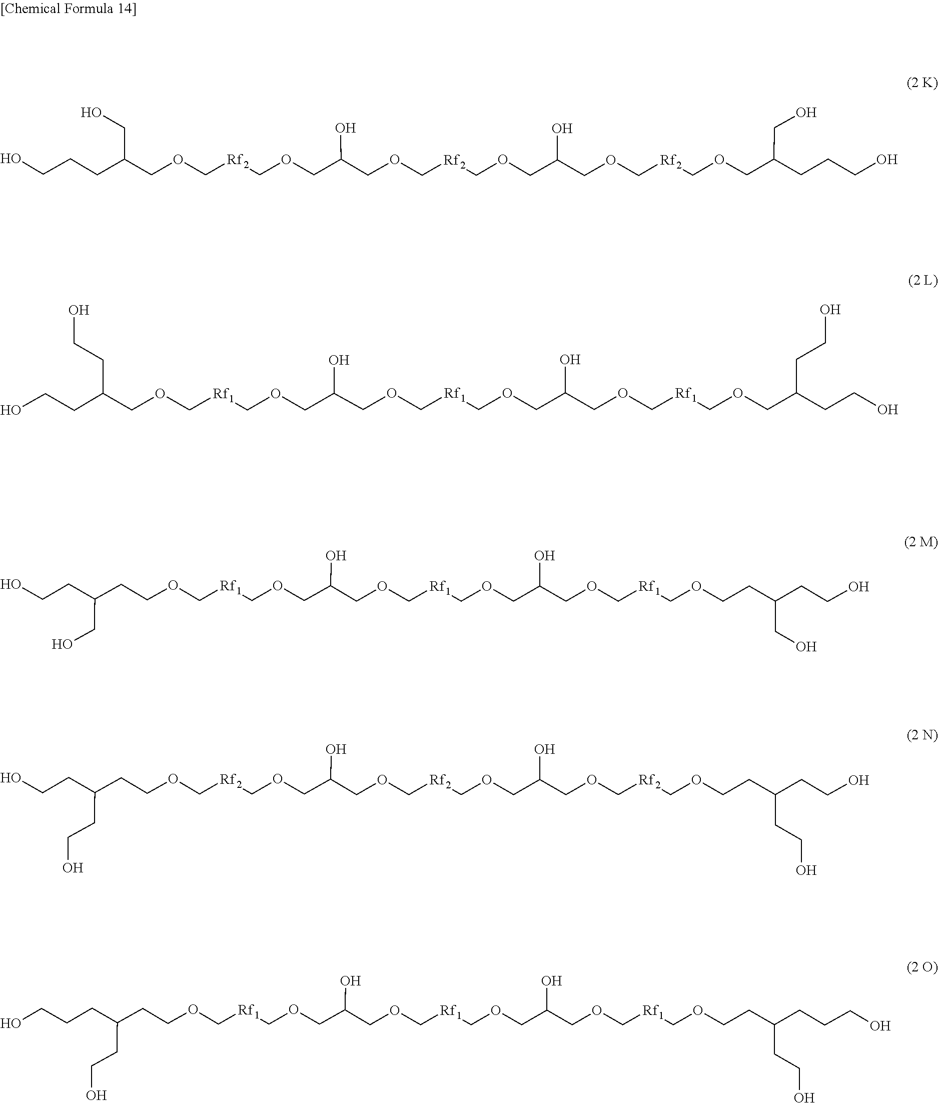

(In three Rf₁'s in Formula (2K), r represents the average degree of polymerization and represents 1 to 15. r's in three Rf₁'s may be different from each other, or may be the same in part or in whole.)

In three Rf₁'s in Formula (2L), p and q represent the average degrees of polymerization, p represents 1 to 20, and q represents 0 to 20. p's and q's in three Rf₁'s may be different from each other, or may be the same in part or in whole.)

In three Rf₁'s in Formula (2M), p and q represent the average degrees of polymerization, p represents 1 to 20, and q represents 0 to 20. p's and q's in three Rf₁'s may be different from each other, or may be the same in part or in whole.)

(In three Rf₂'s in Formula (2N), r represents the average degree of polymerization and represents 1 to 15. r's in three Rf₂'s may be different from each other, or may be the same in part or in whole.)

In three Rf₁'s in Formula (2O), p and q represent the average degrees of polymerization, p represents 1 to 20, and q represents 0 to 20. p's and q's in three Rf₁'s may be different from each other, or may be the same in part or in whole.)

The number-average molecular weight (Mn) of the fluorine-containing ether compound of the present embodiment is preferably in a range of 500 to 10000, more preferably in a range of 500 to 5000, and particularly preferably in a range of 1000 to 3000. In a case where the number-average molecular weight is 500 or more, the lubricant containing the fluorine-containing ether compound of the present embodiment is less likely to transpiration, and it is possible to prevent the transpiration and transfer to the magnetic head of the lubricant. In addition, in a case where the number-average molecular weight is 10.000 or less, the viscosity of the fluorine-containing ether compound becomes appropriate, and a lubricating layer having a thin thickness can be easily formed by applying a lubricant including the fluorine-containing ether compound. In a case where the number-average molecular weight is 5,000 or less, the viscosity becomes easy to handle in the case of being applied to the lubricant, which is more preferable.

The number-average molecular weight (Mn) of the fluorine-containing ether compound is a value measured by ¹H-NMR and ¹⁹F-NMR using AVANCE III 400 manufactured by Bruker Biospin. Specifically, the number of repeating units of the PFPE chain is calculated from the integral value measured by ¹⁹F-NMR, and the number-average molecular weight is determined. In the measurement of nuclear magnetic resonance (NMR), the sample was diluted in a single solvent such as hexafluorobenzene, d-acetone, or d-tetrahydrofuran or a solvent mixture and was used for the measurement. As the reference for the ¹⁹F-NMR chemical shift, the peak of hexafluorobenzene was set to −164.7 ppm. As the reference of the ¹H-NMR chemical shift, the peak of acetone was set to 2.2 ppm.

In the fluorine-containing ether compound of the present embodiment, it is preferable that the polydispersity (weight-average molecular weight (Mw)/number-average molecular weight (Mn) ratio) is set to 1.3 or less by cutting off the molecular weight by an appropriate method.

In the present embodiment, a method for cutting off the molecular weight is not particularly limited, and for example, molecular weight cutting-off by a silica gel column chromatography method, a gel permeation chromatography (GPC) method, or the like, molecular weight cutting-off by a supercritical extraction method, or the like can be used.

### “Production Method”

A method for producing the fluorine-containing ether compound of the present embodiment is not particularly limited, and the fluorine-containing ether compound can be produced using a known production method in the related art. The fluorine-containing ether compound of the present embodiment can be produced by, for example, the following production method.

Specifically, in the case of producing a fluorine-containing ether compound in which z in Formula (1) is 1, a production method selected from a first production method to a fourth production method shown below can be used. In the case of producing a fluorine-containing ether compound in which z in Formula (1) is 2, a production method selected from a fifth production method and a sixth production method shown below can be used.

### <First Production Method>

In the case of producing a fluorine-containing ether compound in which z in Formula (1) is 1, R¹ and R⁴ are the same as each other and are the groups represented by Formula (2-1), a is 1, X¹ is a hydrogen atom, two PFPE chains represented by R² are the same as each other, and h and i in Formula (4) as R³ are 1, a production method shown in Formula (8) can be used.

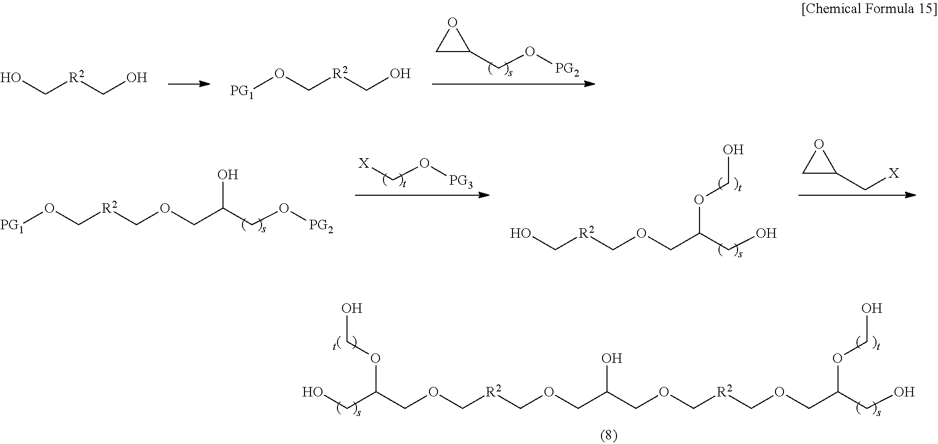

(In Formula (8), R² is the same as R² in Formula (1). PG₁, PG₂, and PG₂ each independently represent a protective group, and may be the same as or different from each other. X represents a (pseudo)halogen group. s representing the number of methylene groups is an integer corresponding to b in Formula (2-1). t representing the number of methylene groups is an integer corresponding to f of X² (=Formula (3)) in Formula (2-1).

### (First Reaction)

A fluorine-based compound having hydroxymethyl groups (—CH₂OH) at both terminals of the PFPE chain corresponding to R² in Formula (1) is prepared. A first intermediate compound is produced by bonding an appropriate protective group (PG₁) to the hydroxymethyl group at one terminal of the fluorine-based compound.

### (Second Reaction)

Next, a second intermediate compound is produced by reacting an epoxy compound having a hydroxy group protected by a protective group (PG₂) with the hydroxymethyl group (—CH₂OH) to which the protective group (PG₁) is not bonded in the first intermediate compound obtained by the first reaction.

The epoxy compound used in the second reaction has a group corresponding to —(CH₂)ₙ—CH(OX²)—(CH₂)ₙ—OX¹ in the group represented by Formula (2-1). Specifically, as shown in Formula (8), an epoxy compound corresponding to —(CH₂)ₐ—CH(OX²)—(CH₂)_{b}—OX¹ in the group represented by Formula (2-1), in which a is 1, b is s, and X¹ is a hydrogen atom, is used. Such an epoxy compound may be produced by a known method, or a commercially available product may be used.

### (Third Reaction)

Next, a (pseudo)halogenated alkyl compound (X—(CH₂)ₜ—O-PG₃) having a hydroxy group protected with a protective group (PG₃) is reacted with a secondary hydroxy group in the second intermediate compound obtained by the second reaction. Thereafter, the protective groups PG₁, PG₂, and PG₃ contained in the obtained compound are deprotected under appropriate conditions to produce a third intermediate compound having a terminal group corresponding to R¹ (═R⁴) at one terminal of the PFPE chain corresponding to R².

The (pseudo)halogenated alkyl compound (X—(CH₂)ₜ—O-PG₃) used in the third reaction has a group corresponding to —OX² (X² is the group represented by Formula (3)) in the group represented by Formula (2-1). Specifically, as shown in Formula (8), a (pseudo)halogenated alkyl compound corresponding to the group (—((CH₂)ᵣ—O)_{g}—H) represented by Formula (3) in which f is t and g is 1 is used. Such a (pseudo)halogenated alkyl compound may be produced by a known method, or a commercially available product may be used.

### (Fourth Reaction)

Finally, a (pseudo)halogenated epoxy compound having a partial structure corresponding to the linking group R³ is reacted with the hydroxymethyl group (—CH₂OH) positioned at the terminal of the PFPE chain corresponding to R², which is contained in the third intermediate compound. In the first production method, it is preferable that the reaction ratio between the third intermediate compound and the (pseudo)halogenated epoxy compound is set to about 2:1 (molar ratio).

The (pseudo)halogenated epoxy compound used in the fourth reaction has a group corresponding to the group represented by Formula (4) (—O(CH₂)ₕ—CH(OH)—(CH₂)NO—). Specifically, as shown in Formula (8), a (pseudo)halogenated epoxy compound corresponding to the group (—O(CH₂)_{b}—CH(OH)—(CH₂)—O—) represented by Formula (4) in which h and i are 1 is used. Such a (pseudo)halogenated epoxy compound may be produced by a known method, or a commercially available product may be used.

By performing the above-described steps, it is possible to produce the fluorine-containing ether compound in which z in Formula (1) is 1, R¹ and R⁴ are the same as each other and are the groups represented by Formula (2-1), a is 1, X¹ is a hydrogen atom, two PFPE chains represented by R² are the same as each other, and h and i in Formula (4) as R³ are 1.

In the above-described first production method, a case where all of the protective groups PG₁, PG₂, and PG₃ contained in the compounds are deprotected in the third reaction has been described as an example, but only the protective group PG₁ may be deprotected in the third reaction, and the protective groups PG₂ and PG₃ may be deprotected under appropriate conditions after the fourth reaction.

In addition, in the above-described first production method, a case where the epoxy compound corresponding to the group represented by Formula (2-1) in which a in is 1 and X¹ is a hydrogen atom is used as the epoxy compound used in the second reaction has been described as an example, but an epoxy compound corresponding to a group in which X¹ is the group represented by Formula (3) may be used. The epoxy compound corresponding to the group in which X¹ is the group represented by Formula (3) may be produced by a known method, or a commercially available product may be used.

In addition, in the above-described first production method, a case where the (pseudo)halogenated alkyl compound corresponding to the group (—((CH₂)ᵣ—O)_{g}—H) represented by Formula (3) in which f is t and g is 1 is used as the (pseudo)halogenated alkyl compound (X—(CH₂)—O-PG₃) used in the third reaction has been described as an example, but a (pseudo)halogenated alkyl compound corresponding to the group represented by Formula (3) in which g is 2 may be used. The (pseudo)halogenated alkyl compound corresponding to the group represented by Formula (3) in which g is 2 may be produced by a known method, or a commercially available product may be used.

### <Second Production Method>

In the case of producing a fluorine-containing ether compound in which z in Formula (1) is 1, R¹ and R⁴ are the same as each other, two PFPE chains represented by R² are the same as each other, and h and i in Formula (4) as R³ are 1, a method represented by Formula (9) may also be used.

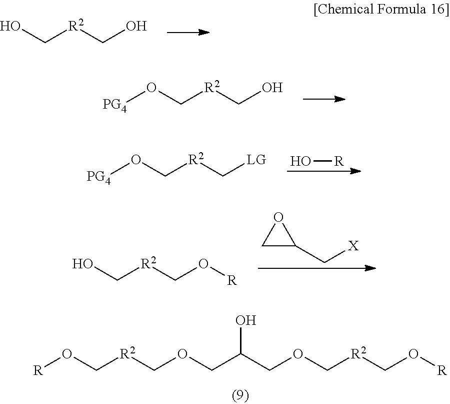

(In Formula (9), R² is the same as R² in Formula (1). PG₄ represents a protective group. LG represents a leaving group obtained by reacting a hydroxy group with an activator. R represents an organic group having a partial structure corresponding to —(CH₂)ᵣ—CH(R⁵)R⁶ of R¹ (═R⁴) in Formula (1). X represents a (pseudo)halogen group.)

### (First Reaction)

A first intermediate compound in which a protective group (PG₄) is bonded to one terminal of the PFPE chain corresponding to R² in Formula (1) is produced in the same manner as in the first reaction in the first production method described above.

### (Second Reaction)

Next, a second intermediate compound is produced by reacting a known activator with a hydroxymethyl group at one terminal of the first intermediate compound obtained by the first reaction to convert the terminal of the first intermediate compound on a side opposite to the protective group (PG₄) into a leaving group (LG).

As the above-described leaving group (LG), for example, a chloro group, a bromo group, an iodo group, a p-toluenesulfonyloxy group, a methanesulfonyloxy group, a trifluoromethanesulfonyloxy group, a perfluoroalkylsulfonyloxy group, a nitrobenzenesulfonyloxy group, and the like can be used.

### (Third Reaction)

Next, an alcohol compound (R—OH) including a partial structure corresponding to —(CH₂)ₓ—CH(R⁵)R⁶ of R¹(═R⁴) is reacted with the leaving group (LG) of the second intermediate compound obtained by the second reaction to link the terminal group sites, and then the protective group (PG₄) is deprotected by an appropriate method. In this manner, a third intermediate compound having a terminal group corresponding to —(CH₂)ᵣ—CH(R⁵)R⁶ of R¹(═R⁴) at one terminal of the PFPE chain corresponding to R² is produced. The alcohol compound used in the third reaction may be produced by a known method, or a commercially available product may be used.

### (Fourth Reaction)

Finally, a (pseudo)halogenated epoxy compound having a partial structure corresponding to the linking group R³ is reacted with the hydroxymethyl group (—CH₂OH) positioned at the terminal of the PFPE chain corresponding to R², which is contained in the third intermediate compound. In the second production method, the reaction ratio between the third intermediate compound and the (pseudo)halogenated epoxy compound is preferably about 2:1 (molar ratio).

As the (pseudo)halogenated epoxy compound used in the fourth reaction, the same compound as the one that can be used in the fourth reaction of the first production method can be used.

By performing the above-described steps, a fluorine-containing ether compound in which z in Formula (1) is 1, R¹ and R⁴ are the same as each other, two PFPE chains represented by R² are the same as each other, and h and i in Formula (4) as R³ are 1 is obtained.

Among the polar groups contained in the alcohol compound including the partial structure corresponding to —(CH₂)ₓ—CH(R⁵)R⁶ of R¹(═R⁴) used in the third reaction of the above-described second production method, a polar group that does not participate in the bonding with the second intermediate compound in the third reaction may be protected with an appropriate protective group and then used in the third reaction. In that case, the protective group of the polar group can be deprotected under appropriate conditions after the third reaction or after the fourth reaction.

### <Third Production Method>

In the case of producing a fluorine-containing ether compound in which z in Formula (1) is 1, R¹ and R⁴ are the same as each other, two PFPE chains represented by R² are the same as each other, and h and i in Formula (4) as R³ are 1, a method represented by Formula (10) may also be used.

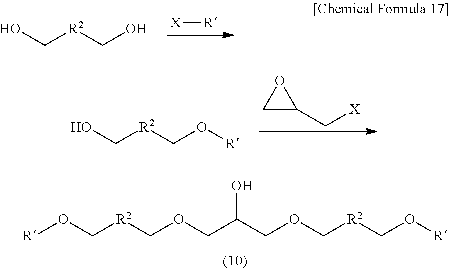

(In Formula (10), R² is the same as R² in Formula (1). X represents a (pseudo)halogen group. R represents an organic group having a partial structure corresponding to —(CH₂)ₓ—CH(R⁵)R⁶ of R¹ (═R⁴) in Formula (1)).

### (First Reaction)

A fluorine-based compound having hydroxymethyl groups (—CH₂OH) at both terminals of the PFPE chain corresponding to R² in Formula (1) is prepared. A (pseudo)halogenated alkyl compound (X—R′) including a partial structure corresponding to —(CH₂)ₓ—CH(R⁵)R⁶ of R¹(═R⁴) is reacted with the hydroxymethyl group at one terminal end of the fluorine-based compound to link the terminal group site. In this manner, a first intermediate compound having a terminal group corresponding to —(CH₂)ₓ—CH(R⁵)R⁶ of R¹(═R⁴) at one terminal of the PFPE chain corresponding to R² is produced. The (pseudo)halogenated alkyl compound including a partial structure corresponding to —(CH₂)ₓ—CH(R⁵)R⁶ of R¹(═R⁴) may be produced by a known method, or a commercially available product may be used.

### (Second Reaction)

Next, a (pseudo)halogenated epoxy compound having a partial structure corresponding to the linking group R³ is reacted with the hydroxymethyl group (—CH₂OH) positioned at the terminal of the PFPE chain corresponding to R², which is contained in the first intermediate compound. In the third production method, the reaction ratio between the first intermediate compound and the (pseudo)halogenated epoxy compound is preferably about 2:1 (molar ratio).

As the (pseudo)halogenated epoxy compound used in the second reaction, the same compound as the one that can be used in the fourth reaction of the first production method can be used.

By performing the above-described steps, a fluorine-containing ether compound in which z in Formula (1) is 1, R¹ and R⁴ are the same as each other, two PFPE chains represented by R² are the same as each other, and h and i in Formula (4) as R³ are 1 is obtained.

Among the polar groups contained in the (pseudo)halogenated alkyl compound including the partial structure corresponding to —(CH₂)ᵣ—CH(R⁵)R⁶ of R¹(═R⁴) used in the first reaction of the above-described third production method, a polar group that does not participate in the bonding with the fluorine-based compound in the first reaction may be protected with an appropriate protective group and then used in the first reaction. In that case, the protective group of the polar group can be deprotected under appropriate conditions after the first reaction or after the second reaction.

In the fourth reaction of the first production method, the fourth reaction of the second production method, and the second reaction of the third production method described above, a case where the (pseudo)halogenated epoxy compound corresponding to the group (—O(CH₂)_{b}—CH(OH)—(CH₂)ᵢO—) represented by Formula (4) in which h and i are 1 is used as the (pseudo)halogenated epoxy compound has been described as an example, but a (pseudo)halogenated epoxy compound or a (pseudo)halogenated alkyl compound corresponding to the group represented by Formula (4) in which h and/or i in is 2 or 3 may be used. The (pseudo)halogenated epoxy compound or (pseudo)halogenated alkyl compound in which h and/or i of the group represented by Formula (4) is 2 or 3 can be produced by a known method.

### <Fourth Production Method>

In the case of producing a fluorine-containing ether compound in which z in Formula (1) is 1 and any one or more of terminal groups represented by R¹ and R⁴ or two PFPE chains represented by R² are different, the following production method can be used.

### (First Reaction)

A first intermediate compound having a terminal group corresponding to R¹ at one terminal of the PFPE chain corresponding to R² on the R¹ side is produced in the same manner as in the method shown by the first production method to the third production method described above.

### (Second Reaction)

Next, a (pseudo)halogenated epoxy compound having a partial structure corresponding to the linking group R³ is reacted with the hydroxymethyl group (—CH₂OH) positioned at the terminal of the PFPE chain corresponding to R² on the R¹ side, which is contained in the first intermediate compound. In the fourth production method, the reaction ratio between the first intermediate compound and the (pseudo)halogenated epoxy compound is preferably about 1:1 (molar ratio). In this manner, a second intermediate compound having a terminal group corresponding to R¹ at one terminal of the PFPE chain corresponding to R² on the R¹ side and having an epoxy group having a partial structure corresponding to the linking group R³ at the other terminal is produced. As the (pseudo)halogenated epoxy compound, the same compound as the compound which can be used in the fourth reaction of the first production method described above can be used.

### (Third Reaction)

Next, in the same manner as in the above-described first intermediate compound, a third intermediate compound having a terminal group corresponding to R⁴ at one terminal of the PFPE chain corresponding to R² on the R⁴ side is produced. In the fourth production method, in the case of producing a fluorine-containing ether compound in which R⁴ is not the branched terminal group represented by Formula (2), a third intermediate compound having a terminal group corresponding to R⁴ can be produced, for example, by the following method. That is, a method of preparing a fluorine-based compound having hydroxymethyl groups (—CH₂OH) at both terminals of the PFPE chain corresponding to R² in Formula (1) and reacting the hydroxymethyl group at one terminal with a compound including a structure corresponding to a group represented by any of Formulae (6-1) to (6-3) by a known method can be used.

### (Fourth Reaction)

Thereafter, the second intermediate compound is reacted with the third intermediate compound, whereby a fluorine-containing ether compound in which z in Formula (1) is 1 and any one or more of the terminal groups represented by R¹ and R⁴ or two PFPE chains represented by R² are different can be produced.

In the first intermediate compound produced by the first reaction of the above-described fourth production method and the third intermediate compound produced by the third reaction, the polar group included in the terminal group R¹ and/or the terminal group R⁴ may be protected by an appropriate protective group. In that case, the protective group of the polar group can be deprotected under appropriate conditions after the second reaction or after the fourth reaction.

In the above-described fourth production method, the first reaction, the second reaction, and the third reaction are performed in this order, but the order of performing the third reaction may be before the first reaction or between the first reaction and the second reaction, and is not particularly limited.

In addition, in the above-described fourth production method, the first intermediate compound obtained in the first reaction is used in the second reaction, but the third intermediate compound obtained in the third reaction may be used instead of the first intermediate compound. In this case, in the fourth reaction, the first intermediate compound is used instead of the third intermediate compound.

### <Fifth Production Method>

In the case of producing a fluorine-containing ether compound in which z in Formula (1) is 2, three PFPE chains represented by R² are the same as one another, two linking groups R³ are the same as each other, and terminal groups represented by R¹ and R⁴ are the same as each other, or in the case of producing a fluorine-containing ether compound in which z in Formula (1) is 2, only the center R² among three PFPE chains represented by R² is different, two linking groups R³ are the same as each other, and terminal groups represented by R¹ and R⁴ are the same as each other, the following production method can be used.

### (First Reaction)

A first intermediate compound having a terminal group corresponding to R¹ (═R⁴) at one terminal of the PFPE chain corresponding to R² on the R¹ side (═R² on the R⁴ side) is produced in the same manner as in the method shown by the first production method to the fourth production method described above.

### (Second Reaction)

A fluorine-based compound in which a hydroxymethyl group (—CH₂OH) is disposed at each of both terminals of the PFPE chain corresponding to R² in the center of the molecule in Formula (1) is prepared. Next, hydroxy groups of hydroxymethyl groups disposed at both terminals of the fluorine-based compound and a (pseudo)halogenated epoxy compound having a partial structure corresponding to the linking group R³ is reacted.

In the fifth production method, the reaction ratio between the fluorine-based compound and the (pseudo)halogenated epoxy compound is preferably about 1:2 (molar ratio). In this manner, a second intermediate compound in which epoxy groups having a partial structure corresponding to the linking group R³ are bonded to both terminals of the PFPE chain corresponding to R² in the center of the molecule in Formula (1) is produced. As the (pseudo)halogenated epoxy compound, the same compound as the compound which can be used in the fourth reaction of the first production method described above can be used.

### (Third Reaction)

Finally, the first intermediate compound and the second intermediate compound are mixed and reacted with each other. In the fifth production method, the reaction ratio between the first intermediate compound and the second intermediate compound is preferably about 2:1 (molar ratio).

By performing the above-described steps, it is possible to produce a fluorine-containing ether compound in which z in Formula (1) is 2, three PFPE chains represented by R² are the same as one another, two linking groups R³ are the same as each other, and terminal groups represented by R¹ and R⁴ are the same as each other, or a fluorine-containing ether compound in which z in Formula (1) is 2, only the center R² among three PFPE chains represented by R² is different, two linking groups R³ are the same as each other, and terminal groups represented by R¹ and R⁴ are the same as each other.

In the first intermediate compound produced by the first reaction of the above-described fifth production method, the polar group included in the terminal group R¹ (═R⁴) may be protected by an appropriate protective group. In that case, the protective group of the polar group can be deprotected under appropriate conditions after the first reaction or after the third reaction.

In the above-described fifth production method, the second reaction is performed after the first reaction, but the first reaction may be performed after the second reaction.

### <Sixth Production Method>

In the case of producing a fluorine-containing ether compound in which z in Formula (1) is 2, two linking groups R³ are the same as each other, and any one or more of the terminal groups represented by R¹ and R⁴ and three PFPE chains are different, the following production method can be used.

### (First Reaction)

A first intermediate compound having epoxy groups having a partial structure corresponding to the linking group R³ at both terminals of the PFPE chain corresponding to R² in the center of the molecule in Formula (1) is produced in the same manner as in the case of producing the second intermediate compound in the second reaction of the fifth production method described above.

### (Second Reaction and Third Reaction)

A second intermediate compound having a terminal group corresponding to R¹ at one terminal of the PFPE chain corresponding to R² on the R¹ side, and a third intermediate compound having a terminal group corresponding to R⁴ at one terminal of the PFPE chain corresponding to R² on the R⁴ side are produced in the same manner as in the methods shown in the first production method to the fifth production method.

### (Fourth Reaction and Fifth Reaction)

A fourth reaction of reacting the second intermediate compound with the first intermediate compound obtained by the first reaction and a fifth reaction of reacting the third intermediate compound with the fourth intermediate compound obtained by the fourth reaction are sequentially performed.

By performing the above-described steps, it is possible to produce a fluorine-containing ether compound in which z in Formula (1) is 2, two linking groups R; are the same as each other, and any one or more of the terminal groups represented by R¹ and R⁴ and three PFPE chains are different.

In the second intermediate compound and the third intermediate compound produced by the second reaction and the third reaction of the sixth production method described above, the polar group included in the terminal group R¹ and/or R⁴ may be protected by an appropriate protective group. In that case, the protective group of the polar group can be deprotected under appropriate conditions at any stage after the second reaction to the fifth reaction.

In the above-described sixth production method, the first reaction, the second reaction, and the third reaction are performed in this order, but the order of performing the first reaction may be between the second reaction and the third reaction or after the third reaction, and is not particularly limited.

In addition, in the above-described sixth production method, the second intermediate compound is used in the fourth reaction, and the third intermediate compound is used in the fifth reaction, but the third intermediate compound may be used in the fourth reaction, and the second intermediate compound may be used in the fifth reaction.

As the (pseudo)halogen group (X) contained in the (pseudo)halogenated alkyl compound and the (pseudo)halogenated epoxy compound used in the first production method to the sixth production method described above, for example, at least one selected from a chloro group, a bromo group, an iodo group, a p-toluenesulfonyloxy group, a methanesulfonyloxy group, a trifluoromethanesulfonyloxy group, a perfluoroalkylsulfonyloxy group, or a nitrobenzenesulfonyloxy group can be used.

### [Lubricant for Magnetic Recording Medium]

A lubricant for a magnetic recording medium of the present embodiment contains a fluorine-containing ether compound represented by Formula (1).

In the lubricant of the present embodiment, known materials used as materials for lubricants can be mixed and used as necessary as long as the characteristics are not impaired by the inclusion of the fluorine-containing ether compound represented by Formula (1).

Specific examples of the known materials include FOMBLIN (registered trademark) ZDIAC, FOMBLIN ZDEAL, and FOMBLIN AM-2001 (all of which are manufactured by Solvay Solexis), and Moresco A20H (manufactured by Moresco Corporation). The known material used by being mixed with the lubricant of the present embodiment preferably has a number-average molecular weight of 500 to 10000.

In a case where the lubricant of the present embodiment includes another material of the fluorine-containing ether compound represented by Formula (1), the content of the fluorine-containing ether compound represented by Formula (1) in the lubricant of the present embodiment is preferably 50% by mass or more, and more preferably 70% by mass or more. The content of the fluorine-containing ether compound represented by Formula (1) may be 80% by mass or more or 90% by mass or more.

Since the lubricant of the present embodiment includes the fluorine-containing ether compound represented by Formula (1), the lubricant has excellent adhesion to the protective layer, and can coat the surface of the protective layer at a high coating rate even in a case where the thickness is reduced, and thus can form a lubricating layer having good coatability. Therefore, according to the lubricant of the present embodiment, a lubricating layer having excellent wear resistance and smoothness can be formed even in a case where the thickness is reduced.

### [Magnetic Recording Medium]

A magnetic recording medium of the present embodiment has at least a magnetic layer, a protective layer, and a lubricating layer sequentially provided on a substrate.

In the magnetic recording medium of the present embodiment, one or two or more underlayers can be provided between the substrate and the magnetic layer as necessary. In addition, an adhesion layer and/or a soft magnetic layer can be provided between the underlayer and the substrate.

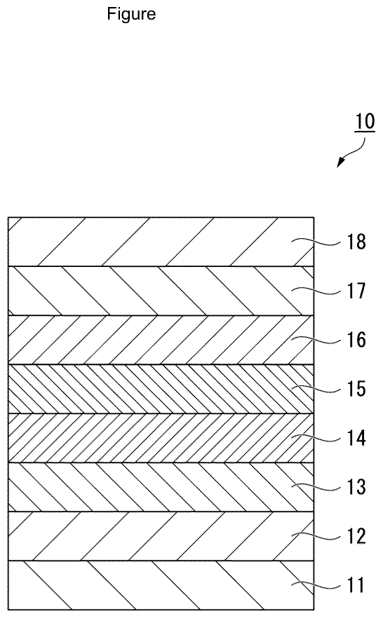

FIG. 1 is a schematic cross-sectional view showing one embodiment of a magnetic recording medium of the present invention.

A magnetic recording medium 10 of the present embodiment has a structure in which an adhesion layer 12, a soft magnetic layer 13, a first underlayer 14, a second underlayer 15, a magnetic layer 16, a protective layer 17, and a lubricating layer 18 are sequentially provided on a substrate 11.

### “Substrate”

As the substrate 11, for example, a non-magnetic substrate having a film made of NiP or a NiP alloy formed on a substrate made of a metal such as Al or an Al alloy or an alloy material can be used.

In addition, as the substrate 11, a non-magnetic substrate made of a non-metallic material such as glass, ceramics, silicon, silicon carbide, carbon, or a resin may be used, or a non-magnetic substrate having a film of NiP or a NiP alloy formed on a base made of these non-metallic materials may be used.

### “Adhesion Layer”

The adhesion layer 12 prevents the progress of the corrosion of the substrate 11, which occurs in a case where the substrate 11 and the soft magnetic layer 13 provided on the adhesion layer 12 are disposed in contact with each other.

The material of the adhesion layer 12 can be appropriately selected from, for example, Cr, a Cr alloy, Ti, a Ti alloy, CrTi, NiAl, and an AIRu alloy. The adhesion layer 12 can be formed by, for example, a sputtering method.

### “Soft Magnetic Layer”

The soft magnetic layer 13 preferably has a structure in which a first soft magnetic film, an interlayer made of a Ru film, and a second soft magnetic film are laminated in this order. That is, it is preferable that the soft magnetic layer 13 has a structure in which the soft magnetic films above and below the interlayer are anti-ferro-coupling (AFC) bonded by interposing the interlayer made of the Ru film between two soft magnetic films.

Examples of the material of the first soft magnetic film and the second soft magnetic film include a CoZrTa alloy and a CoFe alloy.

It is preferable that any one of Zr, Ta, or Nb is added to the CoFe alloy used for the first soft magnetic film and the second soft magnetic film. This makes the amorphization of the first soft magnetic film and the second soft magnetic film promoted. As a result, it becomes possible to improve the orientation of the first underlayer (seed layer) and to reduce the floating height of the magnetic head.

The soft magnetic layer 13 can be formed by, for example, a sputtering method.

### “First Underlayer”

The first underlayer 14 is a layer that controls the orientations and crystal sizes of the second underlayer 15 and the magnetic layer 16 provided thereon.

Examples of the first underlayer 14 include layers made of a Cr layer, a Ta layer, a Ru layer, a CrMo alloy layer, a CoW alloy layer, a CrW alloy layer, a CrV alloy layer, or a CrTi alloy layer.

The first underlayer 14 can be formed by, for example, a sputtering method.

### “Second Underlayer”

The second underlayer 15 is a layer that controls the orientation of the magnetic layer 16 to be good. The second underlayer 15 is preferably a layer made of Ru or a Ru alloy.

The second underlayer 15 may be a single layer or may be composed of a plurality of layers. In a case where the second underlayer 15 is made of a plurality of layers, all of the layers may be composed of the same material, or at least one layer may be composed of a different material.

The second underlayer 15 can be formed by, for example, a sputtering method.

### “Magnetic Layer”

The magnetic layer 16 is made of a magnetic film in which the magnetization easy axis is oriented in a direction perpendicular or horizontal to the substrate surface. The magnetic layer 16 is a layer containing Co and Pt. In order to improve the SNR characteristics, the magnetic layer 16 may be a layer containing an oxide, Cr, B, Cu, Ta, Zr, or the like.

Examples of the oxide contained in the magnetic layer 16 include SiO₂, SiO, Cr₂O₃, CoO, Ta₂O₃, and TiO₂.

The magnetic layer 16 may be composed of one layer, or may be composed of a plurality of magnetic layers made of materials having different compositions.

For example, in a case where the magnetic layer 16 is made up of three layers of a first magnetic layer, a second magnetic layer, and a third magnetic layer, which are laminated in this order, the first magnetic layer is preferably a granular structure made of a material containing Co, Cr, and Pt, and further containing an oxide. As the oxide contained in the first magnetic layer, for example, an oxide of Cr, Si, Ta, Al, Ti, Mg, Co, or the like is preferably used. Among these, TiO₂, Cr₂O₃, SiO₂, and the like can be suitably used. In addition, the first magnetic layer is preferably made of a composite oxide obtained by adding two or more kinds of oxides. Among these, Cr₂O₃—SiO₂, Cr₂O₃—TiO₂, SiO₂—TiO₂, and the like can be suitably used. The first magnetic layer can contain one or more elements selected from B, Ta, Mo, Cu, Nd, W, Nb, Sm, Tb, Ru, and Re, in addition to Co, Cr, Pt, and the oxide.

The same material as that of the first magnetic layer can be used for the second magnetic layer. The second magnetic layer is preferably a granular structure.

The third magnetic layer is preferably a non-granular structure made of a material containing Co, Cr, and Pt and not containing an oxide. The third magnetic layer can contain one or more elements selected from B, Ta, Mo, Cu, Nd, W, Nb, Sm, Tb, Ru, Re, and Mn, in addition to Co, Cr, and Pt.

In a case where the magnetic layer 16 is formed of a plurality of magnetic layers, it is preferable that a non-magnetic layer is provided between the adjacent magnetic layers. In a case where the magnetic layer 16 is made up of three layers of a first magnetic layer, a second magnetic layer, and a third magnetic layer, it is preferable to provide non-magnetic layers between the first magnetic layer and the second magnetic layer and between the second magnetic layer and the third magnetic layer.

As the non-magnetic layer provided between the adjacent magnetic layers in the magnetic layer 16, for example, Ru, a Ru alloy, a CoCr alloy, or a CoCrX1 alloy (X1 represents one or two or more elements selected from Pt, Ta, Zr, Re, Ru, Cu, Nb, Ni, Mn, Ge, Si, O, N, W, Mo, Ti, V, or B) can be suitably used.

It is preferable to use an alloy material containing an oxide, a metal nitride, or a metal carbide in the non-magnetic layer provided between the adjacent magnetic layers in the magnetic layer 16. Specifically, as the oxide, for example, SiO₂, Al₂O₃, Ta₂O₅, Cr₂O₃, MgO, Y₂O₃, TiO₂, or the like can be used. As the metal nitride, for example, AlN, Si₃N₄, TaN, CrN, or the like can be used. As the metal carbide, for example, TaC, BC, SiC, and the like can be used.

The non-magnetic layer can be formed by, for example, a sputtering method.

In order to realize a higher recording density, the magnetic layer 16 is preferably a magnetic layer of perpendicular magnetic recording in which the magnetization easy axis is oriented in a direction perpendicular to the substrate surface. The magnetic layer 16 may be a magnetic layer of in-plane magnetic recording.

The magnetic layer 16 may be formed by any known method in the related art, such as a vapor deposition method, an ion beam sputtering method, or a magnetron sputtering method. The magnetic layer 16 is usually formed by a sputtering method.

### “Protective Layer”

The protective layer 17 protects the magnetic layer 16. The protective layer 17 may be composed of one layer or may be composed of a plurality of layers. Examples of the material of the protective layer 17 include carbon, carbon containing nitrogen, and silicon carbide. As the protective layer 17, a carbon-based protective layer can be preferably used, and an amorphous carbon protective layer is particularly preferable. It is preferable that the protective layer 17 is a carbon-based protective layer since the interaction with the polar group contained in the fluorine-containing ether compound in the lubricating layer 18 is further enhanced.

The adhesion force between the carbon-based protective layer and the lubricating layer 18 can be controlled by producing the carbon-based protective layer with hydrogenated carbon and/or nitrided carbon and adjusting the hydrogen content and/or the nitrogen content in the carbon-based protective layer. The hydrogen content in the carbon-based protective layer is preferably 3 atomic % to 20 atomic % in the case of being measured by hydrogen forward scattering (HFS). In addition, the nitrogen content in the carbon-based protective layer is preferably 4 atomic % to 15 atomic % in the case of being measured by X-ray photoelectron spectroscopy (XPS).

The hydrogen and/or nitrogen contained in the carbon-based protective layer does not need to be uniformly contained in the entire carbon-based protective layer. The carbon-based protective layer is suitably a composition gradient layer in which nitrogen is contained on the lubricating layer 18 side of the protective layer 17 and hydrogen is contained on the magnetic layer 16 side of the protective layer 17. In this case, the adhesion force between the magnetic layer 16 and the lubricating layer 18 and the carbon-based protective layer is further improved.

The film thickness of the protective layer 17 is preferably 1 nm to 7 nm. In a case where the film thickness of the protective layer 17 is 1 nm or more, the performance as the protective layer 17 can be sufficiently obtained. In a case where the film thickness of the protective layer 17 is 7 nm or less, it is preferable from the viewpoint of thinning the protective layer 17.

As a method for forming the protective layer 17, a sputtering method using a target material containing carbon, a chemical vapor deposition (CVD) method using a hydrocarbon raw material such as ethylene or toluene, an ion beam deposition (IBD) method, or the like can be used.

In a case where a carbon-based protective layer is formed as the protective layer 17, the film can be formed by, for example, a DC magnetron sputtering method. In particular, in a case where a carbon-based protective layer is formed as the protective layer 17, it is preferable to form an amorphous carbon protective layer by a plasma CVD method. The amorphous carbon protective layer formed by the plasma CVD method has a uniform surface and a small roughness.

“Lubricating layer” The lubricating layer 18 prevents the contamination of the magnetic recording medium 10. In addition, the lubricating layer 18 reduces the frictional force of the magnetic head of a magnetic recording and reproducing device that slides on the magnetic recording medium 10, and improves the durability of the magnetic recording medium 10.

As shown in FIG. 1, the lubricating layer 18 is formed in contact with the protective layer 17. The lubricating layer 18 contains the above-described fluorine-containing ether compound.

In a case where the protective layer 17 disposed below the lubricating layer 18 is a carbon-based protective layer, particularly, the lubricating layer 18 is bonded to the protective layer 17 with a high bonding force. As a result, even in a case where the thickness of the lubricating layer 18 is small, it becomes easy to obtain the magnetic recording medium 10 in which the surface of the protective layer 17 is coated at a high coating rate, and the contamination of the surface of the magnetic recording medium 10 can be effectively prevented.

The average film thickness of the lubricating layer 18 is preferably 0.5 nm (5 Å) to 2.0 nm (20 Å) and more preferably 0.5 nm (5 Å) to 1.0 nm (10 Å). In a case where the average film thickness of the lubricating layer 18 is 0.5 nm or more, the lubricating layer 18 is formed with a uniform film thickness without being formed in an island shape or a mesh shape. Therefore, the surface of the protective layer 17 can be coated with the lubricating layer 18 at a high coating rate. In addition, when the average film thickness of the lubricating layer 18 is set to 2.0 nm or less, the lubricating layer 18 can be sufficiently thinned, and the floating height of the magnetic head can be sufficiently reduced.

In a case where the surface of the protective layer 17 is not coated with the lubricating layer 18 at a sufficiently high coating rate, an environmental substance adsorbed on the surface of the magnetic recording medium 10 passes through the gap of the lubricating layer 18 and invade the lower layer of the lubricating layer 18. The environmental substance that has intruded the lower layer of the lubricating layer 18 is adsorbed and bonded to the protective layer 17, and generates a contaminant. In addition, in the case of magnetic recording and reproducing, this contaminant (aggregation component) adheres (is transferred) to the magnetic head as smear, and damages the magnetic head or degrades the magnetic recording and reproducing characteristics of the magnetic recording and reproducing device.

Examples of the environmental substance that generates a contaminant include a siloxane compound (cyclic siloxane, linear siloxane), an ionic impurity, a hydrocarbon having a relatively high molecular weight, such as octacosane, and a plasticizer such as dioctyl phthalate. Examples of a metal ion contained in the ionic impurity include a sodium ion and a potassium ion. Examples of an inorganic ion contained in the ionic impurity include a chlorine ion, a bromine ion, a nitrate ion, a sulfate ion, and an ammonium ion. Examples of an organic ion contained in the ionic impurity include an oxalate ion and a formate ion.

### “Method of Forming Lubricating Layer”

Examples of a method for forming the lubricating layer 18 include a method of preparing a magnetic recording medium in the middle of manufacturing in which each layer up to the protective layer 17 has been formed on the substrate 11, applying a solution for forming the lubricating layer onto the protective layer 17, and drying the solution.

The solution for forming the lubricating layer is obtained by dispersing and dissolving the lubricant for a magnetic recording medium of the above-described embodiment in a solvent as necessary and adjusting the viscosity and the concentration to be suitable for the application method.

Examples of the solvent used in the solution for forming the lubricating layer include fluorine-based solvents such as Vertrel (registered trademark) XF (product name, manufactured by Mitsui DuPont Fluorochemicals Co., Ltd.) and/or ASAHIKLIN (registered trademark) AE-3000 (product name, manufactured by AGC Inc.).

The method for applying the solution for forming the lubricating layer is not particularly limited, and examples thereof include a spin coating method, a spray coating method, a paper coating method, and a dipping method.

In a case where the dipping method is used, for example, the following method can be used. First, the substrate 11 on which each layer up to the protective layer 17 has been formed is immersed in the solution for forming the lubricating layer, which has been put into an immersion tank of a dip coating device. Next, the substrate 11 is pulled up from the immersion tank at a predetermined speed. As a result, the solution for forming the lubricating layer is applied onto the surface of the protective layer 17 on the substrate 11.

The use of the dipping method makes it possible to uniformly apply the solution for forming the lubricating layer to the surface of the protective layer 17, and makes it possible to form the lubricating layer 18 on the protective layer 17 with a uniform film thickness.

In the present embodiment, it is preferable to perform a heat treatment on the substrate 11 on which the lubricating layer 18 has been formed. The heat treatment improves the adhesion between the lubricating layer 18 and the protective layer 17 and improves the adhesion force between the lubricating layer 18 and the protective layer 17.

The heat treatment temperature is preferably set to 100° C. to 180° C. In a case where the heat treatment temperature is 100° C. or higher, an effect of improving the adhesion between the lubricating layer 18 and the protective layer 17 can be sufficiently obtained. In addition, when the heat treatment temperature is set to 180° C. or lower, the thermal decomposition of the lubricating layer 18 can be prevented. The heat treatment time is preferably set to 10 to 120 minutes.

The magnetic recording medium 10 of the present embodiment has at least the magnetic layer 16, the protective layer 17, and the lubricating layer 18 sequentially provided on the substrate 11. In the magnetic recording medium 10 of the present embodiment, the lubricating layer 18 containing the above-described fluorine-containing ether compound is formed in contact with the protective layer 17. This lubricating layer 18 has excellent adhesion to the protective layer 17, can coat the surface of the protective layer 17 with a high coating rate even in a case where the thickness is small, and has excellent wear resistance and smoothness. Therefore, in the magnetic recording medium 10 of the present embodiment, the magnetic head can be caused to stably float, and long-term reliability and durability are good.

### EXAMPLES

Hereinafter, the present invention will be described in more detail with reference to Examples and Comparative Examples. The present invention is not limited to Examples described below.

### Example 1

A compound represented by Formula (1A) was obtained by the following method.

### (Step of Producing First Intermediate Compound (1A-1))

20 g of a compound represented by HOCH₂CF₂CF₂O(CF₂CF₂CF₂O)ᵣCF₂CF₂CH₂OH (r indicating the average degree of polymerization in the formula was 3.8) (number-average molecular weight: 909, molecular weight distribution: 1.1), 1.95 g of 3,4-dihydro-2H-pyran, and 44 mL of a mixed solution of ASAHIKLIN (registered trademark) AE-3000 (manufactured by AGC Inc.) as a fluorine-based solvent and dichloromethane (volume ratio: 1:1) were charged into a 300 mL eggplant flask under a nitrogen gas atmosphere, and the mixture was stirred at 0° C. until uniform, thereby obtaining a mixed solution. 0.084 g of p-toluenesulfonic acid monohydrate was added to this mixed solution, stirred at 0° C. for 30 minutes, and then stirred at room temperature for 2 hours to carry out a reaction.

The reaction product obtained after the reaction was cooled to 0° C., 50 mL of saturated aqueous sodium bicarbonate was added thereto, and the reaction was stopped. The obtained reaction solution was transferred to a separatory funnel and extracted three times with 100 mL of ethyl acetate. The organic layer was washed with saline and dewatered with anhydrous sodium sulfate. After filtering off a desiccant, the filtrate was thickened, and the residue was purified by silica gel column chromatography to obtain 10.8 g of a compound represented by Formula (11) as a first intermediate compound (1A-1).

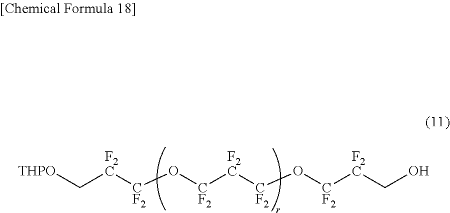

(In Formula (11), THP represents a tetrahydropyranyl group, and r indicating the average degree of polymerization represents 3.8.)

(Step of producing second intermediate compound (1A-2)) 10.0 g of a compound represented by Formula (11) (number-average molecular weight: 993, 10.1 mmol) as a first intermediate compound (1A-1), 1.9 g of a compound (A-1) represented by Formula (12) (molecular weight: 158, 12.1 mmol) as an epoxy compound, and 20 mL of t-butanol were charged into a 100 mL eggplant flask under a nitrogen gas atmosphere, and stirred at room temperature, thereby obtaining a mixed solution. 0.2 g of potassium tert-butoxide (molecular weight: 112, 2.0 mmol) was added to this mixed solution, stirred, and reacted at 70° C. for 5 hours.

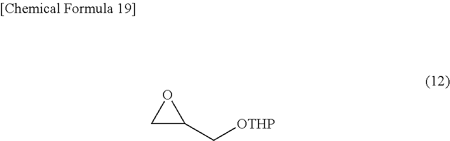

(In Formula (12), THP represents a tetrahydropyranyl group.)

A reaction product obtained after the reaction was cooled to 25° C., transferred to a separatory funnel containing 100 mL of water, and extracted three times with 100 mL of ethyl acetate. The organic layer was washed with water and dewatered with anhydrous sodium sulfate. After filtering off a desiccant, the filtrate was thickened, and the residue was purified by silica gel column chromatography to obtain 10.0 g of a compound represented by Formula (13) as a second intermediate compound (1A-2).

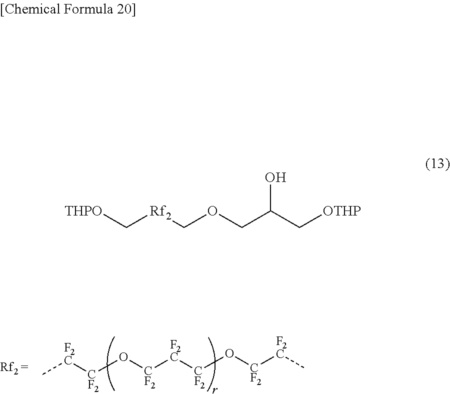

(In Formula (13), THP represents a tetrahydropyranyl group, Rf₂ is represented by the above formula, and r indicating the average degree of polymerization in Rf₂ represents 3.8.)

### (Step of Producing Third Intermediate Compound (1A-3))

10.0 g of a compound represented by Formula (13) (number-average molecular weight: 1151, 8.7 mmol), which is a second intermediate compound (1A-2), 2.7 g of a compound (A-2) represented by Formula (14) (molecular weight: 209, 13.0 mmol), which is a (pseudo)halogenated alkyl compound, and 29 mL of N,N-dimethylformamide (DMF) were charged into a 100 mL eggplant flask under a nitrogen gas atmosphere, and stirred at 0° C. until uniform. 0.70 g of sodium hydride (molecular weight: 24, 17.4 mmol) was further added to this uniform liquid, stirred, and reacted at 40° C. for 10 hours.

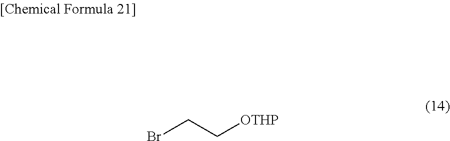

(In Formula (14), THP represents a tetrahydropyranyl group.)

The reaction solution obtained after the reaction was returned to room temperature, 23 g of a 10% hydrogen chloride/methanol solution (hydrogen chloride-methanol reagent (5% to 10%) manufactured by Tokyo Chemical Industry Co., Ltd.) was added thereto, and the mixture was stirred at room temperature for 2 hours. The reaction solution was transferred little by little to a separatory funnel containing 100 mL of saline, and the mixture was extracted three times with 200 mL of ethyl acetate. The organic layer was washed with 100 mL of saline, 100 mL of saturated aqueous sodium bicarbonate, and 100 mL of saline in this order, and dewatered with anhydrous sodium sulfate. After filtering off a desiccant, the filtrate was thickened, and the residue was purified by silica gel column chromatography. The above-described steps made 6.5 g of a compound represented by Formula (15) obtained as a third intermediate compound (1A-3).

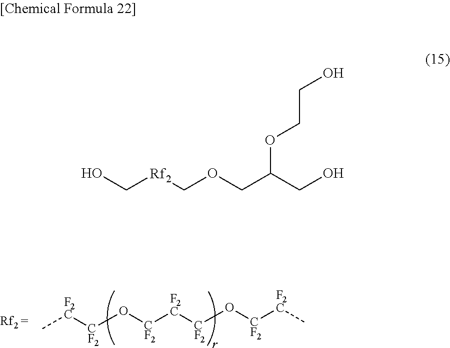

(In Formula (15), Rf₂ is represented by the above formula, and r indicating the average degree of polymerization in Rf₂ represents 3.8.)

### (Step of Producing Compound (1A))

6.5 g of a compound represented by Formula (15) (number-average molecular weight: 1155, 5.6 mmol) as a third intermediate compound (1A-3), 0.39 g of epibromohydrin (molecular weight: 137, 2.8 mmol), which is a (pseudo)halogenated epoxy compound, and 11 mL of N,N-dimethylformamide (DMF) were charged into a 100 mL eggplant flask under a nitrogen gas atmosphere, and stirred at room temperature, thereby obtaining a mixed solution. 2.7 g of cesium carbonate (molecular weight: 325, 8.4 mmol) was added to this mixed solution, stirred and reacted at 70° C. for 8 hours.

A reaction product obtained after the reaction was cooled to 25° C., transferred to a separatory funnel containing 100 mL of water, and extracted three times with 100 mL of ethyl acetate. The organic layer was washed with water and dewatered with anhydrous sodium sulfate. After filtering off a desiccant, the filtrate was thickened, and the residue was purified by silica gel column chromatography to obtain 4.5 g of a compound (1A) (r indicating the average degree of polymerization in two Rf₂'s in Formula (1A) was 3.8) (number-average molecular weight: 2110).

The obtained compound (1A) was subjected to ¹H-NMR and ¹⁹F-NMR measurements, and the structure was identified from the following results.

¹H-NMR (CD₃COCD₃): δ [ppm]3.39 to 4.35 (36H)

¹⁹F-NMR (CD₃COCD₃): δ [ppm]=−84.0 to −83.0 (30.4F), −86.4 (8F), −124.3 (8F), −130.0 to −129.0 (15.2F)

### Example 2

The same operation as in Example 1 was performed except that in the step of producing the third intermediate compound (1A-3) in Example 1, 2.9 g (molecular weight: 223, 13.0 mmol) of a compound (B-1) represented by Formula (16), which is a (pseudo)halogenated alkyl compound, was used instead of the compound (A-2) represented by Formula (14), and 4.6 g (number-average molecular weight: 2138) of a compound (1B) (in two Rf₂'s in Formula (1B), r indicating the average degree of polymerization was 3.8) was obtained.

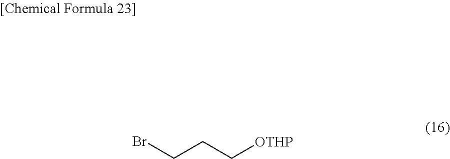

### (in Formula (16), THP Represents a Tetrahydropyranyl Group)

The obtained compound (1B) was subjected to ¹H-NMR and ¹⁹F-NMR measurements, and the structure was identified from the following results.

¹H-NMR (CD₃COCD₃): δ [ppm]1.56 to 1.80 (4H), 3.38 to 4.35 (36H)

¹⁹F-NMR (CD₃COCD₃): δ [ppm]=−84.0 to −83.1 (30.4F), −86.4 (8F), −124.2 (8F), −130.1 to −129.0 (15.2F)

### Example 3

The same operation as in Example 1 was performed except that, in the step of producing the second intermediate compound (1A-2) in Example 1, 2.1 g (molecular weight: 172, 12.1 mmol) of a compound (C-1) represented by Formula (17), which is an epoxy compound synthesized by the following method, was used instead of the compound (A-1) represented by Formula (12), and 4.6 g (number-average molecular weight: 2138) of a compound (1C) (r indicating the average degree of polymerization in two Rf₂'s in Formula (1C) was 3.8) was obtained.

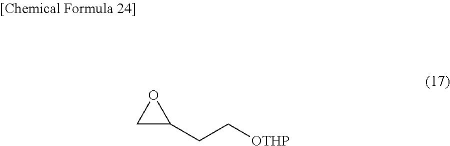

(In Formula (17), THP represents a tetrahydropyranyl group.)

A compound (C-1) represented by Formula (17) was obtained by protecting a hydroxy group of 3-butene-1-ol using 3,4-dihydro-2H-pyran and oxidizing a double bond of the obtained compound.

The obtained compound (1C) was subjected to ¹H-NMR and ¹⁹F-NMR measurements, and the structure was identified from the following results.

¹H-NMR (CD₃COCD₃): δ [ppm]1.50 to 1.86 (4H), 3.39 to 4.38 (36H)

¹⁹F-NMR (CD₃COCD₃): δ [ppm]=−84.0 to −82.9 (30.4F), −86.3 (8F), −124.1 (8F), −130.1 to −129.0 (15.2F)

### Example 4

The same operation as in Example 1 was performed except that, in the step of producing the second intermediate compound (1A-2) in Example 1, 2.1 g (molecular weight: 172, 12.1 mmol) of a compound (D-1) represented by Formula (18), which is an epoxy compound synthesized by the following method, was used instead of the compound (A-1) represented by Formula (12), and 4.4 g (number-average molecular weight: 2166) of a compound (1D) (r indicating the average degree of polymerization in two Rf₂'s in Formula (1D) was 3.8) was obtained.

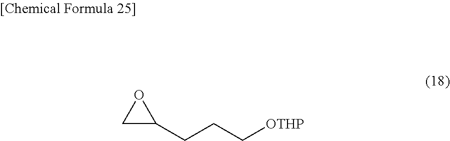

(In Formula (18), THP represents a tetrahydropyranyl group.)

A compound (D-1) represented by Formula (18) was obtained by protecting a hydroxy group of 4-pentene-1-ol using 3,4-dihydro-2H-pyran and oxidizing a double bond of the obtained compound.

The obtained compound (1D) was subjected to ¹H-NMR and ¹⁹F-NMR measurements, and the structure was identified from the following results.

¹H-NMR (CD₃COCD₃): δ [ppm]1.44 to 1.85 (8H), 3.35 to 4.45 (36H)

¹⁹F-NMR (CD₃COCD₃): δ [ppm]=−84.0 to −83.1 (30.4F), −86.4 (8F), −124.1 (8F), −130.0 to −128.8 (15.2F)

### Example 5

The same operation as in Example 1 was performed except that, in the step of producing the second intermediate compound (1A-2) in Example 1, 2.4 g (molecular weight: 202, 12.1 mmol) of a compound (E-1) represented by Formula (19), which is an epoxy compound synthesized by the following method, was used instead of the compound (A-1) represented by Formula (12), and 4.5 g (number-average molecular weight: 2198) of a compound (1E) (r indicating the average degree of polymerization in two Rf₂'s in Formula (1E) was 3.8) was obtained.

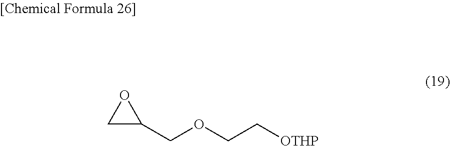

(In Formula (19), THP represents a tetrahydropyranyl group.)

A compound (E-1) represented by Formula (19) was obtained by protecting a hydroxy group of ethylene glycol monoallyl ether using 3,4-dihydro-2H-pyran and oxidizing a double bond of the obtained compound.

The obtained compound (1E) was subjected to ¹H-NMR and ¹⁹F-NMR measurements, and the structure was identified from the following results.

¹H-NMR (CD₃COCD₃): δ [ppm]3.30 to 4.52 (44H)

¹⁹F-NMR (CD₃COCD₃): δ [ppm]=−84.2 to −83.0 (30.4F), −86.5 (8F), −124.0 (8F), −130.0 to −129.0 (15.2F)

### Example 6

The same operation as in Example 1 was performed except that, in the step of producing the second intermediate compound (1A-2) in Example 1, 2.4 g (molecular weight: 200, 12.1 mmol) of a compound (F-1) represented by Formula (2O), which is an epoxy compound synthesized by the following method, was used instead of the compound (A-1) represented by Formula (12), and 4.5 g (number-average molecular weight: 2194) of a compound (1F) (r indicating the average degree of polymerization in two Rf₂'s in Formula (1F) was 3.8) was obtained.

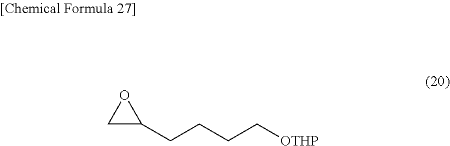

(In Formula (2O), THP represents a tetrahydropyranyl group.)

A compound (F-1) represented by Formula (2O) was obtained by protecting a hydroxy group of 5-hexen-1-ol using 3,4-dihydro-2H-pyran and oxidizing a double bond of the obtained compound.

The obtained compound (1F) was subjected to ¹H-NMR and ¹⁹F-NMR measurements, and the structure was identified from the following results.

¹H-NMR (CD₃COCD₃): δ [ppm]1.25 to 1.78 (12H), 3.40 to 4.38 (36H) ¹⁹F-NMR (CD₃COCD₃): δ [ppm]=−84.0 to −83.1 (30.4F), −86.4 (8F), −124.1 (8F), −130.1 to −129.0 (15.2F)

### Example 7

In the step of producing the first intermediate compound (1A-1) in Example 1, 20 g of a compound represented by HOCH₂CF₂O(CF₂CF₂O)ₚ(CF₂O)_{q}CF₂CH₂OH (p indicating the average degree of polymerization in the formula was 4.0, and q indicating the average degree of polymerization was 4.0) (number-average molecular weight: 906, molecular weight distribution: 1.1) was used instead of HOCH₂CF₂CF₂O(CF₂CF₂CF₂O)CF₂CF₂CH₂OH (r indicating the average degree of polymerization in the formula was 3.8) to synthesize a first intermediate compound (1G-1).

Thereafter, the same operation as in Example 1 was performed except that, in the step of producing the second intermediate compound (1A-2) in Example 1, 2.4 g of the compound (F-1) represented by Formula (2O) (molecular weight: 200, 12.1 mmol), which is an epoxy compound, was used instead of the compound (A-1) represented by Formula (12), and in the step of producing the third intermediate compound (1A-3), 2.8 g of the compound (B-1) represented by Formula (16) (molecular weight: 223, 12.6 mmol), which is a (pseudo)halogenated alkyl compound, was used instead of the compound (A-2) represented by Formula (14), and 4.3 g of a compound represented by Formula (1G) (p indicating the average degree of polymerization in two Rf₁'s in Formula (1G) was 4.0 and q indicating the average degree of polymerization was 4.0) (number-average molecular weight: 2217).

The obtained compound (1G) was subjected to ¹H-NMR and ¹⁹F-NMR measurements, and the structure was identified from the following results.

¹H-NMR (CD₃COCD₃): δ [ppm]1.37 to 1.85 (16H), 3.36 to 4.46 (26H)

¹⁹F-NMR (CD₃COCD₃): δ [ppm]=−55.6 to −50.6 (16F), −77.7 (4F), −80.3 (4F), −91.0 to −88.4 (32F)

### Example 8

### (Step of Producing First Intermediate Compound (1H-1))

A first intermediate compound (1H-1) represented by Formula (2I) was synthesized by performing the same operation as in the step of producing the first intermediate compound (1G-1) in Example 7.

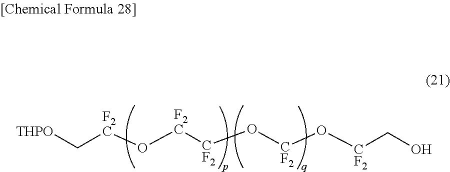

(In Formula (2I), THP represents a tetrahydropyranyl group, p indicating the average degree of polymerization is 4.0, and q indicating the average degree of polymerization is 4.0.)

### (Step of Producing Second Intermediate Compound (1H-2))

10.0 g of a first intermediate compound (I H-1) represented by Formula (2I), 3.3 g of pyridine (molecular weight: 79, 15.2 mmol), and 10 mL of dichloromethane were charged into a 100 mL eggplant flask under a nitrogen gas atmosphere, and stirred at 0° C. until uniform, thereby obtaining a mixed solution. 3.4 g of nonafluorobutanesulfonyl fluoride (molecular weight: 302, 11.1 mmol was added to this mixed solution, stirred at 0° C. for 30 minutes, then, stirred and reacted at room temperature for 2 hours.

A reaction product obtained after the reaction was cooled to 25° C. and neutralized with a 5% citric acid aqueous solution. The reaction product was transferred to a separatory funnel and extracted three times with 100 mL of dichloromethane. The organic layer was washed with water and dewatered with anhydrous sodium sulfate. After filtering off a desiccant, the filtrate was thickened, and the residue was purified by silica gel column chromatography to obtain 12.0 g of a compound represented by Formula (22) as a second intermediate compound (1H-2).

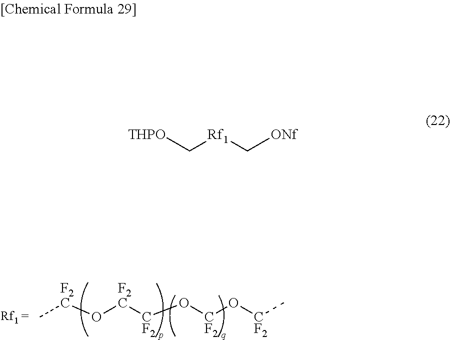

(In Formula (22), THP represents a tetrahydropyranyl group, and Nf represents a nonafluorobutanesulfonyl group. Rf₁ is represented by the above formula, p indicating the average degree of polymerization in Rf₁ represents 4.0, and q indicating the average degree of polymerization represents 4.0.)

### (Step of Producing Third Intermediate Compound (1H-3))

12.0 g of a compound represented by Formula (22) (number-average molecular weight: 1272, 9.4 mmol), which is a second intermediate compound (1H-2), 1.9 g of a compound (H-1) represented by Formula (23) (molecular weight: 132, 14.2 mmol), which is an alcohol alkyl compound, and 19 mL of N,N-dimethylformamide (DMF) were charged into a 100 mL eggplant flask under a nitrogen gas atmosphere, and stirred at 0° C. until uniform. 0.76 g of sodium hydride (molecular weight: 24, 8.9 mmol) was further added to this uniform liquid, stirred and reacted at 40° C. for 10 hours.

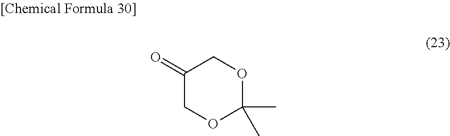

The reaction solution obtained after the reaction was returned to room temperature, 25 g of a 10% hydrogen chloride/methanol solution (hydrogen chloride-methanol reagent (5% to 10%) manufactured by Tokyo Chemical Industry Co., Ltd.) was added thereto, and the mixture was stirred at room temperature for 2 hours. The reaction solution was transferred little by little to a separatory funnel containing 100 mL of saline, and the mixture was extracted three times with 200 mL of ethyl acetate. The organic layer was washed with 100 mL of saline, 100 ml of saturated aqueous sodium bicarbonate, and 100 mL of saline in this order, and dewatered with anhydrous sodium sulfate. After filtering off a desiccant, the filtrate was thickened, and the residue was purified by silica gel column chromatography. The above-described steps made 6.5 g of a compound represented by Formula (24) obtained as a third intermediate compound (1H-3).

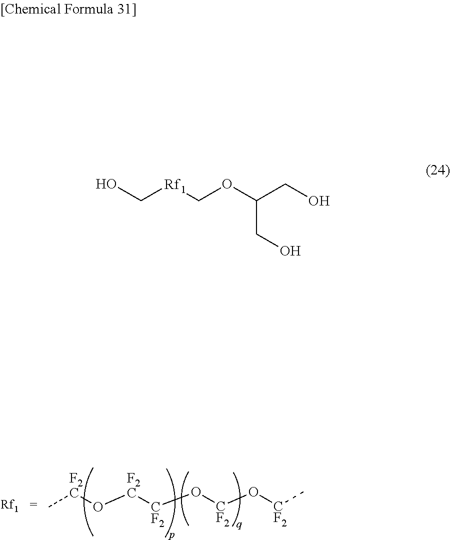

(In Formula (24), Rf₁ is represented by the above formula, p indicating the average degree of polymerization in Rf₁ represents 4.0, and q indicating the average degree of polymerization represents 4.0.)

### (Step of Producing Compound (1H))

6.5 g of a compound represented by Formula (24) (number-average molecular weight: 1110, 5.9 mmol) as a third intermediate compound (1H-3), 0.4 g of epibromohydrin (molecular weight: 137, 2.9 mmol) as a (pseudo)halogenated epoxy compound, and 12 mL of N,N-dimethylformamide (DMF) were charged into a 100 mL eggplant flask under a nitrogen gas atmosphere, and stirred at room temperature, thereby obtaining a mixed solution. 2.9 g of cesium carbonate (molecular weight: 325, 8.8 mmol) was added to this mixed solution, stirred and reacted at 70° C. for 8 hours.

A reaction product obtained after the reaction was cooled to 25° C., transferred to a separatory funnel containing 100 mL of water, and extracted three times with 100 mL of ethyl acetate. The organic layer was washed with water and dewatered with anhydrous sodium sulfate. After filtering off a desiccant, the filtrate was thickened, and the residue was purified by silica gel column chromatography to obtain 4.5 g of a compound (1H) (p indicating the average degree of polymerization in two Rf₁'s in Formula (1H) was 4.0, and q indicating the average degree of polymerization was 4.0) (number-average molecular weight: 2016).

The obtained compound (1H) was subjected to ¹H-NMR and ¹⁹F-NMR measurements, and the structure was identified from the following results.

¹H-NMR (CD₃COCD₃): δ [ppm]3.36 to 4.68 (28H)

¹⁹F-NMR (CD₃COCD₃): δ [ppm]=−55.5 to −50.6 (16F), −77.8 (4F), −80.2 (4F), −91.0 to −88.4 (32F)

### Example 9

The same operation as in Example 8 was performed except that, in the step of producing the first intermediate compound (1H-1) in Example 8, 20 g of a compound represented by HOCH₂CF₂O(CF₂CF₂O)ₚ(CF₂O)_{q}CF₂CH₂OH (p indicating the average degree of polymerization in the formula was 6.3, and q indicating the average degree of polymerization was 0) (number-average molecular weight: 909, molecular weight distribution: 1.1) was used instead of HOCH₂CF₂O(CF₂CF₂O)ₚ(CF₂O)_{q}CF₂CH₂OH (p indicating the average degree of polymerization in the formula was 4.0, and q indicating the average degree of polymerization was 4.0), and in the step of producing the third intermediate compound (1H-3), 2.1 g of a compound (I-1) represented by Formula (25) (molecular weight: 146, 14.1 mmol), which is an alcohol compound, was used instead of the compound (H-1) represented by Formula (23) to synthesize a third intermediate compound (1I-3), and 4.6 g of a compound (1I) (p indicating the average degree of polymerization in two Rf₁'s in Formula (1I) was 6.3, and q indicating the average degree of polymerization was 0) (number-average molecular weight: 2050) was obtained.

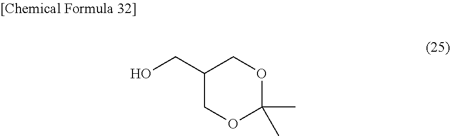

The obtained compound (1I) was subjected to ¹H-NMR and ¹⁹F-NMR measurements, and the structure was identified from the following results.

¹H-NMR (CD₃COCD₃): δ [ppm]1.50 to 1.89 (2H), 3.46 to 4.59 (30H)

¹⁹F-NMR (CD₃COCD₃): δ [ppm]=−78.6 (4F), −81.2 (4F), −90.1 to −88.4 (50.4F)

### Example 10

The same operation as in Example 8 was performed except that, in the step of producing the first intermediate compound (1H-1) in Example 8, 20 g of a compound represented by HOCH₂CF₂CF₂O(CF₂CF₂CF₂O)CF₂CF₂CH₂OH (r indicating the average degree of polymerization in the formula was 3.8) (number-average molecular weight: 909, molecular weight distribution: 1.1) was used instead of HOCH₂CF₂O(CF₂CF₂O)ₚ(CF₂O)_{q}CF₂CH₂OH (p indicating the average degree of polymerization in the formula was 4.0, and q indicating the average degree of polymerization was 4.0), and in the step of producing the third intermediate compound (1H-3), 4.1 g of a compound (J-1) represented by Formula (26) (molecular weight: 288, 14.1 mmol), which is an alcohol compound, was used instead of the compound (H-1) represented by Formula (23) to synthesize a third intermediate compound (1J-3), and 4.8 g of a compound (1J) (r indicating the average degree of polymerization in two Rf₂'s in Formula (1J) was 3.8) (number-average molecular weight: 2078) was obtained.

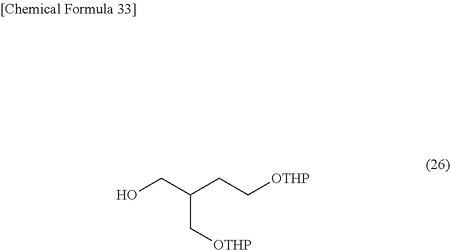

### (in Formula (26), THP Represents a Tetrahydropyranyl Group)

A compound (J-1) represented by Formula (26) was produced by the following method. A hydroxy group of ethyl 3-hydroxypropanoate was protected using 3,4-dihydro-2H-pyran, and (2-bromoethoxy)tetrahydro-2H-pyran represented by Formula (14) was reacted with the α-position of the ester group of the obtained compound to construct a trisubstituted carbon atom. Thereafter, the ester group of the compound having the trisubstituted carbon atom was reduced. As a result, a compound (J-1) represented by Formula (26) was obtained.

The obtained compound (1J) was subjected to ¹H-NMR and ¹⁹F-NMR measurements, and the structure was identified from the following results.

¹H-NMR (CD₃COCD₃): δ [ppm]1.48 to 1.84 (6H), 3.51 to 4.50 (30H)

¹⁹F-NMR (CD₃COCD₃): δ [ppm]=−84.0 to −83.0 (30.4F), −86.3 (8F), −124.0 (8F), −130.0 to −128.8 (15.2F)

### Example 11

The same operation as in Example 10 was performed except that, in the step of producing the third intermediate compound (1J-3) in Example 10, 4.3 g of a compound (K-1) represented by Formula (27) (molecular weight: 302, 14.2 mmol), which is an alcohol compound synthesized by the following method, was used instead of the compound (J-1) represented by Formula (26), and 4.9 g of a compound (1K) (r indicating the average degree of polymerization in two Rf₂'s in Formula (1K) was 3.8) (number-average molecular weight: 2106) was obtained.

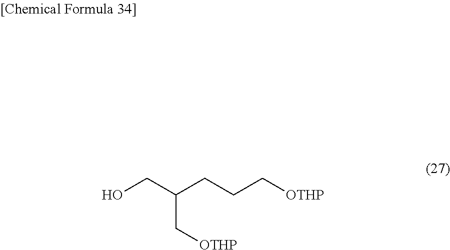

(In Formula (27), THP represents a tetrahydropyranyl group.)

A compound (K-1) represented by Formula (27) was produced by the following method. A hydroxy group of ethyl 3-hydroxypropanoate was protected using 3,4-dihydro-2H-pyran, and (3-bromopropoxy)tetrahydro-2H-pyran represented by Formula (16) was reacted with the α-position of the ester group of the obtained compound to construct a trisubstituted carbon atom. Thereafter, the ester group of the compound having the trisubstituted carbon atom was reduced. As a result, a compound (K-1) represented by Formula (27) was obtained.

The obtained compound (1K) was subjected to ¹H-NMR and ¹⁹F-NMR measurements, and the structure was identified from the following results.

¹H-NMR (CD₃COCD₃): δ [ppm]1.36 to 1.80 (10H), 3.43 to 4.50 (30H)

¹⁹F-NMR (CD₃COCD₃): δ [ppm]=−84.3 to −83.0 (30.4F), −86.4 (8F), −124.2 (8F), −130.1 to −128.8 (15.2F)

### Example 12

The same operation as in Example 9 was performed except that, in the step of producing the third intermediate compound (1I-3) in Example 9, 4.3 g of a compound (L-1) represented by Formula (28) below (molecular weight: 302, 14.2 mmol), which is an alcohol compound synthesized by the following method, was used instead of the compound (I-1) represented by Formula (25), and 4.8 g of a compound (1L) (p indicating the average degree of polymerization in two Rf₁'s in Formula (1L) was 6.3, and q indicating the average degree of polymerization was 0) (number-average molecular weight: 2106) was obtained.

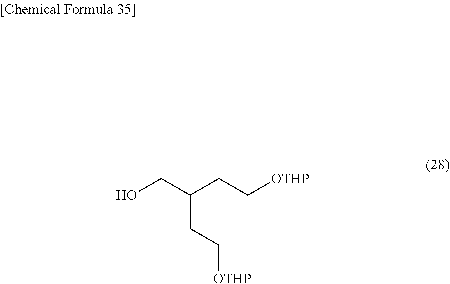

(In Formula (28), THP represents a tetrahydropyranyl group.)

A compound (L-1) represented by Formula (28) was produced by the following method. A hydroxy group of ethyl 4-hydroxybutanoate was protected using 3,4-dihydro-2H-pyran, and (2-bromoethoxy)tetrahydro-2H-pyran represented by Formula (14) was reacted with the α-position of the ester group of the obtained compound to construct a trisubstituted carbon atom. Thereafter, the ester group of the compound having the trisubstituted carbon atom was reduced. As a result, a compound (L-1) represented by Formula (28) was obtained.

The obtained compound (1L) was subjected to ¹H-NMR and ¹⁹F-NMR measurements, and the structure was identified from the following results.

¹H-NMR (CD₃COCD₃): δ [ppm]1.34 to 1.80 (10H), 3.40 to 4.52 (30H)

¹⁹F-NMR (CD₃COCD₃): δ [ppm]=−78.6 (4F), −81.0 (4F), −90.1 to −88.4 (50.4F)

### Example 13

The same operation as in Example 8 was performed except that, in the step of producing the third intermediate compound (1H-3) in Example 8, 4.3 g of a compound (M-1) represented by Formula (29) below (molecular weight: 302, 14.2 mmol), which is an alcohol compound synthesized by the following method, was used instead of the compound (H-1) represented by Formula (23), and 4.9 g of a compound (1M) (p indicating the average degree of polymerization in two Rf₁'s in Formula (1M) was 4.0, and q indicating the average degree of polymerization was 4.0) (number-average molecular weight: 2101) was obtained.

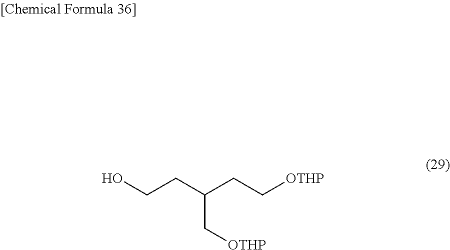

(In Formula (29), THP represents a tetrahydropyranyl group.)

A compound (M-1) represented by Formula (29) was synthesized by the following method. First, (2-bromoethoxy)tetrahydro-2H-pyran represented by Formula (14) was reacted with the α-position of the ester group of ethyl 3-butenoate to construct a trisubstituted carbon atom. Thereafter, the ester group of the compound having a trisubstituted carbon atom was reduced, the resulting primary hydroxy group was protected using 3,4-dihydro-2H-pyran, and finally, the carbon-carbon double bond site was hydroborated to obtain a compound (M-1) represented by Formula (29).

The obtained compound (1M) was subjected to ¹H-NMR and ¹⁹F-NMR measurements, and the structure was identified from the following results.

¹H-NMR (CD₃COCD₃): δ [ppm]1.37 to 1.83 (14H), 3.43 to 4.50 (26H)

¹⁹F-NMR (CD₃COCD₃): δ [ppm]=−55.3 to −50.6 (16F), −77.7 (4F), −80.2 (4F), −91.0 to −88.3 (32F)

### Example 14

The same operation as in Example 10 was performed except that, in the step of producing the third intermediate compound (1J-3) in Example 10, 4.5 g of a compound (N-1) represented by Formula (30) (molecular weight: 316, 14.2 mmol), which is an alcohol compound synthesized by the following method, was used instead of the compound (J-1) represented by Formula (26), and 5.0 g of a compound (1N) (r indicating the average degree of polymerization in two Rf₂'s in Formula (1N) was 3.8) (number-average molecular weight: 2134) was obtained.

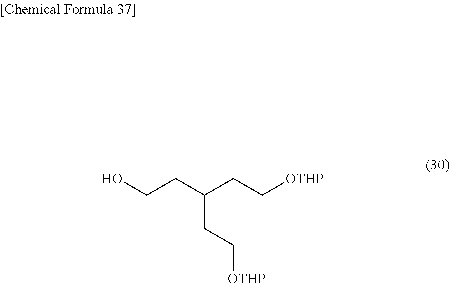

(In Formula (30), THP represents a tetrahydropyranyl group.)

A compound (N-1) represented by Formula (30) was synthesized by the following method. First, a hydroxy group of 1,5-dihydroxy-3-pentanone was protected using 3,4-dihydro-2H-pyran, and a ketone group was converted into an unsaturated ester using triethyl phosphonoacetate. Thereafter, the carbon-carbon unsaturated bond and the ester group of the obtained compound were reduced to obtain a compound (N-1) represented by Formula (30).

The obtained compound (1N) was subjected to ¹H-NMR and ¹⁹F-NMR measurements, and the structure was identified from the following results.

¹H-NMR (CD₃COCD₃): δ [ppm]1.32 to 1.76 (14H), 3.45 to 4.53 (30H)

¹⁹F-NMR (CD₃COCD₃): δ [ppm]=−84.4 to −83.1 (30.4F), −86.4 (8F), −124.2 (8F), −130.0 to −128.8 (15.2F)

### Example 15

The same operation as in Example 9 was performed except that, in the step of producing the third intermediate compound (1I-3) in Example 9, 4.7 g of a compound (0-1) represented by Formula (31) below (molecular weight: 330, 14.2 mmol), which is an alcohol compound synthesized by the following method, was used instead of the compound (I-1) represented by Formula (25), and 5.0 g of a compound (1O) (p indicating the average degree of polymerization in two Rf₁'s in Formula (1O) was 6.3, and q indicating the average degree of polymerization was 0) (number-average molecular weight: 2162) was obtained.

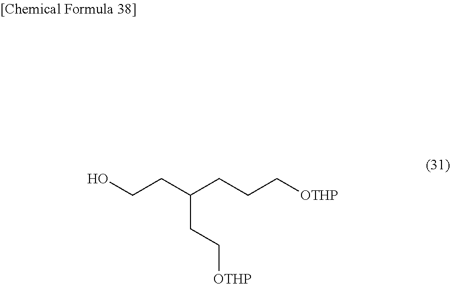

(In Formula (31), THP represents a tetrahydropyranyl group.)

A compound (0-1) represented by Formula (31) was synthesized by the following method. First, a hydroxy group of 1,6-dihydroxy-3-hexanone was protected using 3,4-dihydro-2H-pyran, and a ketone group was converted into an unsaturated ester using triethyl phosphonoacetate. Thereafter, the carbon-carbon unsaturated bond and the ester group of the obtained compound were reduced to obtain a compound (0-1) represented by Formula (31).

The obtained compound (1O) was subjected to ¹H-NMR and ¹⁹F-NMR measurements, and the structure was identified from the following results.

¹H-NMR (CD₃COCD₃): δ [ppm]1.33 to 1.87 (18H), 3.40 to 4.62 (30H)

¹⁹F-NMR (CD₃COCD₃): δ [ppm]=−78.5 (4F), −81.2 (4F), −90.2 to −88.3 (50.4F)

### Example 16

### (Step of Producing First Intermediate Compound (2A-1))

The same operation as in the step of producing the third intermediate compound (1A-3) in Example 1 was performed except that, in the step of producing the intermediate compound (1A-1) in Example 1, 20 g of a compound represented by HOCH₂CF₂CF₂O(CF₂CF₂CF₂O)ᵣCF₂CF₂CH₂OH (r indicating the average degree of polymerization in the formula was 2.0) (number-average molecular weight: 610, molecular weight distribution: 1.1) was used instead of HOCH₂CF₂CF₂O(CF₂CF₂CF₂O)ᵣCF₂CF₂CH₂OH (r indicating the average degree of polymerization in the formula was 3.8), and 6.0 g of a first intermediate compound (2A-1) represented by Formula (32) was obtained.

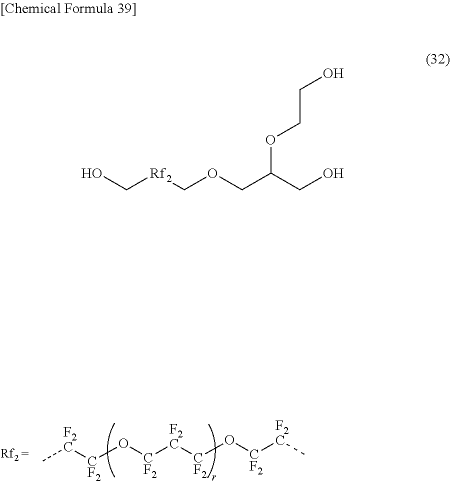

(In Formula (32), Rf₂ is represented by the above formula, and r indicating the average degree of polymerization in Rf₂ represents 2.0.)

### (Step of Producing Second Intermediate Compound (2A-2))

10 g of a compound represented by HOCH₂CF₂CF₂O(CF₂CF₂CF₂O)CF₂CF₂CH₂OH (r indicating the average degree of polymerization in the formula was 2.0) (number-average molecular weight: 610, molecular weight distribution: 1.1), 4.9 g of epibromohydrin (molecular weight: 136, 36.1 mmol) as a (pseudo)halogenated epoxy compound, and 33 mL of t-butanol were charged into a 100 mL eggplant flask under a nitrogen gas atmosphere, and stirred at room temperature, thereby producing a mixed solution. 4.6 g of potassium tert-butoxide (molecular weight: 112, 41.0 mmol) was added to this mixed solution, stirred, and reacted at 70° C. for 5 hours.

A reaction product obtained after the reaction was cooled to 25° C., transferred to a separatory funnel containing 100 mL of water, and extracted three times with 100 mL of ethyl acetate. The organic layer was washed with water and dewatered with anhydrous sodium sulfate. After filtering off a desiccant, the filtrate was thickened, and the residue was purified by silica gel column chromatography to obtain 8.0 g of a compound represented by Formula (33) as a second intermediate compound (2A-2).

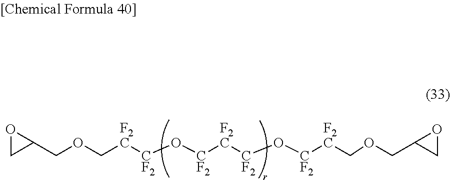

(In Formula (33), r indicating the average degree of polymerization represents 2.0.)

### (Step of Producing Compound (2A))

6.0 g of the first intermediate compound (2A-1) represented by Formula (32) (number-average molecular weight: 856, 7.0 mmol), 2.5 g of the second intermediate compound (2A-2) represented by Formula (33) (number-average molecular weight: 722, 3.5 mmol), and 14 mL of t-butanol were charged into a 100 mL eggplant flask under a nitrogen gas atmosphere, and stirred at room temperature, thereby producing a mixed solution. 3.4 g of potassium tert-butoxide (molecular weight: 112, 10.5 mmol) was added to this mixed solution, stirred, and reacted at 70° C. for 10 hours.

A reaction product obtained after the reaction was cooled to 25° C., transferred to a separatory funnel containing 100 mL of water, and extracted three times with 100 mL of ethyl acetate. The organic layer was washed with water and dewatered with anhydrous sodium sulfate. After filtering off a desiccant, the filtrate was thickened, and the residue was purified by silica gel column chromatography to obtain 4.5 g of a compound (2A) (r indicating the average degree of polymerization in three Rf₂'s in Formula (2A) was 2.0) (number-average molecular weight: 2123).

The obtained compound (2A) was subjected to ¹H-NMR and ¹⁹F-NMR measurements, and the structure was identified from the following results.

¹H-NMR (CD₃COCD₃): δ [ppm]=3.35 to 4.41 (46H)

¹⁹F-NMR (CD₃COCD₃): δ [ppm]=−84.0 to −83.0 (30.4F), −86.4 (8F), −124.3 (8F), −130.0 to −129.0 (15.2F)

### Example 17

The same operation as in Example 16 was performed except that, in the step of producing the first intermediate compound (2A-1) in Example 16, 3.9 g of the compound (B-1) represented by Formula (16) (molecular weight: 223, 13.0 mmol) was used instead of the compound (A-2) represented by Formula (14), and 6.1 g of a compound (2B) (r indicating the average degree of polymerization in three Rf₂'s in Formula (2B) was 2.0) (number-average molecular weight: 2151) was obtained.

The obtained compound (2B) was subjected to ¹H-NMR and ¹⁹F-NMR measurements, and the structure was identified from the following results.

¹H-NMR (CD₃COCD₃): δ [ppm]1.53-1.83 (4H), 3.40 to 4.36 (46H)

¹⁹F-NMR (CD₃COCD₃): δ [ppm]=−84.0 to −83.1 (30.4F), −86.3 (8F), −124.3 (8F), −130.1 to −129.0 (15.2F)

### Example 18

The same operation as in Example 16 was performed except that, in the step of producing the first intermediate compound (2A-1) in Example 16, 5.9 g of the compound (C-1) represented by Formula (17) (molecular weight: 172, 34.6 mmol) was used instead of the compound (A-1) represented by Formula (12), and 6.0 g of a compound (2C) (r indicating the average degree of polymerization in three Rf₂'s in Formula (2C) was 2.0) (number-average molecular weight: 2151) was obtained.

The obtained compound (2C) was subjected to ¹H-NMR and ¹⁹F-NMR measurements, and the structure was identified from the following results.

¹H-NMR (CD₃COCD₃): δ [ppm]1.48-1.87 (4H), 3.40 to 4.39 (46H)

¹⁹F-NMR (CD₃COCD₃): δ [ppm]=−84.0 to −83.0 (30.4F), −86.4 (8F), −124.2 (8F), −130.1 to −129.0 (15.2F)

### Example 19

The same operation as in Example 16 was performed except that, in the step of producing the first intermediate compound (2A-1) in Example 16, 6.4 g of the compound (D-1) represented by Formula (18) (molecular weight: 186, 34.6 mmol) was used instead of the compound (A-1) represented by Formula (12), and 6.2 g of a compound (2D) (r indicating the average degree of polymerization in three Rf₂'s in Formula (2D) was 2.0) (number-average molecular weight: 2179) was obtained.

The obtained compound (2D) was subjected to ¹H-NMR and ¹⁹F-NMR measurements, and the structure was identified from the following results.

¹H-NMR (CD₃COCD₃): δ [ppm]1.45-1.87 (8H), 3.36 to 4.50 (46H)

¹⁹F-NMR (CD₃COCD₃): δ [ppm]=−84.0 to −83.1 (30.4F), −86.3 (8F), −124.4 (8F), −130.0 to −129.0 (15.2F)

### Example 20

The same operation as in Example 16 was performed except that, in the step of producing the first intermediate compound (2A-1) in Example 16, 7.0 g of the compound (E-1) represented by Formula (19) (molecular weight: 202, 34.6 mmol) was used instead of the compound (A-1) represented by Formula (12), and 6.4 g of a compound (2E) (r indicating the average degree of polymerization in three Rf₂'s in Formula (2E) was 2.0) (number-average molecular weight: 2211) was obtained.

The obtained compound (2E) was subjected to ¹H-NMR and ¹⁹F-NMR measurements, and the structure was identified from the following results.

¹H-NMR (CD₃COCD₃): δ [ppm]=3.30 to 4.57 (54H)

¹⁹F-NMR (CD₃COCD₃): δ [ppm]=−84.2 to −83.1 (30.4F), −86.4 (8F), −124.3 (8F), −130.1 to −129.0 (15.2F)

### Example 21

The same operation as in Example 16 was performed except that, in the step of producing the first intermediate compound (2A-1) in Example 16, 6.9 g of the compound (F-1) represented by Formula (2O) (molecular weight: 200, 34.6 mmol) was used instead of the compound (A-1) represented by Formula (12), and 6.3 g of a compound (2F) (r indicating the average degree of polymerization in three Rf₂'s in Formula (2F) was 2.0) (number-average molecular weight: 2207) was obtained.

The obtained compound (2F) was subjected to ¹H-NMR and ¹⁹F-NMR measurements, and the structure was identified from the following results.

¹H-NMR (CD₃COCD₃): δ [ppm]1.25-1.80 (12H), 3.40 to 4.39 (46H)

¹⁹F-NMR (CD₃COCD₃): δ [ppm]=−84.0 to −83.0 (30.4F), −86.3 (8F), −124.3 (8F), −130.1 to −129.1 (15.2F)

### Example 22

### (Step of Producing First Intermediate Compound (2G-1))

The same operation as in Example 16 was performed in the same manner except that, in the step of producing the first intermediate compound (2A-1) in Example 16, 20 g of a compound represented by HOCH₂CF₂O(CF₂CF₂O)ₚ(CF₂O)_{q}CF₂CH₂OH (p indicating the average degree of polymerization in the formula was 2.4, and q indicating the average degree of polymerization in the formula was 2.4) (number-average molecular weight: 614, molecular weight distribution: 1.1) was used instead of HOCH₂CF₂CF₂O(CF₂CF₂CF₂O)ᵣCF₂CF₂CH₂OH (r indicating the average degree of polymerization in the formula was 2.0), 6.89 g of a compound (F-1) represented by Formula (2O) (molecular weight: 200, 34.4 mmol), which is an epoxy compound, was used instead of the compound (A-1) represented by Formula (12), and 3.7 g of a compound (B-1) represented by Formula (16) (molecular weight: 223, 16.7 mmol) was used instead of the compound (A-2) represented by Formula (14), and a first intermediate compound (2G-1) was produced.

### (Step of Producing Second Intermediate Compound (2G-2))

The same operation as in Example 16 was performed except that, in the step of producing the second intermediate compound (2A-2) in Example 16, 10 g of a compound represented by HOCH₂CF₂O(CF₂CF₂O)ₚ(CF₂O)_{q}CF₂CH₂OH (p indicating the average degree of polymerization in the formula was 2.4, and q indicating the average degree of polymerization was 2.4) (number-average molecular weight: 614, molecular weight distribution: 1.1) was used instead of HOCH₂CF₂CF₂O(CF₂CF₂CF₂O)ᵣCF₂CF₂CH₂OH (r indicating the average degree of polymerization in the formula was 2.0), and a second intermediate compound (2G-2) was produced.

### (Step of Producing Compound (2G))

the same operation as in the step of producing the compound (2A) of Example 16 was performed using the first intermediate compound (2G-1) and the second intermediate compound (2G-2), and 6.0 g of a compound (2G) (p indicating the average degree of polymerization in three Rf₁'s in Formula (2G) was 2.4, and q indicating the average degree of polymerization was 2.4) (number-average molecular weight: 2249) was obtained.

The obtained compound (2G) was subjected to ¹H-NMR and ¹⁹F-NMR measurements, and the structure was identified from the following results.

¹H-NMR (CD₃COCD₃): δ [ppm]1.36-1.85 (16H), 3.35 to 4.46 (46H)

¹⁹F-NMR (CD₃COCD₃): δ [ppm]=−55.6 to −50.6 (14.4F), −77.7 (6F), −80.2 (6F), −91.0 to −88.4 (28.8F)

### Example 23

### (Step of Producing First Intermediate Compound (2H-1))

The same operation as in the step of producing the third intermediate compound (1H-3) of Example 8 was performed except that, in the step of producing the first intermediate compound (1H-1) of Example 8, 20 g of a compound (number-average molecular weight: 614, molecular weight distribution: 1.1) represented by HOCH₂CF₂O(CF₂CF₂O)ₚ(CF₂O)_{g}CF₂CH₂OH (p indicating the average degree of polymerization in the formula was 2.4, and q indicating the average degree of polymerization was 2.4) was used instead of the compound represented by HOCH₂CF₂O(CF₂CF₂O)ₚ(CF₂O)_{q}CF₂CH₂OH (p indicating the average degree of polymerization in the formula was 4.0, and q indicating the average degree of polymerization was 4.0), and 6.0 g of a first intermediate compound (2H-1) represented by Formula (34) was obtained.

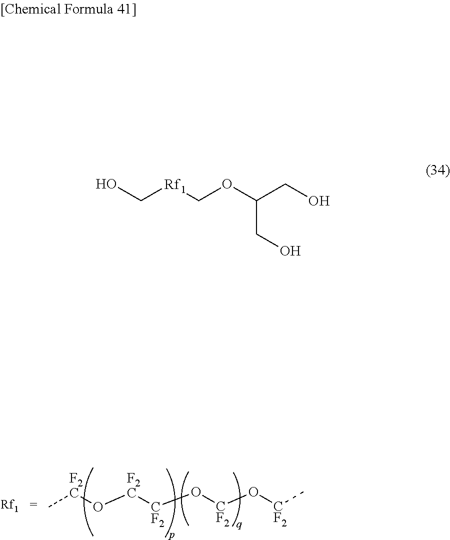

(In Formula (34), Rf₁ is represented by the above formula, p indicating the average degree of polymerization in Rf₁ represents 2.4, and q indicating the average degree of polymerization represents 2.4.)

### (Step of Producing Second Intermediate Compound (2H-2))

The same operation as in the step of producing the second intermediate compound (2G-2) in Example 22 was performed, and a second intermediate compound (2H-2) was synthesized.

### (Step of Producing Compound (2H))

6.0 g of the first intermediate compound (2H-1) represented by Formula (34) (number-average molecular weight: 819, 7.3 mmol), the second intermediate compound (2H-2), and 15 mL of t-butanol were charged into a 100 mL eggplant flask under a nitrogen gas atmosphere, and stirred at room temperature, thereby producing a mixed solution. 3.6 g of potassium tert-butoxide (molecular weight: 112, 11.0 mmol) was added to this mixed solution, stirred, and reacted at 70° C. for 10 hours.

A reaction product obtained after the reaction was cooled to 25° C., transferred to a separatory funnel containing 100 mL of water, and extracted three times with 100 mL of ethyl acetate. The organic layer was washed with water and dewatered with anhydrous sodium sulfate. After filtering off a desiccant, the filtrate was thickened, and the residue was purified by silica gel column chromatography to obtain 4.6 g of a compound (2H) (p indicating the average degree of polymerization in three Rf₁'s in Formula (2H) was 2.4, and q indicating the average degree of polymerization was 2.4) (number-average molecular weight: 2049).

The obtained compound (2H) was subjected to ¹H-NMR and ¹⁹F-NMR measurements, and the structure was identified from the following results.

¹H-NMR (CD₃COCD₃): δ [ppm]=3.36 to 4.66 (38H)

¹⁹F-NMR (CD₃COCD₃): δ [ppm]=−55.7 to −50.6 (14.4F), −77.8 (6F), −80.1 (6F), −91.0 to −88.4 (28.8F)

### Example 24

### (Step of Producing First Intermediate Compound (2I-1))

The same operation as in Example 23 was performed except that, in the step of producing the first intermediate compound (2H-1) in Example 23, 20 g of a compound represented by HOCH₂CF₂O(CF₂CF₂O)ₚ(CF₂O)_{q}CF₂CH₂OH (p indicating the average degree of polymerization in the formula was 3.8, and q indicating the average degree of polymerization in the formulae was 0) (number-average molecular weight: 618, molecular weight distribution: 1.1) was used instead of HOCH₂CF₂O(CF₂CF₂O)ₚ(CF₂O)_{q}CF₂CH₂OH (p indicating the average degree of polymerization in the formulae was 2.4, and q indicating the average degree of polymerization in the formula was 2.4), and 2.7 g of a compound (I-1) represented by Formula (25) (molecular weight: 146, 18.3 mmol), which is an alcohol compound, was used instead of the compound (H-1) represented by Formula (23), and a first intermediate compound (2I-1) was produced.

### (Step of Producing Second Intermediate Compound (2I-2))

The same operation as in Example 16 was performed except that, in the step of producing the second intermediate compound (2A-2) in Example 16, 10 g of a compound represented by HOCH₂CF₂O(CF₂CF₂O)(CF₂O)CF₂CH₂OH (p indicating the average degree of polymerization in the formulae was 3.8, and q indicating the average degree of polymerization in the formula was 0) (number-average molecular weight: 618, molecular weight distribution: 1.1) was used instead of HOCH₂CF₂CF₂O(CF₂CF₂CF₂O)ᵣCF₂CF₂CH₂OH (r indicating the average degree of polymerization in the formula was 2.0), and a second intermediate compound (2I-2) was produced.

### (Step of Producing Compound (2I))

The same operation as in the step of producing the compound (2H) of Example 23 was performed using the first intermediate compound (2I-1) and the second intermediate compound (2I-2), and 4.5 g of a compound (2I) (p indicating the average degree of polymerization in three Rf₁'s in Formula (2I) was 3.8, and q indicating the average degree of polymerization was 0) (number-average molecular weight: 2089) was obtained.

The obtained compound (2I) was subjected to ¹H-NMR and ¹⁹F-NMR measurements, and the structure was identified from the following results.

¹H-NMR (CD₃COCD₃): δ [ppm]1.50 to 1.90 (2H), 3.45 to 4.60 (40H)

¹⁹F-NMR (CD₃COCD₃): δ [ppm]=−78.6 (6F), −81.3 (6F), −90.1 to −88.6 (45.6F)

### Example 25

### (Step of Producing First Intermediate Compound (2I-1))

The same operation as in Example 23 was performed except that, in the step of producing the first intermediate compound (2H-1) in Example 23, 20 g of a compound represented by HOCH₂CF₂CF₂O(CF₂CF₂CF₂OCF₂CF₂CH₂OH (r indicating the average degree of polymerization in the formula was 2.0) (number-average molecular weight: 610, molecular weight distribution: 1.1) was used instead of HOCH₂CF₂O(CF₂CF₂O)ₚ(CF₂O)_{q}CF₂CH₂OH (p indicating the average degree of polymerization in the formula was 2.4, and q indicating the average degree of polymerization was 2.4), and 4.1 g of a compound (J-1) represented by Formula (26) (molecular weight: 288, 14.1 mmol), which is an alcohol compound, was used instead of the compound (H-1) represented by Formula (23), and a first intermediate compound (2J-1) was produced.

### (Step of Producing Second Intermediate Compound (2J-2))

The same operation as in the step of producing the second intermediate compound (2A-2) in Example 16 was performed, and a second intermediate compound (2J-2) was synthesized.

### (Step of Producing Compound (2J))

The same operation as in the step of producing the compound (2H) of Example 23 was performed using the first intermediate compound (2J-1) and the second intermediate compound (2J-2), and 4.5 g of a compound (2J) (r indicating the average degree of polymerization in three Rf₂'s in Formula (2J) was 2.0) (number-average molecular weight: 2091) was obtained.

The obtained compound (2J) was subjected to ¹H-NMR and ¹⁹F-NMR measurements, and the structure was identified from the following results.

¹H-NMR (CD₃COCD₃): δ [ppm]1.46 to 1.86 (6H), 3.40 to 4.55 (40H)

¹⁹F-NMR (CD₃COCD₃): δ [ppm]=−84.0 to −83.0 (30.4F), −86.2 (8F), −124.4 (8F), −130.0 to −129.0 (15.2F)

### Example 26

The same operation as in Example 25 was performed except that, in the step of producing the third intermediate compound (2J-1) in Example 25, 5.6 g of the compound (K-1) represented by Formula (27) (molecular weight: 302, 18.4 mmol), which is an alcohol compound, was used instead of the compound (J-1) represented by Formula (26), and 4.7 g of a compound (2K) (r indicating the average degree of polymerization in three Rf₂'s in Formula (2K) was 2.0) (number-average molecular weight: 2119) was obtained.

The obtained compound (2K) was subjected to ¹H-NMR and ¹⁹F-NMR measurements, and the structure was identified from the following results.

¹H-NMR (CD₃COCD₃): δ [ppm]1.35 to 1.86 (10H), 3.47 to 4.63 (40H)

¹⁹F-NMR (CD₃COCD₃): δ [ppm]=−84.0 to −83.0 (30.4F), −86.2 (8F), −124.4 (8F), −130.1 to −129.0 (15.2F)

### Example 27

The same operation as in Example 24 was performed except that, in the step of producing the first intermediate compound (2I-1) in Example 24, 5.6 g of the compound (L-1) represented by Formula (28) (molecular weight: 302, 18.4 nmol), which is an alcohol compound, was used instead of the compound (I-1) represented by Formula (25), and 4.7 g of a compound (2L) (p indicating the average degree of polymerization in three Rf₁'s in Formula (2L) was 3.8, and q indicating the average degree of polymerization was 0) (number-average molecular weight: 2145) was obtained.

The obtained compound (2L) was subjected to ¹H-NMR and ¹⁹F-NMR measurements, and the structure was identified from the following results.

¹H-NMR (CD₃COCD₃): δ [ppm]1.34 to 1.80 (10H), 3.40 to 4.52 (40H)

¹⁹F-NMR (CD₃COCD₃): δ [ppm]=−78.6 (6F), −81.2 (6F), −90.1 to −88.6 (45.6F)

### Example 28

The same operation as in Example 23 was performed except that in the step of producing the first intermediate compound (2H-1) in Example 23, 5.5 g (molecular weight: 302, 18.4 mmol) of the compound (M-1) represented by Formula (29), which is an alcohol compound, was used instead of the compound (H-1) represented by Formula (23), thereby obtaining 4.8 g (number-average molecular weight: 2133) of a compound (2M) (in three Rf₁'s in Formula (2M), p indicating the average degree of polymerization is 2.4 and q indicating the average degree of polymerization is 2.4).

The obtained compound (2M) was subjected to ¹H-NMR and ¹⁹F-NMR measurements, and the structure was identified from the following results.

¹H-NMR (CD₃COCD₃): δ [ppm]1.40 to 1.86 (14H), 3.40 to 4.60 (36H)

¹⁹F-NMR (CD₃COCD₃): δ [ppm]=−55.7 to −50.7 (14.4F), −77.7 (6F), −80.1 (6F), −91.0 to −88.4 (28.8F)

### Example 29

The same operation as in Example 25 was performed except that, in the step of producing the first intermediate compound (2J-1) in Example 25, 5.8 g of the compound (N-1) represented by Formula (30) (molecular weight: 316, 18.4 mmol), which is an alcohol compound, was used instead of the compound (J-1) represented by Formula (26), and 4.9 g of a compound (2N) (r indicating the average degree of polymerization in three Rf₂'s in Formula (2N) was 2.0) (number-average molecular weight: 2147) was obtained.

The obtained compound (2N) was subjected to ¹H-NMR and ¹⁹F-NMR measurements, and the structure was identified from the following results.

¹H-NMR (CD₃COCD₃): δ [ppm]1.35 to 1.80 (14H), 3.40 to 4.66 (40H)

¹⁹F-NMR (CD₃COCD₃): δ [ppm]=−84.0 to −83.0 (30.4F), −86.1 (8F), −124.3 (8F), −130.0 to −129.0 (15.2F)

### Example 30

The same operation as in Example 24 was performed except that, in the step of producing the first intermediate compound (2I-1) in Example 24, 6.0 g of the compound (0-1) represented by Formula (31) (molecular weight: 330, 18.4 mmol), which is an alcohol compound, was used instead of the compound (I-1) represented by Formula (25), and 5.0 g of a compound (2O) (p indicating the average degree of polymerization in three Rf₁'s in Formula (2O) was 3.8, and q indicating the average degree of polymerization is 0) (number-average molecular weight: 2201) was obtained.

The obtained compound (2O) was subjected to ¹H-NMR and ¹⁹F-NMR measurements, and the structure was identified from the following results.

¹H-NMR (CD₃COCD₃): δ [ppm]1.35 to 1.87 (18H), 3.42 to 4.68 (40H)

¹⁹F-NMR (CD₃COCD₃): δ [ppm]=−78.5 (6F), −81.0 (6F), −90.1 to −88.6 (45.6F)

The values of z in a case where each of the compounds (1A) to (1O) and (2A) to (2O) of Examples 1 to 30, which were obtained as described above, was applied to Formula (1) and the structures of R¹, R², R³, and R⁴ are shown in Tables 1 to 5.

In the items shown in Tables 1 to 5, from the left, “z” is the value of z shown in Formula (1), “R¹” is R¹, which is the branched terminal group of Formula (1), the left side shows an actual branched terminal group, the right side shows a structure in a case where R¹ is represented by Formula (2-1) or (2-2), “R²” shows a structure in a case where R² in Formula (1) is represented by Formula (7-1) or (7-2), “R³” shows that R³ in Formula (1) is represented by Formula (4), and “R⁴” shows a structure of R⁴ in Formula (1).

In the compounds (1A) to (1O) and (2A) to (2O) of Examples 1 to 30, in R³ represented by Formula (4). h=1 and i=1.

TABLE 1

| | z | R¹ | R¹ | R² | R³ | R⁴ | Compound |
|---|---|---|---|---|---|---|---|
| Example 1 | 1 | 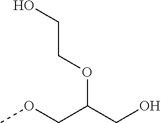 | Formula (2-1) a = 1 b = 1 X¹ = H X² = Formula (3) f = 2 g = 1 | Rf₂ r = 3.8 | (4) | Same as R¹ | (1A) |
| Example 2 | 1 | 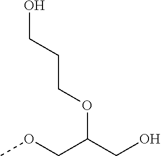 | Formula (2-1) a = 1 b = 1 X¹ = H X² = Formula (3) f = 3 g = 1 | Rf₂ r = 3.8 | (4) | Same as R¹ | (1B) |
| Example 3 | 1 | 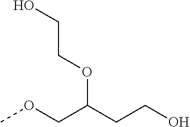 | Formula (2-1) a = 1 b = 2 X¹ = H X² = Formula (3) f = 2 g = 1 | Rf₂ r = 3.8 | (4) | Same as R¹ | (1C) |
| Example 4 | 1 | 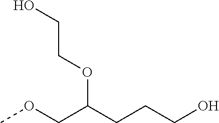 | Formula (2-1) a = 1 b = 3 X¹ = H X² = Formula (3) f = 2 g = 1 | Rf₂ r = 3.8 | (4) | Same as R¹ | (1D) |
| Example 5 | 1 | 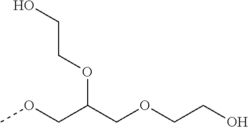 | Formula (2-1) a = 1 b = 1 X¹ = Formula (3) f = 2 g = 1 X² = Formula (3) f = 2 | Rf₂ r = 3.8 | (4) | Same as R¹ | (1E) |
| | | | g = 1 | | | | |
| Example 6 | 1 | 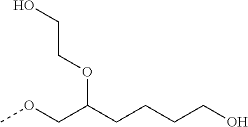 | Formula (2-1) a = 1 b = 4 X¹ = H X² = Formula (3) f = 2 g = 1 | Rf₂ r = 3.8 | (4) | Same as R¹ | (1F) |

TABLE 2

| | z | R¹ | R¹ | R² | R³ | R⁴ | Compound |
|---|---|---|---|---|---|---|---|
| Example 7 | 1 | 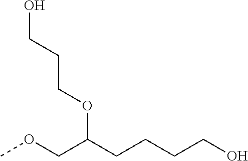 | Formula (2-1) a = 1 b = 4 X¹ = H X² = Formula (3) f = 3 g = 1 | Rf₁ p = 4.0 q = 4.0 | (4) | Same as R¹ | (1G) |
| Example 8 | 1 | 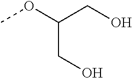 | Formula (2-2) c = 0 d = 1 e = 1 X³ = H | Rf₁ p = 4.0 q = 4.0 | (4) | Same as R¹ | (1H) |
| | | | X⁴ = H | | | | |
| Example 9 | 1 | 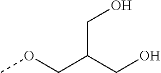 | Formula (2-2) c = 1 d = 1 e = 1 X³ = H | Rf₁ p = 6.3 q = 0 | (4) | Same as R¹ | (1I) |
| | | | X⁴ = H | | | | |
| Example 10 | 1 | 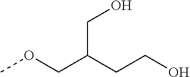 | Formula (2-2) c = 1 d = 1 e = 2 X³ = H | Rf₂ r = 3.8 | (4) | Same as R¹ | (1J) |
| | | | X⁴ = H | | | | |
| Example 11 | 1 | 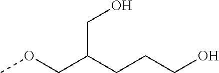 | Formula (2-2) c = 1 d = 1 e = 3 X³ = H | Rf₂ r = 3.8 | (4) | Same as R¹ | (1K) |
| | | | X⁴ = H | | | | |
| Example 12 | 1 | 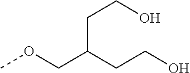 | Formula (2-2) c = 1 d = 2 e = 2 X³ = H | Rf₁ p = 6.3 q = 0 | (4) | Same as R¹ | (1L) |
| | | | X⁴ = H | | | | |

TABLE 3

| | z | R¹ | R¹ | R² | R³ | R⁴ | Compound |
|---|---|---|---|---|---|---|---|
| Example 13 | 1 | 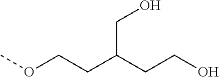 | Formula (2-2) c = 2 d = 1 e = 2 X³ = H | Rf₁ p = 4.0 q = 4.0 | (4) | Same as R¹ | (1M) |
| | | | X⁴ = H | | | | |
| Example 14 | 1 | 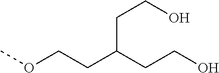 | Formula (2-2) c = 2 d = 2 e = 2 X³ = H | Rf₂ r = 3.8 | (4) | Same as R¹ | (1N) |
| | | | X⁴ = H | | | | |
| Example 15 | 1 | 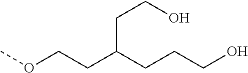 | Formula (2-2) c = 2 d = 2 e = 3 X³ = H | Rf₁ p = 6.3 q = 0 | (4) | Same as R¹ | (1O) |
| | | | X⁴ = H | | | | |
| Example 16 | 2 | 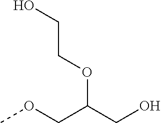 | Formula (2-1) a = 1 b = 1 X¹ = H X² = Formula (3) f = 2 g = 1 | Rf₂ r = 2.0 | (4) | Same as R¹ | (2A) |
| Example 17 | 2 | 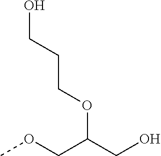 | Formula (2-1) a = 1 b = 1 X¹ = H X² = Formula (3) f = 3 g = 1 | Rf₂ r = 2.0 | (4) | Same as R¹ | (2B) |
| Example 18 | 2 | 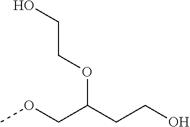 | Formula (2-1) a = 1 b = 2 X¹ = H X² = Formula (3) f = 2 g = 1 | Rf₂ r = 2.0 | (4) | Same as R¹ | (2C) |

TABLE 4

| | z | R¹ | R¹ | R² | R³ | R⁴ | Compound |
|---|---|---|---|---|---|---|---|
| Example 19 | 2 | 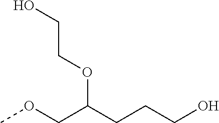 | Formula (2-1) a = 1 b = 3 X¹ = H X² = Formula (3) f = 2 g = 1 | Rf₂ r = 2.0 | (4) | Same as R¹ | (2D) |
| Example 20 | 2 | 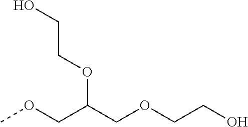 | Formula (2-1) a = 1 b = 1 X¹ = Formula (3) f = 2 g = 1 X² = Formula (3) f = 2 | Rf₂ r = 2.0 | (4) | Same as R¹ | (2E) |
| | | | g = 1 | | | | |
| Example 21 | 2 | 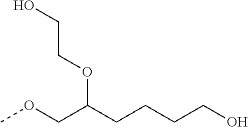 | Formula (2-1) a = 1 b = 4 X¹ = H X² = Formula (3) f = 2 g = 1 | Rf₂ r = 2.0 | (4) | Same as R¹ | (2F) |
| Example 22 | 2 | 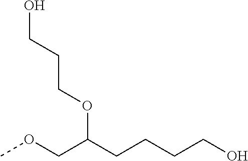 | Formula (2-1) a = 1 b = 4 X¹ = H X² = Formula (3) f = 3 g = 1 | Rf₁ p = 2.4 q = 2.4 | (4) | Same as R¹ | (2G) |
| Example 23 | 2 | 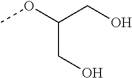 | Formula (2-2) c = 0 d = 1 e = 1 X³ = H | Rf₁ p = 2.4 q = 2.4 | (4) | Same as R¹ | (2H) |
| | | | X⁴ = H | | | | |
| Example 24 | 2 | 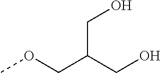 | Formula (2-2) c = 1 d = 1 e = 1 X³ = H | Rf₁ p = 3.8 q = 0 | (4) | Same as R¹ | (2I) |
| | | | X⁴ = H | | | | |

TABLE 5

| | z | R¹ | R¹ | R² | R³ | R⁴ | Compound |
|---|---|---|---|---|---|---|---|
| Example 25 | 2 | 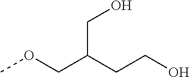 | Formula (2-2) c = 1 d = 1 e = 2 | Rf₂ r = 2.0 | (4) | Same as R¹ | (2J) |
| | | | X³ = H | | | | |
| | | | X⁴ = H | | | | |
| Example 26 | 2 | 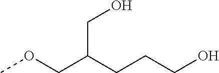 | Formula (2-2) c = 1 d = 1 e = 3 | Rf₂ r = 2.0 | (4) | Same as R¹ | (2K) |
| | | | X³ = H | | | | |
| | | | X⁴ = H | | | | |
| Example 27 | 2 | 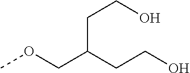 | Formula (2-2) c = 1 d = 2 e = 2 | Rf₁ p = 3.8 q = 0 | (4) | Same as R¹ | (2L) |
| | | | X³ = H | | | | |
| | | | X⁴ = H | | | | |
| Example 28 | 2 | 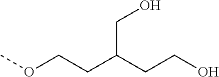 | Formula (2-2) c = 2 d = 1 e = 2 | Rf₁ p = 2.4 q = 2.4 | (4) | Same as R¹ | (2M) |
| | | | X³ = H | | | | |
| | | | X⁴ = H | | | | |
| Example 29 | 2 | 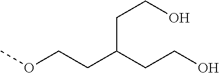 | Formula (2-2) c = 2 d = 2 e = 2 | Rf₂ r = 2.0 | (4) | Same as R¹ | (2N) |
| | | | X³ = H | | | | |
| | | | X⁴ = H | | | | |
| Example 30 | 2 | 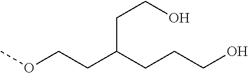 | Formula (2-2) c = 2 d = 2 e = 3 | Rf₁ p = 3.8 q = 0 | (4) | Same as R¹ | (2O) |
| | | | X³ = H | | | | |
| | | | X⁴ = H | | | | |

### Comparative Example 1

A compound (3A) represented by Formula (35) was synthesized by the method described in Patent Document 1.

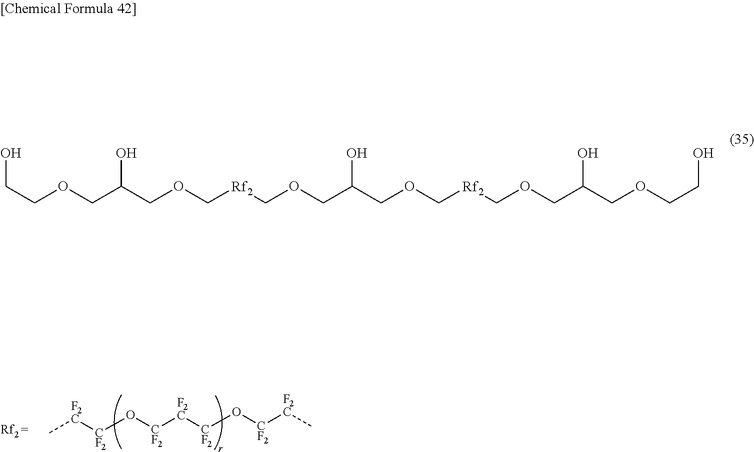

(In Formula (35), Rf₂ is represented by the above formula, and r indicating the average degree of polymerization in Rf₂ represents 3.8.)

### Comparative Example 2

A compound (3B) represented by Formula (36) was synthesized by the method described in Patent Document 2.

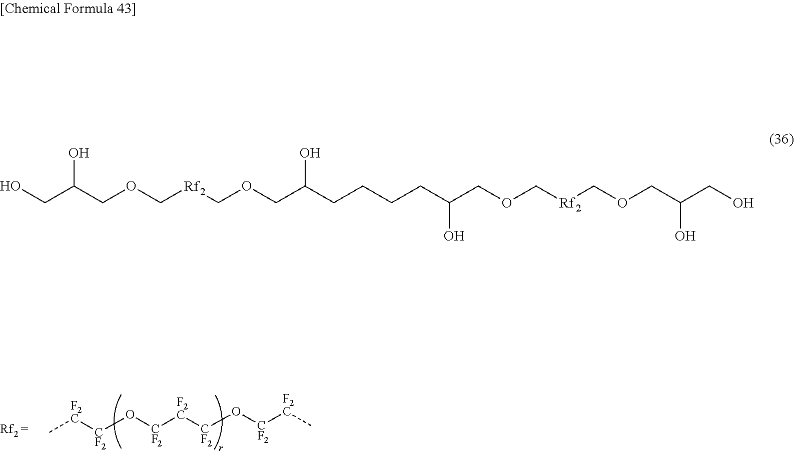

(In Formula (36), Rf₂ is represented by the above formula, and r indicating the average degree of polymerization in Rf₂ represents 3.8.)

### Comparative Example 3

A compound (3C) represented by Formula (37) was synthesized by the method described in Patent Document 3.

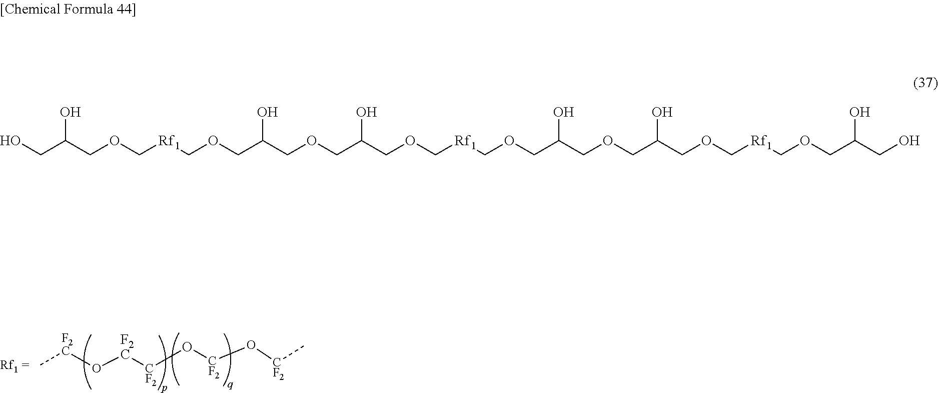

(In Formula (37), Rf₁ is represented by the above formula, p indicating the average degree of polymerization in Rf₁ represents 3.8, and q indicating the average degree of polymerization represents 0.)

### Comparative Example 4

A compound (3D) represented by Formula (38) was synthesized by the method described in Patent Document 4.

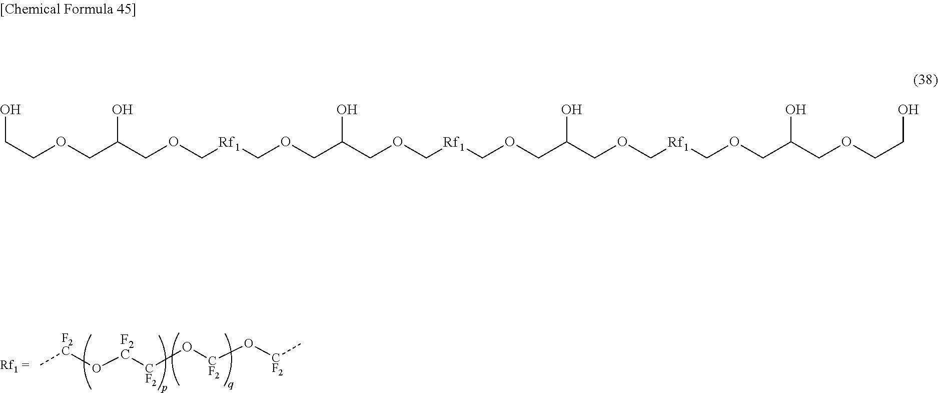

(In Formula (38), Rf₁ is represented by the above formula, and in the central Rf₁, p indicating the average degree of polymerization represents 3.8, and q indicating the average degree of polymerization represents 0. In two Rf₁'s at the terminals, p indicating the average degree of polymerization represents 2.4, and q indicating the average degree of polymerization represents 2.4.)

### Comparative Example 51

A compound (3E) represented by Formula (39) was synthesized by the method described in Patent Document 5.

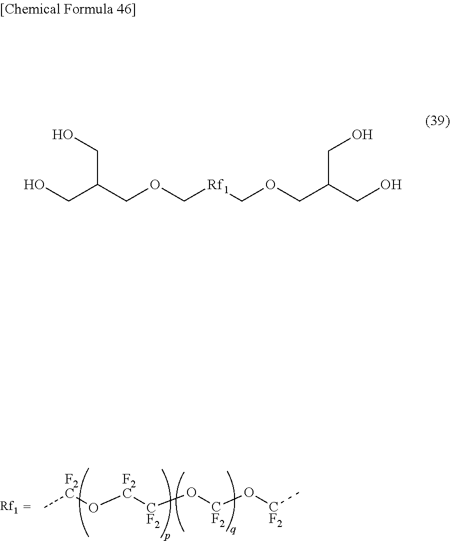

(In Formula (39), Rf₁ is represented by the above formula, p indicating the average degree of polymerization in Rf₁ represents 4.5, and q indicating the average degree of polymerization represents 4.5.)

### Comparative Example 61

A compound (3F) represented by Formula (40) was synthesized by the method described in Patent Document 5.

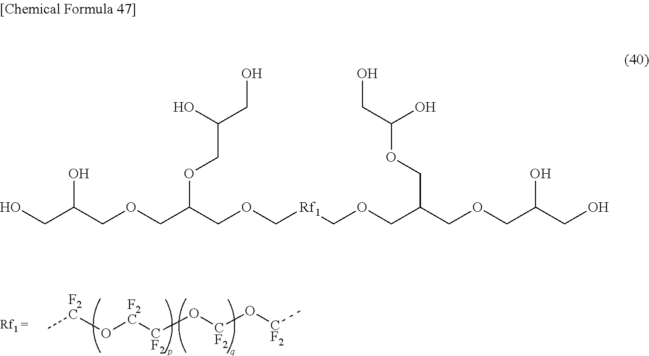

(In Formula (40), Rf₁ is represented by the above formula, p indicating the average degree of polymerization in Rf₁ represents 4.5, and q indicating the average degree of polymerization represents 4.5.)

### Comparative Example 7

A compound (3G) represented by Formula (41) was synthesized by the method described in Patent Document 6.

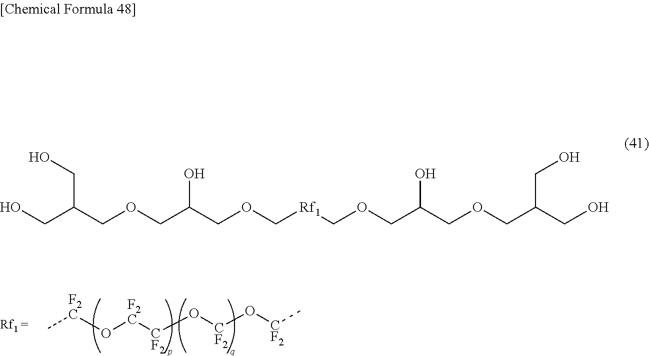

(In Formula (41), Rf₁ is represented by the above formula, p indicating the average degree of polymerization in Rf₁ represents 4.5, and q indicating the average degree of polymerization represents 4.5.)

The number-average molecular weights (Mn) of the compounds of Examples 1 to 30 and Comparative Examples 1 to 7 obtained as described above were determined from the measurement results of the above-described ¹H-NMR and ¹⁹F-NMR. The results thereof are shown in Table 6 and Table 7. It is presumed that there is a variation of about 1 to 5 in the value of the average molecular weight of the synthesized compound due to the molecular weight distribution of the fluoropolyether used as a raw material of the compound, a difference in operation In the case of synthesizing the compound, and the like.

TABLE 6

| | | Number- | | | | |
|---|---|---|---|---|---|---|
| | | average | | | | |
| | | molecular | Film | Wear | | |
| | | weight | thickness | resistance | Smoothness | Comprehensive |
| | Compound | (Mn) | (Å) | test | evaluation | evaluation |
| Example 1 | (1A) | 2110 | 9.5 | B | A | B |
| Example 2 | (1B) | 2138 | 9.5 | B | A | B |
| Example 3 | (1C) | 2138 | 9.4 | A | A | A |
| Example 4 | (1D) | 2166 | 9.5 | A | A | A |
| Example 5 | (1E) | 2198 | 9.4 | A | A | A |
| Example 6 | (1F) | 2194 | 9.4 | A | A | A |
| Example 7 | (1G) | 2217 | 9.6 | A | A | A |
| Example 8 | (1H) | 2016 | 9.4 | B | B | B |
| Example 9 | (1I) | 2050 | 9.4 | B | B | B |
| Example 10 | (1J) | 2078 | 9.5 | B | B | B |
| Example 11 | (1K) | 2106 | 9.3 | B | A | B |
| Example 12 | (1L) | 2106 | 9.6 | A | A | A |
| Example 13 | (1M) | 2101 | 9.5 | A | B | B |
| Example 14 | (1N) | 2134 | 9.5 | A | A | A |
| Example 15 | (1O) | 2162 | 9.4 | A | A | A |
| Example 16 | (2A) | 2123 | 9.6 | B | A | B |
| Example 17 | (2B) | 2151 | 9.6 | B | A | B |
| Example 18 | (2C) | 2151 | 9.5 | A | A | A |
| Example 19 | (2D) | 2179 | 9.5 | A | A | A |
| Example 20 | (2E) | 2211 | 9.4 | A | A | A |
| Example 21 | (2F) | 2207 | 9.6 | A | A | A |
| Example 22 | (2G) | 2249 | 9.5 | A | A | A |
| Example 23 | (2H) | 2049 | 9.5 | B | B | B |
| Example 24 | (2I) | 2089 | 9.5 | B | B | B |
| Example 25 | (2J) | 2091 | 9.4 | B | B | B |
| Example 26 | (2K) | 2119 | 9.5 | B | A | B |
| Example 27 | (2L) | 2145 | 9.5 | A | A | A |
| Example 28 | (2M) | 2133 | 9.5 | A | B | B |
| Example 29 | (2N) | 2147 | 9.6 | A | A | A |
| Example 30 | (2O) | 2201 | 9.6 | A | A | A |

TABLE 7

| | | Number- | | | | |
|---|---|---|---|---|---|---|
| | | average | | | | |
| | | molecular | Film | Wear | | |
| | | weight | thickness | resistance | Smoothness | Comprehensive |
| | Compound | (Mn) | (Å) | test | evaluation | evaluation |
| Comparative | (3A) | 2110 | 9.4 | C | C | C |
| Example 1 | | | | | | |
| Comparative | (3B) | 2196 | 9.4 | C | C | C |
| Example 2 | | | | | | |
| Comparative | (3C) | 2264 | 9.5 | D | C | D |
| Example 3 | | | | | | |
| Comparative | (3D) | 2200 | 9.6 | C | C | C |
| Example 4 | | | | | | |
| Comparative | (3E) | 1210 | 9.4 | D | D | D |
| Example 5 | | | | | | |
| Comparative | (3F) | 1446 | 9.5 | D | D | D |
| Example 6 | | | | | | |
| Comparative | (3G) | 1324 | 9.6 | D | C | D |
| Example 7 | | | | | | |

Next, solutions for forming a lubricating layer were prepared using the compounds obtained in Examples 1 to 30 and Comparative Examples 1 to 7 by a method described below. In addition, lubricating layers for a magnetic recording medium were formed using the obtained solutions for forming a lubricating layer by the following method, and magnetic recording media of Examples 1 to 30 and Comparative Examples 1 to 7 were obtained.

### “Solution for Forming Lubricating Layer”

Each of the fluorine-containing ether compounds obtained in Examples 1 to 30 and Comparative Examples 1 to 7 was dissolved in Vertrel (registered trademark) XF (trade name, manufactured by Mitsui DuPont Fluorochemicals Co., Ltd.), which is a fluorine-based solvent, and diluted with Vertrel XF so that the film thickness In the case of being applied onto the protective layer was 9 Å to 10 Å, thereby obtaining a solution for forming a lubricating layer.

### “Magnetic Recording Medium”

A magnetic recording medium in which an adhesion layer, a soft magnetic layer, a first underlayer, a second underlayer, a magnetic layer, and a protective layer were sequentially provided on a substrate having a diameter of 65 mm was prepared. The protective layer was formed of carbon.

The solutions for forming a lubricating layer of Examples 1 to 30 and Comparative Examples 1 to 7 were each applied onto the protective layer of the magnetic recording medium in which the individual layers up to the protective layer had been formed by a dipping method. The dipping method was performed under conditions of an immersion rate of 10 mm/see, an immersion time of 30 sec, and a lifting rate of 1.2 mm/sec.

Thereafter, the magnetic recording medium coated with the solution for forming a lubricating layer was placed in a thermostatic chamber at 120° C. and heated for 10 minutes to remove the solvent in the solution for forming a lubricating layer, thereby forming a lubricating layer on the protective layer, and obtaining a magnetic recording medium.

### “Film Thickness Measurement”

For the lubricating layers of the magnetic recording media of Examples 1 to 30 and Comparative Examples 1 to 7 obtained as described above, the peak heights in C—F vibration expansion and contraction were measured using FT-IR (trade name: Nicolet iS50, manufactured by Thermo Fisher Scientific Inc.). Next, the film thicknesses of the lubricating layers were calculated from the measured values of the peak heights in the C—F vibration and expansion and contraction of the lubricating layer, using a correlation expression obtained by the method described below.

### “Method for Calculating Correlation Expression”

A disk in which an adhesion layer, a soft magnetic layer, a first underlayer, a second underlayer, a magnetic layer, and a protective layer were sequentially provided on a substrate having a diameter of 65 mm was prepared. A lubricating layer was formed on the protective layer of the disk at each of film thicknesses of 6 to 20 Å (in increments of 2 Å).

Thereafter, for each disk on which the lubricating layer was formed, the increase in film thickness from the disk surface on which the lubricating layer was not formed was measured using an ellipsometer, and the measured value was defined as the film thickness of the lubricating layer. In addition, for each disk on which the lubricating layer was formed, the peak height in the C—F vibration and expansion and contraction was measured using FT-IR.

Then, a correlation expression between the peak height obtained by FT-IR and the film thickness of the lubricating layer obtained using the ellipsometer was obtained.

Next, the wear resistance test and the smoothness test were performed and evaluated for the magnetic recording media of Examples 1 to 30 and Comparative Examples 1 to 7 by the methods shown below. The results thereof are shown in Table 6 and Table 7.

### “Wear Resistance Test”

Using a pin-on-disk type friction and wear tester, an alumina ball having a diameter of 2 mm as a contactor was slid on the surface of the lubricating layer of the magnetic recording medium at a load of 40 gf and a sliding speed of 0.25 m/see, and the friction coefficient of the surface of the lubricating layer was measured. Then, a sliding time (friction coefficient increasing time) until the friction coefficient of the surface of the lubricating layer rapidly increased was measured. The friction coefficient increasing time was measured four times for the lubricating layer of each magnetic recording medium, and the average value (time) thereof was used as an index of the wear resistance of the lubricant coating film.

### “Evaluation Standard for Wear Resistance”

The results of the friction coefficient increase times of the magnetic recording media using the compounds of Examples 1 to 30 and the compounds of Comparative Examples 1 to 7 are shown in Table 6 and Table 7. The evaluation of the friction coefficient increasing time was performed as follows. It is understood that the larger the friction coefficient increasing time is, the better the result is.
A: 650 sec or more
B: 550 sec or more and less than 650 sec
C: 450 sec or more and less than 550 sec
D: less than 450 sec

The time until the friction coefficient rapidly increases can be used as an index of the wear resistance of the lubricating layer for the following reason. The reason is that, in a case where the magnetic recording medium is used, the wear progresses, and the lubricating layer is removed by the wear, the contactor and the protective layer come into direct contact with each other, and the friction coefficient rapidly increases. It is considered that the time until the present friction coefficient rapidly increases is also correlated with the friction test.

### “Smoothness Test”

As an evaluation index of the smoothness of the surface of the lubricating layer, a touch-down power (TDp) was measured. The measurement of TDp was performed as follows using a write tester (DFH tester).

The magnetic recording medium to be evaluated was rotated at 5,400 rpm, and the magnetic head was disposed to face a position at a radius of 18 mm from the center. The heater power of the write element (DFH element) of the magnetic head was gradually increased, and the DFH element was thermally expanded by the heat generation of the heater. In addition, the heater power at a point in time when the tip of the DFH element protruding due to the thermal expansion of the DFH element contacts with the lubricating layer of the magnetic recording medium was measured as TDp (unit: mW). The contact between the distal end of the DFH element and the lubricating layer of the magnetic recording medium was detected by an acoustic emission (AE) sensor.

In general, as the film thickness of the lubricating layer decreases, TDp required for the DFH element to contact with the surface of the lubricating layer increases. On the other hand, in the case of comparison between magnetic recording media having the same average film thickness, it is known that the value of TDp decreases as the surface unevenness of the lubricating layer increases, since the maximum height of the lubricating layer increases.

### “Evaluation Standard for Smoothness”

The smoothness of the lubricating layers of the magnetic recording media formed of the compounds of Examples 1 to 30 and the compounds of Comparative Examples 1 to 7 was evaluated as follows.
A: TDp value of 51.5 mW or more (the surface unevenness is very small)
B: TDp value of 51.0 to 51.4 mW (the surface unevenness is small)
C: TDp value of 50.5 to 50.9 mW (the surface unevenness is large)
D: TDp value of 50.4 mW or less (the surface unevenness is very large)

### “Comprehensive Evaluations”

Based on the results of the wear resistance test and the smoothness test, the comprehensive evaluation was performed according to the following evaluation standards.

### “Evaluation Standard for Comprehensive Evaluation”

A: The evaluations of wear resistance and smoothness are all A.
B: The evaluations of wear resistance and smoothness are A or B, and one or more thereof are B.
C: One or more of the evaluations of wear resistance and smoothness are C, and there is no D.
D: One or more of the evaluations of wear resistance and smoothness are D.

As shown in Table 6, for the magnetic recording media of Examples 1 to 30, the evaluations of the wear resistance test and the smoothness test were all “A” or “B”, and the comprehensive evaluations were “A” or “B”. From this, it was possible to confirm that the magnetic recording media of Examples 1 to 30 have good wear resistance and the magnetic recording media have high smoothness.

It is presumed that this is because all of the compounds represented by (1A) to (1O) and (2A) to (2O) forming the lubricating layers of the magnetic recording media of Examples 1 to 30 satisfy Formula (1).

In particular, for the lubricating layers of the magnetic recording media of Examples 1 to 7, 11, 12, 14 to 22, 26, 27, 29, and 30 formed of the compounds (1A) to (1G), (1K), (1L), (1N), (1O), (2A) to (2G), (2K), (2L), (2N), and (2O), the evaluations of the smoothness test were “A”.

In the group of the compounds used in the above-described examples, since two primary hydroxy groups included in the branched terminal group are disposed to be separated by five or more atoms, the primary hydroxy groups are less likely to aggregate with each other and are likely to interact with the protective layer independently. Therefore, it is considered that the lubricating layer easily wets and spreads uniformly on the protective layer and has good coatability, and particularly excellent smoothness is obtained.

In addition, in the lubricating layers of the magnetic recording media of Examples 3 to 7, 12 to 15, 18 to 22, and 27 to 30, in which the compounds (1C) to (1G), (1L) to (1O), (2C) to (2G), and (2L) to (2O) were used, the evaluations of the wear resistance test were “A”.

In the group of the compounds used in the above-described examples, the distances between the perfluoropolyether chain and two primary hydroxy groups included in the branched terminal group are sufficiently separated. From this, two primary hydroxy groups included in the branched terminal group are not affected by the bulkiness attributed to the perfluoropolyether chain. Therefore, both of two primary hydroxy groups included in the branched terminal group have high mobility and degree of freedom and have high adsorptivity to the protective layer. In addition, the lubricating layers of the above-described examples have sufficient fluidity and flexibility due to the high mobility of two primary hydroxy groups included in the branched terminal group. Therefore, even in a case where a part of the lubricating layer is deformed due to abrasion and the fluorine-containing ether compound in the lubricating layer moves to another location, the restoration power to return to the original position is high. As a result, it is presumed that particularly excellent wear resistance is obtained.

On the other hand, as shown in Table 7, in Comparative Examples 1 to 7 having the lubricating layer formed of any of the compounds (3A) to (3G), the evaluations of the wear resistance test and the smoothness test were all “C” or “D”, which were inferior to those of Examples 1 to 30. It is presumed that this is because in Comparative Examples 1 to 7, the lubricating layers were formed using a compound that did not satisfy Formula (1).

Specifically, the magnetic recording media of Comparative Examples 1 to 4 have the lubricating layers formed of the compounds (3A) to (3D). In the compounds (3A) to (3D), the linking group having a secondary hydroxy group is disposed between two or three perfluoropolyether chains, and the terminal groups in which a secondary hydroxy group and a primary hydroxy group are disposed in this order are provided at both terminals of the perfluoropolyether chain.

The compounds (3A) to (3D) used in the lubricating layers of Comparative Examples 1 to 4 have the linking group having a hydroxy group disposed between two or three perfluoropolyether chains. Therefore, the central portions of the chain-like structures of the compounds (3A) to (3D) are caused to closely adhere to the protective layers. However, in the compounds (3A) to (3D), since both terminal groups include a secondary hydroxy group having a low degree of freedom, the adsorptivity to the protective layer is not sufficient, and the perfluoropolyether chain is likely to float.

In addition, in the compounds (3B) and (3C), each linking group disposed between two or three perfluoropolyether chains has two secondary hydroxy groups. It is presumed that in a case where the number of the secondary hydroxy groups included in the linking group is large, the secondary hydroxy groups inhibit each other from bonding to the active sites on the protective layer. As a result, it is presumed that the polar group that does not participate in the bonding with the active point on the protective layer aggregates by attracting a polar group between the molecules and/or in the molecule, and the wear resistance and the smoothness are insufficient.

In addition, the compound (3E) has only one perfluoropolyether chain, and a terminal group including two primary hydroxy groups is disposed at each of both ends of the perfluoropolyether chain. In the magnetic recording medium of Comparative Example 5 in which the lubricating layer was formed using the compound (3E), both of the wear resistance test and the smoothness test were evaluated as “D”.

The compound (3E) has only one perfluoropolyether chain, and a structure including a polar group is not disposed in the center of the chain-like structure. Therefore, in the lubricating layer of the magnetic recording medium of Comparative Example 5, only both terminals of the molecule of the compound (3E) closely adhere to the protective layer, and the central portion of the chain-like structure is separated from the protective layer. As a result, it is considered that the wear resistance and the smoothness are insufficient.

In addition, the magnetic recording media of Comparative Examples 6 and 7 each have a lubricating layer formed of the compounds (3F) or (3G). In the magnetic recording medium of Comparative Example 6 using the compound (3F), both the wear resistance test and the smoothness test were “D”, and in the magnetic recording medium of Comparative Example 7 using the compound (3G), the wear resistance test was “D” and the smoothness test was “C”.

Both of the compounds (3F) and (3G) have a terminal group structure in which only one perfluoropolyether chain is provided and a plurality of hydroxy groups including two primary hydroxy groups are disposed at each of both ends of the perfluoropolyether chain.

Therefore, in the lubricating layers of the magnetic recording media of Comparative Examples 6 and 7, the central portions of the chain-like structures are separated from the protective layers, as in the lubricating layer of the magnetic recording medium of Comparative Example 5. In addition, at each of both terminal groups of the compounds (3F) and (3G), aside from two primary hydroxy groups having high mobility and high adsorptivity, there are two secondary hydroxy groups having a low degree of freedom in the compound (3F), one secondary hydroxy group in the compound (3G), eight hydroxy groups in the molecule of the compound (3F), and six hydroxy groups in the molecule of the compound (3G). Therefore, it is presumed that, in the lubricating layers of the magnetic recording media of Comparative Examples 6 and 7, there are too many hydroxy groups that participate in the adsorption, and thus a hydroxy group that cannot be adsorbed to the protective layer and is liberated is generated. As a result, it is presumed that a polar group between the molecules and/or in the molecule is likely to aggregate, and the wear resistance and the smoothness are insufficient.

### INDUSTRIAL APPLICABILITY

The use of the lubricant for a magnetic recording medium including the fluorine-containing ether compound of the present invention makes it possible to form a lubricating layer having excellent wear resistance and good smoothness even in a case where the thickness is small.

### REFERENCE SIGNS LIST

10 Magnetic recording medium
11 Substrate
12 Adhesion layer
13 Soft magnetic layer
14 First underlayer
15 Second underlayer
16 Magnetic layer
17 Protective layer
18 Lubricating layer

1. A fluorine-containing ether compound represented by Formula (1), 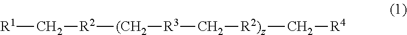
(in Formula (1), z is 1 or 2,
R² is a perfluoropolyether chain,
(z+1) R²'s may be the same in part or in whole, or may be different from each other,
R¹ is a branched terminal group having 3 to 35 carbon atoms, which is represented by Formula (2),
R⁴ is an organic group having 3 to 35 carbon atoms and having 1 to 3 polar groups, and may be the same as or different from R¹,
R³ is a divalent linking group represented by Formula (4), and
in a case where z is 2, two R³'s may be the same as or different from each other)
(in Formula (2), R⁵ and R⁶ are organic groups which do not include a secondary hydroxy group and a tertiary hydroxy group and include one primary hydroxy group, and may be the same as or different from each other, and
x is an integer of 0 to 3),
(in Formula (4), h is an integer of 1 to 3, and i is an integer of 1 to 3).

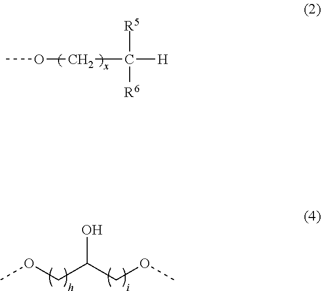

2. The fluorine-containing ether compound according to claim 1, wherein Formula (2) is any group represented by Formula (2-1) or (2-2):
(in Formula (2-1), a is an integer of 1 to 3, and b is an integer of 1 to 4,
X¹ is a hydrogen atom or a group represented by Formula (3),
X² is a group represented by Formula (3), and
X¹ and X² may be the same as or different from each other),
(in Formula (2-2), c is an integer of 0 to 3, and d and e are each independently an integer of 1 to 5,
X³ and X⁴ are each independently a hydrogen atom or a group represented by Formula (3), and
X³ and X⁴ may be the same as or different from each other),
(in Formula (3), f is an integer of 2 to 5, and g is 1 or 2).

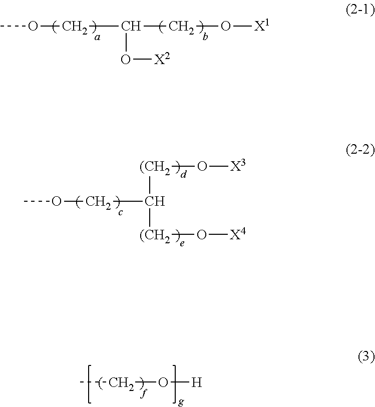

3. The fluorine-containing ether compound according to claim 1, wherein R⁴ in Formula (1) is the group represented by Formula (2).

4. The fluorine-containing ether compound according to claim 2, wherein both R¹ and R⁴ in Formula (1) are each independently represented by Formula (2-1) or (2-2).

5. The fluorine-containing ether compound according to claim 1, wherein R¹ and R⁴ in Formula (1) are the same as each other.

6. The fluorine-containing ether compound according to claim 1, wherein R⁴ in Formula (1) is any group represented by Formulae (6-1) to (6-3), 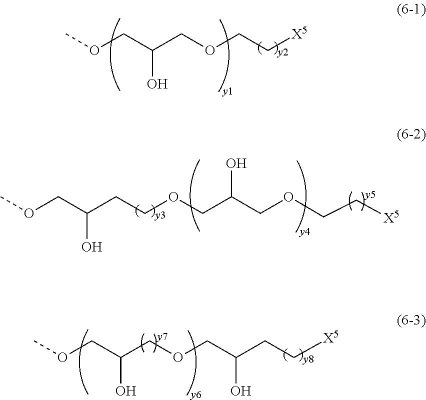
(in Formula (6-1), y1 is 1 or 2, y2 is an integer of 0 to 3, X⁵ is an aromatic hydrocarbon group, an unsaturated heterocyclic group, an alkenyl group, an alkynyl group, or a polar group, in a case where y1 is 1, X⁵ is a polar group, in a case where X⁵ is the aromatic hydrocarbon group or the unsaturated heterocyclic group, an atom constituting a ring structure in X⁵ is bonded to a methylene group adjacent to X⁵, and in a case where X⁵ is an alkenyl group or an alkynyl group, a carbon atom constituting an unsaturated bond in X⁵ is bonded to a methylene group adjacent to X⁵),
(in Formula (6-2), y3 is an integer of 1 to 3, y4 is 0 or 1, y5 is an integer of 0 to 3, X⁵ is an aromatic hydrocarbon group, an unsaturated heterocyclic group, an alkenyl group, an alkynyl group, or a polar group, in a case where y4 is 0, X⁵ is a polar group, in a case where X⁵ is the aromatic hydrocarbon group or the unsaturated heterocyclic group, an atom constituting a ring structure in X⁵ is bonded to a methylene group adjacent to X⁵, and in a case where X⁵ is an alkenyl group or an alkynyl group, a carbon atom constituting an unsaturated bond in X⁵ is bonded to a methylene group adjacent to X⁵),
(in Formula (6-3), y6 is 0 or 1, y7 is an integer of 1 to 3, y8 is an integer of 1 to 3, X⁵ is an aromatic hydrocarbon group, an unsaturated heterocyclic group, an alkenyl group, an alkynyl group, or a polar group, in a case where y6 is 0, X⁵ is a polar group, in a case where X⁵ is the aromatic hydrocarbon group or the unsaturated heterocyclic group, an atom constituting a ring structure in X⁵ is bonded to a methylene group adjacent to X⁵, and in a case where X⁵ is an alkenyl group or an alkynyl group, a carbon atom constituting an unsaturated bond in X⁵ is bonded to a methylene group adjacent to X⁵).

7. The fluorine-containing ether compound according to claim 1, wherein (z+1) R²'s in Formula (1) are each independently a perfluoropolyether chain represented by Formula (5), 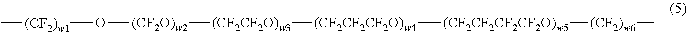
(in Formula (5), w2, w3, w4, and w5 represent average degrees of polymerization and each independently represent 0 to 20, where, all of w2, w3, w4, and w5 are not zero at the same time, w1 and w6 are average values representing the number of CF₂'s and each independently represent 1 to 3, and an order of arrangement of (CF₂O), (CF₂CF₂O), (CF₂CF₂CF₂O), and (CF₂CF₂CF₂CF₂O), which are repeating units in Formula (5), is not particularly limited).

8. The fluorine-containing ether compound according to claim 1, wherein (z+1) R²'s in Formula (1) are each independently any one selected from perfluoropolyether chains represented by Formulae (5-1) to (5-4), 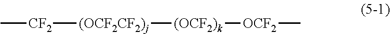
(in Formula (5-1), j and k represent average degrees of polymerization, j represents 1 to 20, and k represents 0 to 20), 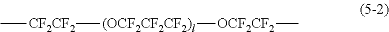
(in Formula (5-2), 1 represents an average degree of polymerization, and represents 1 to 15), 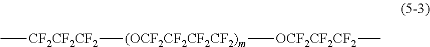
(in Formula (5-3), m represents an average degree of polymerization, and represents 1 to 10), and 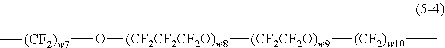
(in Formula (5-4), w8 and w9 represent average degrees of polymerization, and each independently represent 1 to 20, and w7 and w10 are average values representing the number of CF₂'s and each independently represent 1 to 2).

9. The fluorine-containing ether compound according to claim 1, wherein (z+1) R²'s in Formula (1) are all the same as each other.

10. The fluorine-containing ether compound according to claim 1, wherein a number-average molecular weight is within a range of 500 to 10000.

11. A lubricant for a magnetic recording medium, comprising:
the fluorine-containing ether compound according to claim 1.

12. A magnetic recording medium comprising at least in order, on a substrate:
a magnetic layer;
a protective layer; and
a lubricating layer,
wherein the lubricating layer includes the fluorine-containing ether compound according to claim 1.

13. The magnetic recording medium according to claim 12, wherein an average film thickness of the lubricating layer is 0.5 nm to 2.0 nm.
